(19) United States
(12) Patent Application Publication
(10) Pub. No.: US 2007/0028187 A1
(43) Pub. Date: Feb. 1, 2007

(54) Apparatus and method for performing display processing, and computer program product

(76) Inventor: Goro Katsuyama, Kanagawa (JP)

Correspondence Address: HARNESS, DICKEY & PIERCE, P.L.C., P.O. BOX 8910, RESTON, VA, 20195, US

(21) Appl. No.: 11/496,567

(22) Filed: Aug. 1, 2006

(30) Foreign Application Priority Data
Aug. 1, 2005 (JP) 2005-223416
Aug. 1, 2005 (JP) 2005-223417

(51) Int. Cl. G06F 9/00

(52) U.S. Cl. 715/810; 715/836; 715/835; 715/848

(57) ABSTRACT

A display processing apparatus includes a display processing unit that displays an input indicating area and an output indicating area. Input functions are displayed in the input indicating area and output functions are displayed in the output indicating area. The output indicating area can be displayed where the input indicating area has been displayed, or vice versa. When a user selects a function from those areas, that function is executed.

### CROSS-REFERENCE TO RELATED APPLICATIONS

The present document incorporates by reference the entire contents of Japanese priority document, 2005-223416 filed in Japan on Aug. 1, 2005 and 2005-223417 filed in Japan on Aug. 1, 2005.

### BACKGROUND OF THE INVENTION

1. Field of the Invention

The present invention generally relates to displaying an image, specifically relates to displaying only the image in an area of an image.

2. Description of the Related Art

Conventionally, it is difficult to perform detailed setting desired by a user in an apparatus, such as an image forming apparatus, including an operation panel. This is because, while the apparatus includes a screen of a size only necessary and sufficient for displaying functions for the user and an interface used for the setting includes only a ten key, a touch panel, and the like, all functions that can be set have to be displayed in the screen. Since items displayed in the screen are complicated, it is not easy for the user to select a desired function from the items displayed and set the function. Even if a function is displayed, the user tends to avoid selecting the function when the user does not understand the function.

Those skilled in the art have not made any active proposal concerning a display method for improving operability of the apparatus. This might be because those skilled in the art consider that users do not wish to have the conventional user interface changed. Therefore, to prevent unavailable functions from being set, the functions are simply not displayed (e.g., Japanese Patent Application Laid-Open No. 2001-194963; hereinafter, “first document”).

On the other hand, in a personal computer (PC), it is possible to select a screen size, resolution, and the like according to the needs of a user. Therefore, various technologies have been proposed to display functions provided by software in a screen. For example, when the user does not understand how to use a function, a help screen or the like can be displayed on the screen of the PC.

A technology for displaying a virtual polyhedron on a desktop screen of a PC, providing different tools for respective surfaces of the virtual polyhedron displayed, and rotating the virtual polyhedron to switch a tool to be displayed has been proposed (e.g., Japanese Patent Application Laid-Open No. 2000-89886; hereinafter, “second document”).

The PC also includes a variety of user interfaces such as a keyboard and a pointing device. Thus, it is easy for a user to set desired functions. In the technology described in the second document, the virtual polyhedron displayed is rotated using interfaces such as a pointing device. It is possible to perform various setting using tools displayed on surfaces of the virtual polyhedron in the same manner as using the conventional tool window. It is possible to perform the various settings in this way because it is possible to input the settings using a device such as a pointing device that can specify more detailed positions or various keys of a keyboard or the like.

However, the technology for not displaying an item corresponding to an unavailable function in a screen described in the first document simply prevents a user from selecting the unavailable function by mistake. In other words, it is impossible to improve, using such a display technology, operability in setting input and output functions usually performed.

On the other hand, it is difficult to transfer the display technology provided for a PC described in the second document to an image forming apparatus and the like. A monitor of the PC is large because the monitor is designed on the premise that the user performs various kinds of work. It is possible to display an image at high resolution on the monitor. This makes it possible to use the display technology in the PC. A liquid crystal panel tends to be used more often for the monitor of the PC to reduce a space for arranging the monitor. The reduction in space is performed on condition that a size of the monitor is maintained.

A liquid crystal touch panel provided in an image forming apparatus is used only when functions of the image forming apparatus are set. Thus, the image forming apparatus only has to include a liquid crystal touch panel with a size necessary and sufficient for displaying and setting the functions. A size and resolution equivalent to those of the monitor of the PC are not required. Moreover, it is necessary to consider a space for arranging the image forming apparatus, arrangement of other functions such as a contact glass for arranging a paper original. Thus, a size of the liquid crystal touch panel that can be provided in the image forming apparatus is limited. This problem is present not only in the image forming apparatus but also in an apparatus with a size of a display unit limited because of portability or a place of installation.

In the apparatus in which portability, reduction in space, or other functions are given higher priorities than a size of the display unit such as the liquid crystal touch panel, it is impossible to use the display technology proposed to be used in the PC.

Similarly, the apparatus in which portability, reduction in space, or other functions are given higher priorities than interfaces does not include a variety of inputting means unlike the PC including the keyboard and the pointing device. Thus, it is difficult to set functions even if the display technology proposed to be used in the PC is used. For example, it is possible to designate a position by a unit of several dots using the pointing device. However, it is difficult to designate a position by a unit of several dots when a user manually selects a function using the liquid crystal touch panel.

### SUMMARY OF THE INVENTION

It is an object of the present invention to at least partially solve the problems in the conventional technology.

According to an aspect of the present invention, a display processing apparatus includes a display processing unit that displays a function indicating area having shown therein a function executed when selection thereof is accepted from a user; and a selection accepting unit that accepts selection of the function indicating area displayed.

According to another aspect of the present invention, a display processing method includes displaying a function indicating area having shown therein a function executed when selection from a user is accepted; and accepting selection of the function indicating area displayed.

According to still another aspect of the present invention, a computer program product that stores therein a computer program that causes a computer to execute displaying a function indicating area having shown therein a function executed when selection from a user is accepted; and accepting selection of the function indicating area displayed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic of a network diagram for explaining a network environment around a multi function peripheral (MFP) according to a first embodiment of the present invention;

FIG. 2 is a block diagram of a hardware configuration of the MFP according to the first embodiment;

FIG. 3 is a diagram of an example of an operation panel of the MFP according to the first embodiment;

FIG. 4 is a functional block diagram of the MFP according to the first embodiment;

FIG. 5 is a diagram of an example of a screen displayed on a liquid crystal touch panel by a display processing unit shown in FIG. 4;

FIG. 6 is a diagram for explaining a procedure for selecting a function used for input processing from the screen displayed on the liquid crystal touch panel according to the first embodiment;

FIG. 7 is a diagram for explaining a procedure for selecting a function used for output processing from the screen displayed on the liquid crystal touch panel according to the first embodiment;

FIG. 8 is a diagram of an example of a screen displayed on the liquid crystal touch panel after selection of item keys SCAN and PRINT is accepted in the MFP according to the first embodiment;

FIG. 9 is a diagram of an example of a screen in which the display processing unit displays MFP and PC as sub-item keys on the liquid crystal touch panel after selection of an item key LOAD is accepted in the MFP according to the first embodiment;

FIG. 10 is a diagram of an example of a screen displayed on the liquid crystal touch panel by the display processing unit when selection of item keys SCAN and LOAD of input functions is accepted and selection of an item key PRINT of an output function is accepted in the MFP according to the first embodiment;

FIG. 11 is a diagram of an example of a screen displayed on the liquid crystal touch panel by the display processing unit when selection of FAX and EMAIL is accepted as reception sources after selection of an item key RECEIVE of an input function is accepted in the MFP according to the first embodiment;

FIG. 12 is a diagram of an example of a screen displayed on the liquid crystal touch panel by the display processing unit when PC and MFP is accepted as writing destinations after selection of an item key SCAN of an input function is accepted and selection of an item key SAVE of an output function is accepted in the MFP according to the first embodiment;

FIG. 13 is a flowchart of a procedure of processing from display processing for a screen of input functions until selection by a user is accepted to perform output processing in the MFP according to the first embodiment;

FIG. 14 is a diagram of an example in which item keys displayed on the liquid crystal touch panel are arranged sideways;

FIG. 15 is a diagram of an example in which item keys displayed on the liquid crystal touch panel are arranged obliquely;

FIG. 16 is a diagram of an example in which items displayed on the liquid crystal touch panel are arranged in a telescopic structure;

FIG. 17 is a diagram of an example in which item keys displayed on the liquid crystal touch panel are arranged radially;

FIG. 18 is a diagram of an example of a screen displayed on a liquid crystal touch panel by a display processing unit of an MFP according to a modification of the first embodiment;

FIG. 19 is a functional block diagram of an MFP according to a second embodiment of the present invention;

FIG. 20 is a diagram of an example of a screen displayed on a liquid crystal touch panel by a display processing unit of the MFP according to the second embodiment;

FIG. 21 is a diagram for explaining an example in which a virtual cube is rotated by the display processing unit according to the control by a switching unit of the MFP according to the second embodiment;

FIG. 22 is a diagram for explaining a procedure from display of a virtual cube in which selection of a surface having an input function marking shown thereon is not accepted until display of a virtual cube in which selection of a surface having an input function marking shown thereon is accepted on a liquid crystal touch panel of the MFP according to the second embodiment;

FIG. 23 is a diagram for explaining a procedure from display of a virtual cube in which selection of a surface having an output function marking shown thereon is not accepted until display of a virtual cube in which selection of a surface having an output function marking shown thereon is accepted on the liquid crystal touch panel of the MFP according to the second embodiment;

FIG. 24 is a diagram for explaining an example of a virtual cube displayed by the display processing unit after a selection accepting unit accepts selection of a surface having SCAN shown thereon and a surface having PRINT shown thereon from a virtual cube displayed on the liquid crystal touch panel of the MFP according to the second embodiment;

FIG. 25 is diagram of an example of a virtual cube subjected to display processing by the display processing unit after the selection accepting unit accepts selection of a surface having an input function marking SCAN shown thereon and a surface having LOAD shown thereon from a virtual cube displayed on the liquid crystal touch panel of the MFP according to the second embodiment;

FIG. 26 is a diagram of an example of a virtual cube displayed by the display processing unit after the selection accepting unit accepts selection of a surface having an input function marking LOAD shown thereon, accepts selection of PC and MFP as input objects, that is, reception sources, and accepts selection of a surface having an output function marking PRINT shown thereon from a virtual cube displayed on the liquid crystal touch panel of the MFP according to the second embodiment;

FIG. 27 is a diagram of an example of a screen for accepting selection of an input object displayed by the display processing unit when selection of a surface having SCAN shown thereon of a virtual cube displayed on the liquid crystal touch panel of the MFP according to the second embodiment is accepted;

FIG. 28 is a diagram of an example of a screen for accepting selection of input objects displayed by the display processing unit when selection of a surface having RECEIVE shown thereon of a virtual cube displayed on the liquid crystal touch panel of the MFP according to the second embodiment is accepted;

FIG. 29 is a diagram of an example of a screen for accepting selection of input objects displayed by the display processing unit when selection of a surface having LOAD shown thereon of a virtual cube displayed on the liquid crystal touch panel of the MFP according to the second embodiment is accepted;

FIG. 30 is a diagram of an example of a screen for accepting selection of an output destination displayed by the display processing unit when selection of a surface having PRINT shown thereon of a virtual cube displayed on the liquid crystal touch panel of the MFP according to the second embodiment is accepted;

FIG. 31 is a diagram for explaining a preview and detailed setting screens displayed by the display processing unit when the selection accepting unit accepts selection of an item key PAPER in a screen displayed on the liquid crystal touch panel of the MFP according to the second embodiment;

FIG. 32 is a diagram of an example of a screen for accepting selection of output destinations displayed by the display processing unit when the selection accepting unit accepts selection of a surface having SEND shown thereon of a virtual cube displayed on the liquid crystal touch panel of the MFP according to the second embodiment;

FIG. 33 is a diagram of an example of a screen displayed after the selection accepting unit accepts selection of an item key FAX from a screen displayed on the liquid crystal touch panel of the MFP according to the second embodiment;

FIG. 34 is a diagram of an example of a screen for accepting selection of output destinations displayed by the display processing unit when the selection accepting unit accepts selection of a surface having SAVE shown thereon of a virtual cube displayed on the liquid crystal touch panel of the MFP according to the second embodiment;

FIG. 35 is a diagram for explaining an example in which a regular octahedron having functions indicated on respective surfaces thereof is used for the liquid crystal touch panel as an example different from the second embodiment;

FIG. 36 is a diagram for explaining an example in which a hexagonal prism having functions shown on respective sides thereof is used for the liquid crystal touch panel as an example different from the second embodiment;

FIG. 37 is a diagram for explaining an example in which an octagonal prism having functions shown on respective sides thereof is used for the liquid crystal touch panel as an example different from the second embodiment;

FIG. 38 is a diagram for explaining an example in which a regular tetrahedron having functions shown on respective surfaces thereof is used for the liquid crystal touch panel as an example different from the second embodiment;

FIG. 39 is a diagram for explaining an example in which a cylinder having input function markings and output function markings on respective predetermined areas on a side thereof is used for the liquid crystal touch panel as an example different from the second embodiment;

FIG. 40 is a diagram of an example of a screen displayed on a liquid crystal touch panel by a display processing unit according to a first modification of the second embodiment;

FIG. 41 is a diagram of am example of previews and detailed setting screens displayed by a display processing unit when selection of a surface with an output function marking PRINT shown thereon is accepted and selection of an item key PAPER is accepted in an MFP according to a third modification of the second embodiment;

FIG. 42 is a functional block diagram of a display processing apparatus according to a third embodiment of the present invention;

FIG. 43 is a functional block diagram of an MFP according to a fourth embodiment of the present invention;

FIG. 44 is a diagram for explaining an arrangement of a rotation axis for rotating a virtual cube displayed on a liquid crystal touch panel of the MFP according to the fourth embodiment;

FIG. 45 is a diagram for explaining an arrangement of a rotation axis for rotating a virtual cube by a stereoscopic-display processing unit according to the first embodiment different from the fourth embodiment;

FIG. 46 is a diagram for explaining an arrangement of a rotation axis for rotating a virtual cube by a stereoscopic-display processing unit according to the second embodiment different from the fourth embodiment;

FIG. 47 is a flowchart of a procedure of processing from display processing for a surface with an input function shown thereon of a virtual cube until selection of a surface having an input function and an output function shown thereon is accepted and subjected to output processing in the MFP according to the fourth embodiment;

FIG. 48 is a block diagram of a structure of an MFP according to a fifth embodiment of the present invention;

FIG. 49 is a diagram of an example of a screen displayed on a liquid crystal touch panel by a stereoscopic-display processing unit of the MFP according to the fifth embodiment;

FIG. 50 is a diagram for explaining an example in which a virtual cube corresponding to COPY is dragged and copied to a collection of shortcuts and functions of the virtual cube copied or setting conditions of the respective functions are changed on the liquid crystal touch panel of the MFP according to the fifth embodiment;

FIG. 51 is a diagram for explaining an example in which a virtual cube corresponding to COPY and a virtual cube corresponding to DATA PRINT are combined to create one virtual cube on the liquid crystal touch panel of the MFP according to the fifth embodiment;

FIG. 52 is a diagram for explaining an example in which a virtual cube corresponding to COPY and a virtual cube corresponding to SHORTCUT 1 are dragged and copied to respective surfaces of a reduced virtual cube in a space of reduction to generate a reduced virtual cube for performing a plurality of kinds of processing in order;

FIG. 53 is a diagram for explaining an example in which the stereoscopic-display processing unit of the MFP according to the fifth embodiment rotates the reduced virtual cube;

FIG. 54 is a flowchart of a procedure of processing in the MFP according to the fifth embodiment from display processing for a virtual cube until the virtual cube is saved; and

FIG. 55 is a block diagram of a structure of a display processing apparatus according to a sixth embodiment of the present invention.

### DETAILED DESCRIPTION OF THE PREFERRED EMBODIMENTS

Exemplary embodiments of the present invention are explained in detail below with reference to the accompanying drawings. A multi function peripheral (MFP), which is an image forming apparatus, has been explained below. However, the present invention is applicable not only to the MFP but also to various apparatuses that perform display processing.

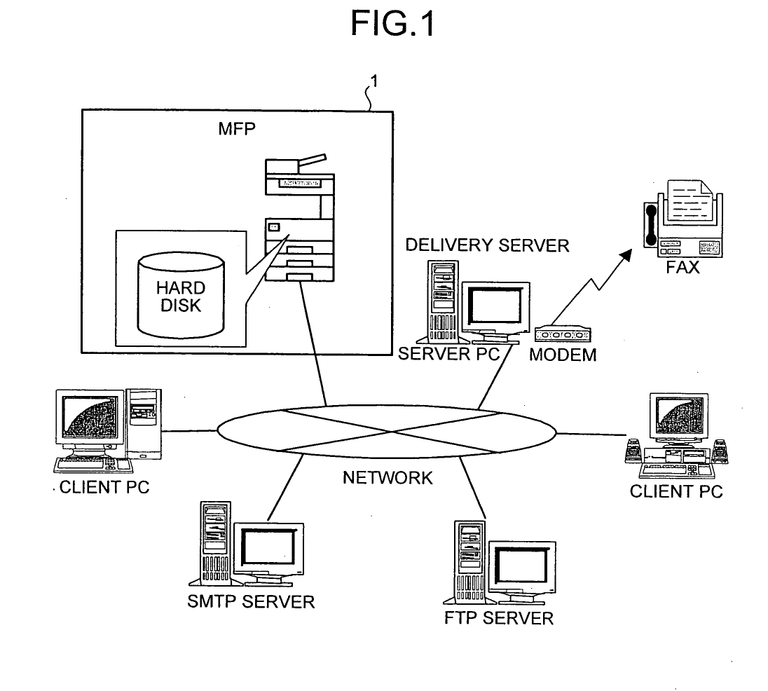

FIG. 1 is a network diagram for explaining a network environment around an MFP 1 that can execute functions of a display processing apparatus according to a first embodiment of the present invention. As shown in the figure, according to the progress of networking in recent years, apparatuses such as personal computers (PCs) provided in an office or the like are usually connected to a network such as a local area network (LAN) and communicate with one another. For example, a client PC, a simple mail transfer protocol (SMTP) server, a file transfer protocol (FTP) server, a server PC, and the like are connected to the network shown in the figure and can transmit and receive electronic mails and transfer files. A delivery server connected to the network by a modem can communicate with a facsimile apparatus outside the office.

According to such progress in networking, the MFP 1 is also connected to such a network and is capable of communicating with the apparatuses such as the PCs. When the MFP 1 includes a storage device such as a hard disk, the MFP 1 has developed into a so-called network multi function peripheral. Thus, the MFP 1 can meet various needs of users.

In addition to the usual copy function, the MFP 1 has acquired a printer function for printing document data and the like according to a print request from the client PC, a facsimile function for transmitting document data and the like to facsimile apparatuses in other offices through the modem connected to the server PC according to a facsimile request from the client PC, a storage function for storing a facsimile document and a copy document accepted in a built-in hard disk, and the like.

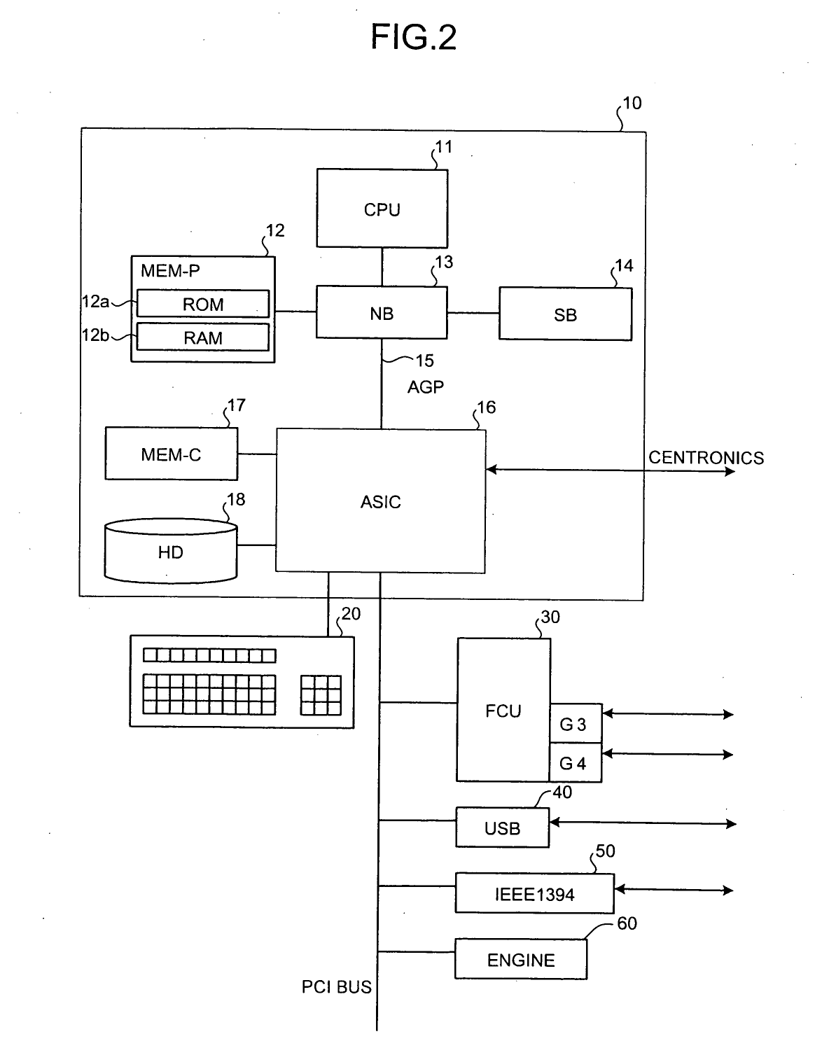

FIG. 2 is a block diagram of a hardware configuration of the MFP 1 according to the first embodiment. As shown in the figure, in the MFP 1, a controller 10 and an engine unit (engine) 60 are connected by a peripheral component interconnect (PCI) bus. The controller 10 is a controller that controls the entire MFP 1 and controls rendering, communication, and input from an operation unit 20. The engine unit 60 is a printer engine or the like that can be connected to the PCI bus. The engine unit 60 is, for example, a one-drum color plotter, a four-drum color plotter, a scanner, a facsimile unit, or the like. The engine unit 60 includes, in addition to a so-called engine section such as a plotter, an image processing section that performs image processing such as error diffusion and gamma conversion.

The controller 10 includes a central processing unit (CPU) 11, a north bridge (NB) 13, a system memory (MEM-P) 12, a south bridge (SB) 14, a local memory (MEM-C) 17, an application specific integrated circuit (ASIC) 16, and a hard disk (HD) 18. The NB 13 and the ASIC 16 are connected by an accelerated graphics port bus (AGP) 15. The MEM-P 12 has a read only memory (ROM) 12a and a random access memory (RAM) 12b.

The CPU 11 performs overall control of the MFP 1. The CPU 11 has a chip set including the NB 13, the MEM-P 12, and the SB 14 and is connected to other apparatuses via this chip set.

The NB 13 is a bridge for connecting the CPU 11 and the MEM-P 12, the SB 14, and the AGP 15. The NB 13 has a memory controller that controls reading of data from and writing of data in the MEM-P 12, a PCI master, and an AGP target.

The MEM-P 12 is a system memory used as a memory for storage of programs and data, a memory for expansion of programs and data, a memory for rendering of a printer, and the like. The MEM-P 12 includes the ROM 12a and the RAM 12b. The ROM 12a is a read only memory used as the memory for storage of programs and data. The RAM 12b is a random access memory used as the memory for expansion of programs and data, the memory for rendering of a printer, and the like.

The SB 14 is a bridge for connecting the NB 13 and a PCI device and a peripheral device. The SB 14 is connected to the NB 13 via the PCI bus. A network interface (I/F) unit and the like are also connected to the PCI bus.

The ASIC 16 is an integrated circuit (IC) for an image processing application that has hardware components for image processing. The ASIC 16 has a role of a bridge that connects the AGP 15, the PCI bus, the HD 18, and the MEM-C 17. The ASIC 16 includes a PCI target and an AGP master, an arbiter (ARB) that is at the core of the ASIC 16, a memory controller that controls the MEM-C 17, a plurality of direct memory access controllers (DMACs) that performs rotation and the like of image data according to a hardware logic and the like, and a PCI unit that performs data transfer via the PCI bus between the ASIC 16 and the engine unit 60. A fax control unit (FCU) 30, a universal serial bus (USB) 40, the Institute of Electrical and Electronics Engineers 1394 (IEEE1394), and an interface 50 are connected to the ASIC 16 via the PCI bus.

The MEM-C 17 is a local memory used as an image buffer for copying and a code buffer. The HD 18 is a storage device for storing image data, programs, font data, and forms.

The AGP 15 is a bus interface for a graphics accelerator card proposed for increasing speed of graphic processing. The AGP 15 directly accesses the MEM-P 12 at high throughput to increase speed of the graphics accelerator card.

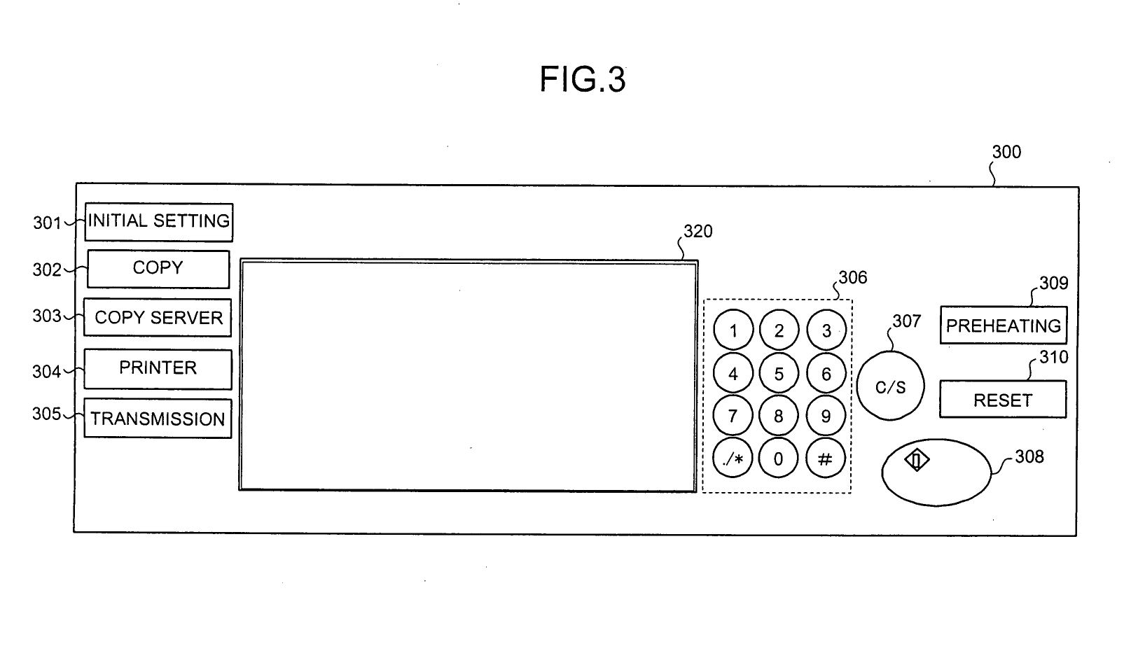

FIG. 3 is a diagram of an example of an operation panel 300 of the MFP 1. As shown in the figure, the operation panel 300 includes an initial setting key 301, a copy key 302, a copy server key 303, a printer key 304, a transmission key 305, a ten key 306, a clear/stop key 307, a start key 308, a preheating key 309, a reset key 310, and a liquid crystal touch panel 320. A screen is displayed on the liquid crystal touch panel 320. This screen is described later.

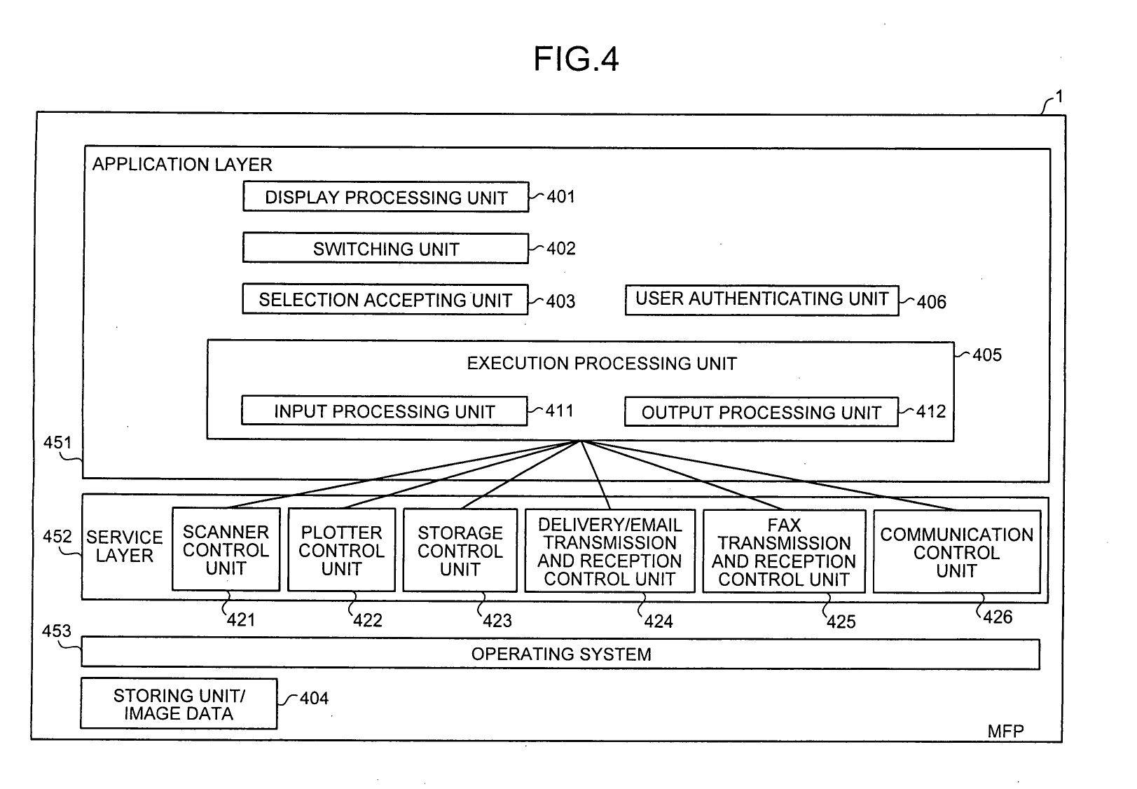

FIG. 4 is a functional block diagram of the MFP 1 that can executes the functions of the display processing apparatus according to the first embodiment. As shown in the figure, the MFP 1 includes an operating system 453, a service layer 452, an application layer 451, and a storing unit 404. The display processing apparatus according to this embodiment may be used in an image forming apparatus other than the MFP including the structure described above.

As shown in FIG. 4, the functions of the MFP 1 are in a hierarchical relation. The service layer 452 is constructed in a layer above the operating system 453. The application layer 451 including a characteristic part of this embodiment described later is constructed in a layer above the service layer 452.

The operating system 453 manages resources of the MFP 1 including hardware resources and provides the service layer 452 and the application layer 451 with functions that use the resources.

The service layer 452 is equivalent to a driver that controls the hardware resources included in the MFP 1. The service layer 452 controls the hardware resources included in the MFP 1 from a scanner control unit 421, a plotter control unit 422, a storage control unit 423, a delivery/e-mail transmission and reception control unit 424, a FAX transmission and reception control unit 425, a communication control unit 426, and the like of the service layer 452 according to a request for output processing from an execution processing unit 405 of the application layer 451 described later. Consequently, various functions are executed.

The storing unit 404 stores image data read from a paper original or received from an e-mail or a facsimile. The storing unit 404 is storing means capable of storing data such as image data. It is possible to constitute the storing unit 404 with any storing means generally used such as an HD, an optical disk, or a memory card.

The MFP 1 includes various hardware resources such as a scanner and a plotter other than the storing unit 404. However, explanations of the hardware resources are omitted.

The application layer 451 includes a display processing unit 401, a switching unit 402, a selection accepting unit 403, the execution processing unit 405, and a user authenticating unit 406. The application layer 451 switches a screen for displaying a marking of a function for performing input processing (hereinafter, “input function”) and a screen for displaying a marking of a function for performing output processing (hereinafter, “output function”). Moreover, the application layer 451 accepts selection of functions desired by a user on the respective screens and executes the input processing and the output processing after accepting the selection.

The user authenticating unit 406 performs authentication of a user when the user uses the MFP 1. Any authentication method may be used as a method of authenticating the user regardless of whether the authentication method is a technology well known to those skilled in the art. When the authentication of the user is successful in the user authenticating unit 406, the user is permitted to use a predetermined function in the MFP 1. Examples of the function, which the user is permitted to use, include transmission and reception of e-mails. It is assumed that the authentication of the user by the user authenticating unit 406 is performed first and, when functions described later are used, the authentication of the user has already been completed.

The display processing unit 401 displays a screen for displaying input functions and a screen for displaying output functions on the liquid crystal touch panel 320.

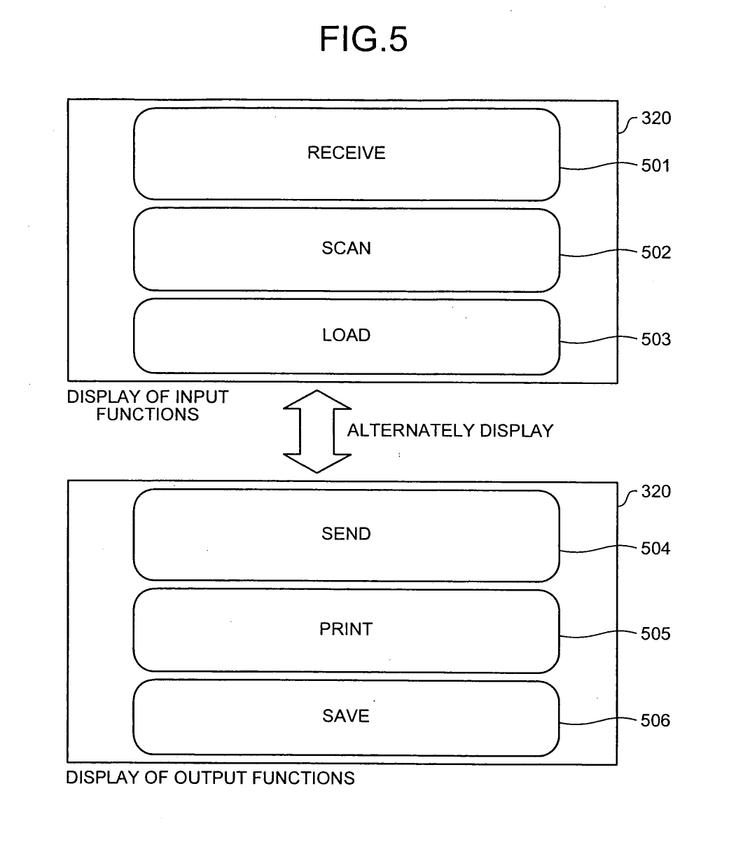

FIG. 5 is a diagram of an example of a screen displayed on the liquid crystal touch panel 320 by the display processing unit 401 according to this embodiment. As shown in the figure, the liquid crystal touch panel 320 switches the screen for displaying input functions and the screen for displaying output functions every predetermined time using the switching unit 402 described later. In the screen for displaying input functions, a predetermined area is prepared for each input function and an input function marking, which is a character string indicating the input function, is shown in the area. In the screen for displaying output functions, a predetermined area is prepared for each output function and an output function marking, which is a character string indicating the output function, is shown in the area. The display processing unit 401 displays, as areas for the respective input functions on the liquid crystal touch panel 20, item keys RECEIVE 501, SCAN 502, and LOAD 503. The display processing unit 401 displays, as areas for the respective output functions on the liquid crystal touch panel 320, item keys SEND 504, PRINT 505, and SAVE 506.

The item key RECEIVE 501 can be selected by the user as an item key indicating an input function for performing input processing of image data received from a network. SCAN 502 is an item key indicating an input function for scanning a paper original from an auto document feeder (ADF) included in the MFP 1 or scanning a paper original arranged on a contact glass to perform input processing for image data. LOAD 503 is an item key indicating an input function for performing input processing by reading image data stored in the storing unit 404. In other words, the areas representing the item keys indicating the input functions according to this embodiment are input instruction areas representing the input functions.

On the other hand, the item key SEND 504 is an item key indicating an output function for performing processing for transmitting image data to the network using an e-mail or a facsimile. The item key PRINT 505 is an item key indicating an output function for performing print processing for image data. The item key SAVE 506 is an item key indicating an output function for writing and storing image data in the storing unit 404. In other words, the areas representing the item keys indicating the output functions according to this embodiment are output instruction areas representing the output functions.

The input function and the output function represented as the item keys arranged in the identical area have a predetermined relation before and after switching the screen for displaying input functions and the screen for displaying output functions. The predetermined relation may be any relation as long as the relation is a relation about functions. However, in this embodiment, in the predetermined relation, a medium of an input source subjected to input processing by the input function and a medium of an output destination subjected to output processing by the output function have the same characteristic.

For example, the predetermined relation is a relation in which, when an image is copied, the image is read from a paper medium and printed on a paper medium. This indicates that a scan function for a paper original indicated by SCAN 502 and a print function for a paper original indicated by PRINT 505 are in the predetermined relation.

This indicates that transmission and reception via the network, that is, an input function indicated by RECEIVE 501 for performing input processing of image data accepted from the network and an output function indicated by SEND 504 for performing processing for transmitting image data to the network are also in the predetermined relation. Moreover, this indicates that an input function indicated by LOAD 503 for performing input processing for image data read in the storing unit 404 and an output function indicated by SAVE 506 for performing processing for writing image data in the storing unit 404 are also in the predetermined relation.

Specifically, as shown in FIG. 5, the display processing unit 401 displays the item keys RECEIVE 501 and SEND 504 about transmission and reception via the network in upper sections, displays the item keys SCAN 502 and PRINT 505 about reading or print processing for a paper original in middle sections, and displays the item keys LOAD 503 and SAVE 506 about reading or writing processing using the storing unit in lower sections. This makes it easy for the user to grasp a correspondence relation. Thus, the user can grasp, when the user refers to item keys, what kinds of functions the item keys indicate. This improves convenience and visibility.

The switching unit 402 performs processing for switching the screen for displaying input functions and the screen for displaying output functions displayed by the display processing unit 401. The switching unit 402 switches the screens at an appropriate time interval to allow the user to accept selection of a function in the MFP 1. In this embodiment, the switching unit 402 switches the screens every three seconds. It goes without saying that, in this embodiment, a predetermined time for switching the screens is not limited to three seconds.

The selection accepting unit 403 accepts selection of an area indicated by an item key from a screen displayed by the display processing unit 401. Specifically, when the user depresses an item key displayed on the liquid crystal touch panel 320 by the display processing unit 401, the selection accepting unit 403 considers that the item key is selected and accepts the selection.

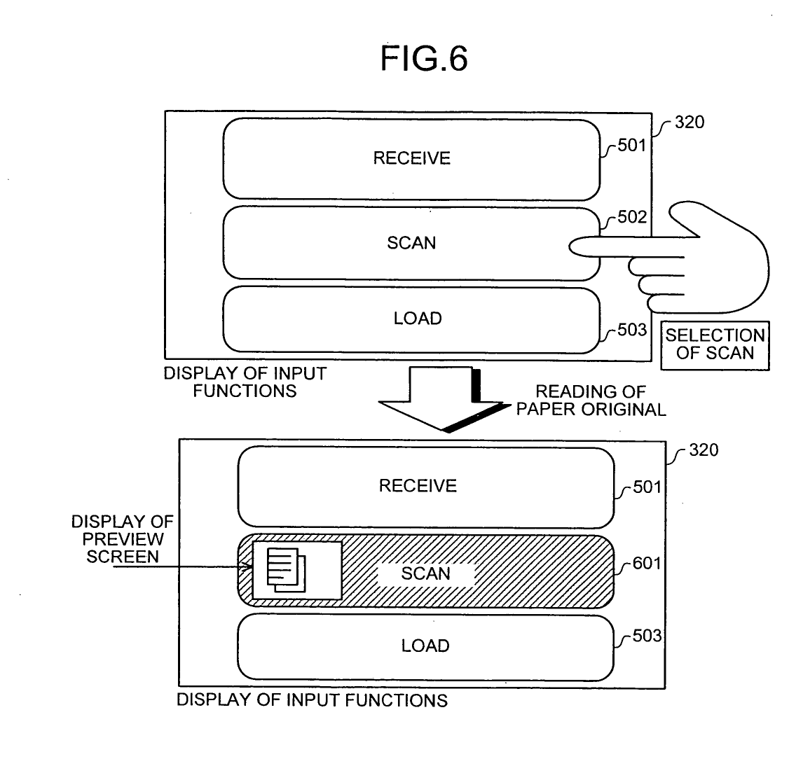

FIG. 6 is a diagram for explaining a procedure until a function used for input processing is selected from a screen displayed on the liquid crystal touch panel 320 according to this embodiment. As shown in the figure, the item keys RECEIVE 501, SCAN 502, and LOAD 503 are displayed on the liquid crystal touch panel 320 as markings of input functions. When the user depresses SCAN 502, the selection accepting unit 403 considers that the item key SCAN 502 is selected and accepts the selection. Consequently, an input processing unit 411 judges that processing for reading a paper original is performed.

When the selection accepting unit 403 accepts selection of an item key, the display processing unit 401 changes a color of the item key, selection of which is accepted by the selection accepting unit 403. In the example shown in FIG. 6, since the selection of the item key SCAN 601 is accepted in the upper section of FIG. 6, the display processing unit 401 changes a color of the item key and displays an item key SCAN 601 as shown in the lower section of FIG. 6. This makes it possible to cause the user to recognize that the selection of the item key is accepted. The input processing unit 411 reads the paper original and subjects the paper original to input processing as image data. The display processing unit 401 displays, in the item key SCAN 601 selected by the user, a preview schematically indicating a result of the input processing. This allows the user to recognize the result of the input processing.

The number of images displayed on the preview schematically indicating the result of the input processing may be identical with the number of images actually subjected to the input processing or may be abbreviated. This means that, for example, when there are one or two images, the images are displayed to allow the user to grasp the number but, when there are three or more images, the images are displayed to urge the user to simply recognize that there are a plurality of images. Similarly, the number of images displayed on a preview schematically indicating a result of output processing described later may be identical with the number of images actually subjected to the output processing or may be abbreviated.

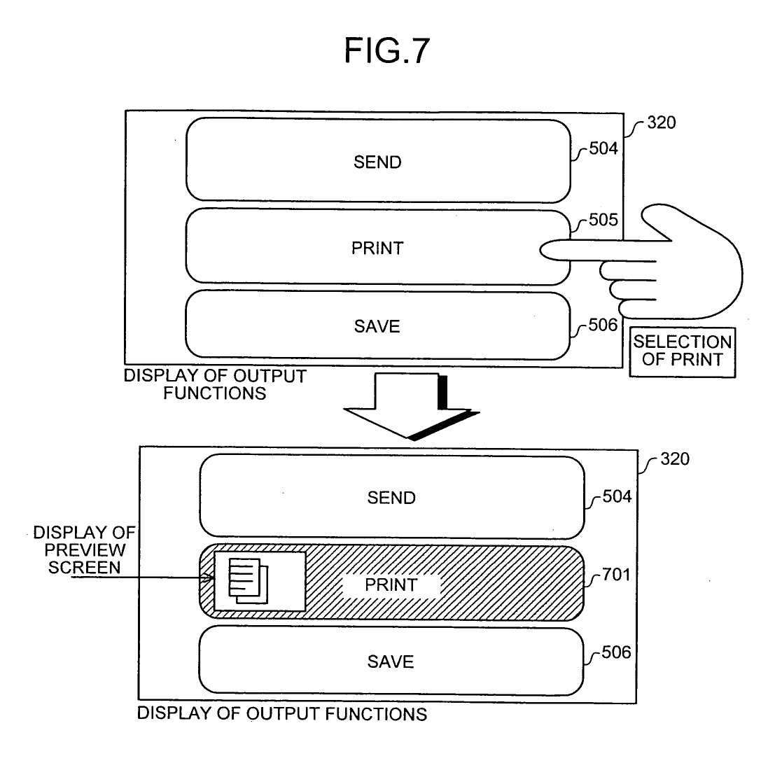

FIG. 7 is a diagram for explaining a procedure until a function used for output processing is selected from a screen displayed on the liquid crystal touch panel 320 according to this embodiment. As shown in the figure, the item keys SEND 504, PRINT 505, and SAVE 506 are displayed on the liquid crystal touch panel 320 as a marking of output functions. When the user depresses the item key PRINT 505, the selection accepting unit 403 considers that the item key PRINT 505 is selected and accepts the selection. Consequently, an output processing unit 412 judges that processing for printing the paper original is performed.

When the selection accepting unit 403 accepts selection of an item key, the display processing unit 401 changes a color of the item key, selection of which is accepted by the selection accepting unit 403. In the example shown in FIG. 7, since the selection of the item key PRINT 505 is accepted in the upper section of FIG. 7, the display processing unit 401 changes a color of the item key and displays an item key PRINT 701 as shown in the lower section of FIG. 7. This makes it possible to urge the user to recognize that the selection of the item key is accepted. The display processing unit 401 displays, in the item key PRINT 701 selected by the user, a preview schematically indicating image data printed as a paper original by the output processing unit 412. This allows the user to recognize the result of the output processing. In other words, compared with color reversal or the like of an item key or an explanation of a function by a text explanation, which has been conventionally used, the user can intuitively understand functions.

The number of images displayed on the preview schematically indicating the result of the output processing may be identical with the number of images actually subjected to the output processing or may be abbreviated as in the case of the number of images displayed on the preview schematically indicating the result of the input processing.

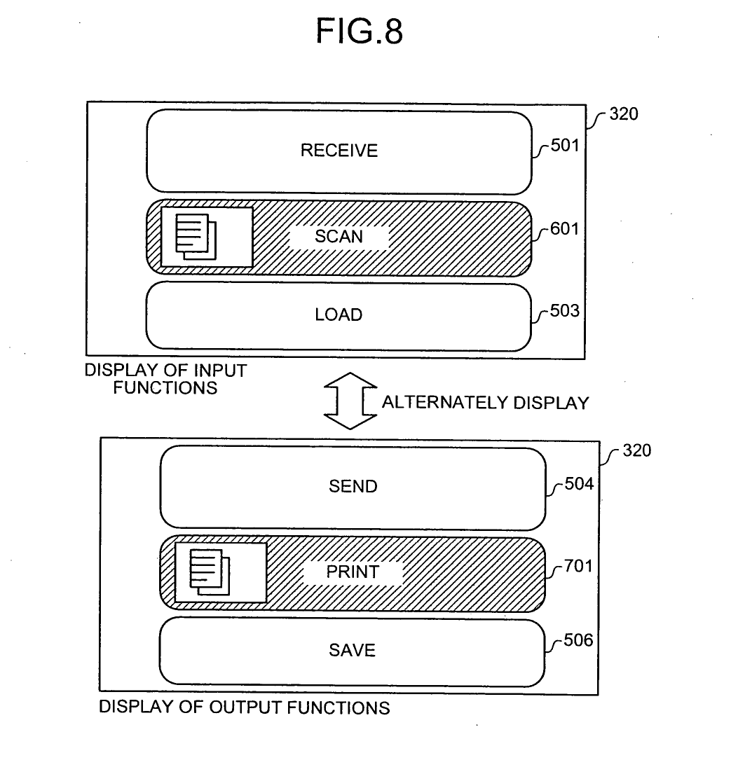

FIG. 8 is a diagram of an example of a screen displayed on the liquid crystal touch panel 320 after the selection of the item keys SCAN 601 and PRINT 701 is accepted. As shown in the figure, the display processing unit 401 alternately switches and displays the screen for displaying input functions and the screen for displaying output functions even after selection is accepted. Since a color of an item key, selection of which is accepted, and a color of other item keys are different, the user can recognize selection of which item key is accepted. Moreover, the display processing unit 401 displays, in the item key selected, a preview schematically indicating results of input processing and output processing. This allows the user to recognize whether the results of the processing have a problem with reference to the preview. When the user judges that there is no problem with reference to the preview, the user depresses the start key 308. Then, the execution processing unit 405 described later performs processing for printing.

After an item key is depressed and the selection accepting unit 403 accepts selection of the item key, the display processing unit 401 may display a sub-item key in the item key selected to urge the user to select the sub-item key.

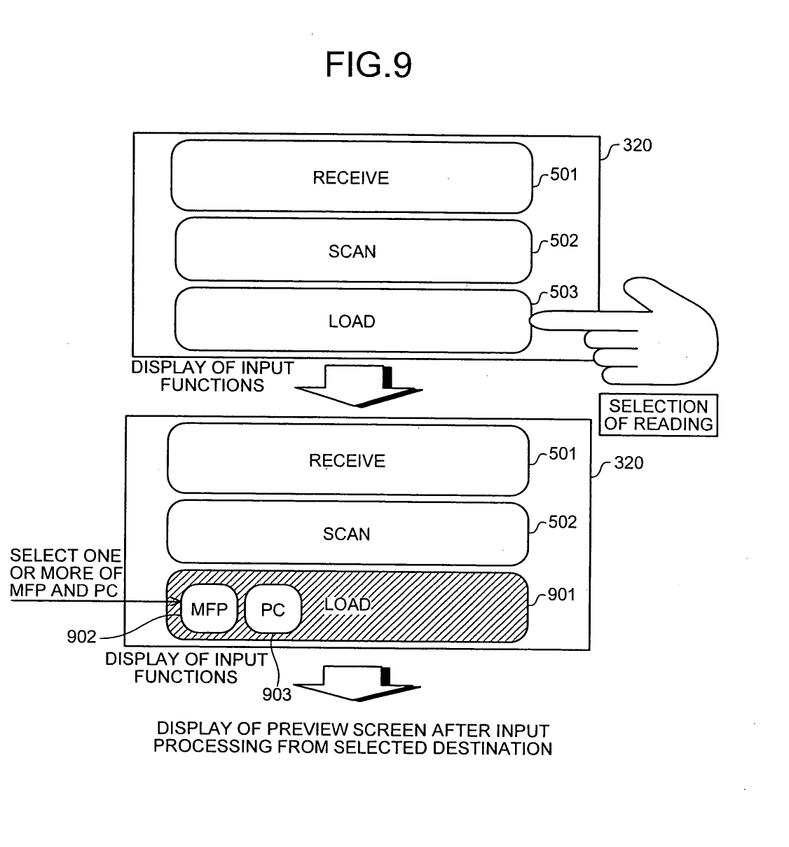

FIG. 9 is a diagram of an example of a screen in which the display processing unit 401 displays MFP 902 and PC 903 as sub-item keys on the liquid crystal touch panel 320. As shown in the figure, when selection of the item key LOAD 503 is accepted, the user needs to designate reading destinations of image data. Thus, the display processing unit 401 displays the sub-item keys MFP 902 and PC 903 corresponding to the reading destinations in an item key LOAD 901. This allows the user to select a reading destination. When the user depresses at least one sub-item key of the sub-item keys MFP 902 and PC 903, the selection accepting unit 403 accepts selection of the sub-item key depressed. Consequently, the execution processing unit 405 judges that the reading destination corresponding to the sub-item key, selection of which is accepted, as a processing object.

In this way, the display processing unit 401 displays item keys on the liquid crystal touch panel 320 and, after selection of an item key is accepted, displays sub-item keys. In this embodiment, the item keys and the sub-item keys are displayed in a hierarchical structure. Hierarchies, selection of which is not accepted, in the hierarchical structure, that is, the sub-item keys present below the item keys, selection of which is not accepted, are not displayed. Consequently, display in the screen on the liquid crystal touch panel 320 according to this embodiment is not complicated and visibility is improved.

When the selection of the sub-item key is accepted, the user moves to a not-shown file selection screen and selects image data to be subjected to input processing. A procedure for selecting a file may be any procedure. For example, it is also possible that, as in the past, a list of image data stored in the MFP 1 or the PC is displayed on the liquid crystal touch panel 32 and, when the user select image data from the list of image data displayed, the selection accepting unit 403 may accept the selection of the image data. When the selection of the image data is accepted, the input processing unit 411 performs processing for inputting the image data, selection of which is accepted. Thereafter, the display processing unit 401 returns to the screen in which the item keys are displayed. In this screen, the display processing unit 401 displays a preview of the image data, selection of which is accepted, in a frame of the item key LOAD, selection of which is accepted.

In the MFP 1 according to this embodiment, it is possible to select a plurality of item keys indicating input functions and a plurality of item keys indicating output functions, respectively. In this way, it is possible to select a plurality of item keys. This makes it possible to execute processing desired by the user and improves operability.

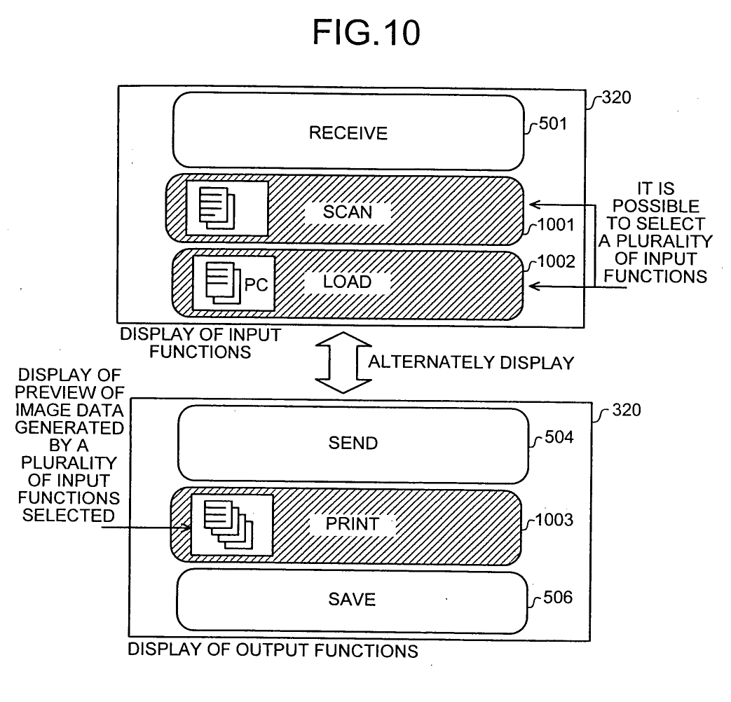

FIG. 10 is a diagram of an example of a screen displayed on the liquid crystal touch panel 320 by the display processing unit 401 when selection of item keys SCAN 1001 and LOAD 1002 of input functions used for processing is accepted and selection of an item key PRINT 1003 of an output function is accepted. As shown in the figure, when selection of a plurality of item keys of input functions is accepted, the display processing unit 401 displays a preview for each of the item keys, selection of which is accepted.

The display processing unit 401 displays, in the item key, selection of which is accepted, a preview schematically indicating a result of output processing of the image data subjected to input processing by the input functions, selection of which is accepted. When the selection of the item keys indicating input functions is accepted, the user can check the preview schematically indicating the result of the output processing.

When selection of a plurality of output functions is accepted, as at the time when the selection of a plurality of input function is accepted, the display processing unit 401 changes colors of a plurality of item keys, selection of which is accepted, and display a preview in the respective item keys.

The selection accepting unit 403 of the MFP 1 according to this embodiment can accept selection of sub-item keys held by one item key from the user. In other words, the execution processing unit 405 can apply processing to a plurality of input processing sources and a plurality of output processing sources corresponding to the sub-item keys.

FIG. 11 is a diagram of an example of a screen displayed on the liquid crystal touch panel 320 by the display processing unit 401 when selection of FAX and EMAIL is accepted as reception sources after selection of an item key RECEIVE of an input function is accepted. In the screen shown in the figure, first, the user depresses the item key RECEIVE 501 and the selection accepting unit 403 accepts selection of item key RECEIVE 501. Thereafter, the user depresses a sub-item key FAX and the selection accepting unit 403 accepts selection of FAX. After accepting the selection of the item key RECEIVE 501, the selection accepting unit 403 accepts selection of a sub-item key EMAIL according to depression of the sub-item key by the user. Consequently, the screen shown in FIG. 11 is displayed by the display processing unit 401. As shown in the figure, the display processing unit 401 displays, in an item key RECEIVE 1101, a preview schematically indicating a result of input processing of FAX and EMAIL.

After accepting selection of the item key SAVE 506 indicating an output function, the selection accepting unit 403 further accepts selection of FAX and EMAIL. Then, the display processing unit 401 displays a preview schematically indicating a result of output processing of image data subjected to input processing. When the selection accepting unit 403 accepts selection of sub-item keys indicating a plurality of input processing objects from one function, the input processing unit 411 can subject a plurality of image data to input processing according to an identical input function. Moreover, the output processing unit 412 can subject one or more image data to output processing using the image data subjected to the input processing and using an output function corresponding to the item key, selection of which is accepted.

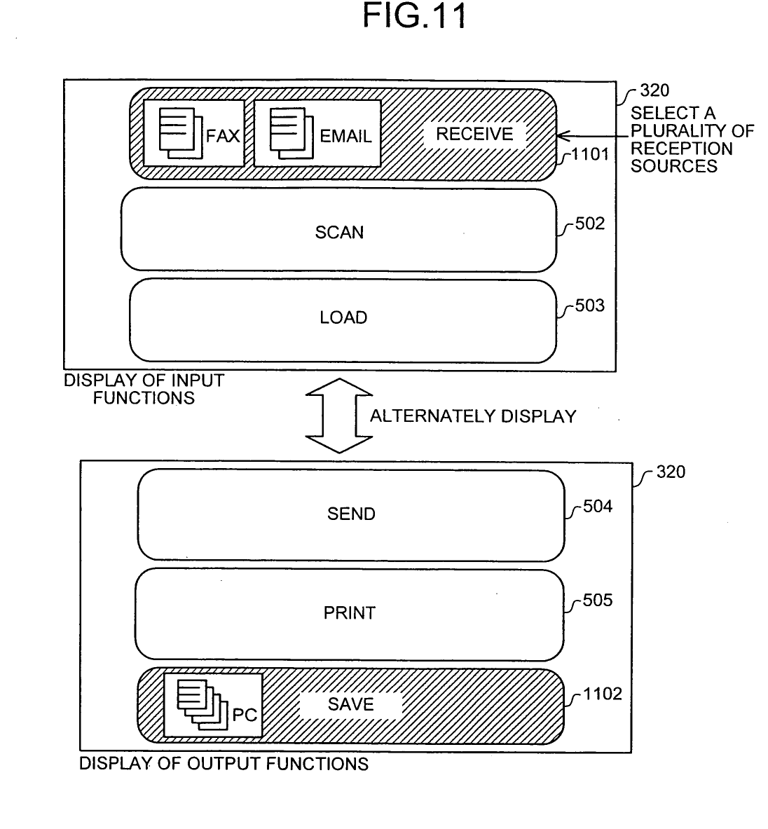

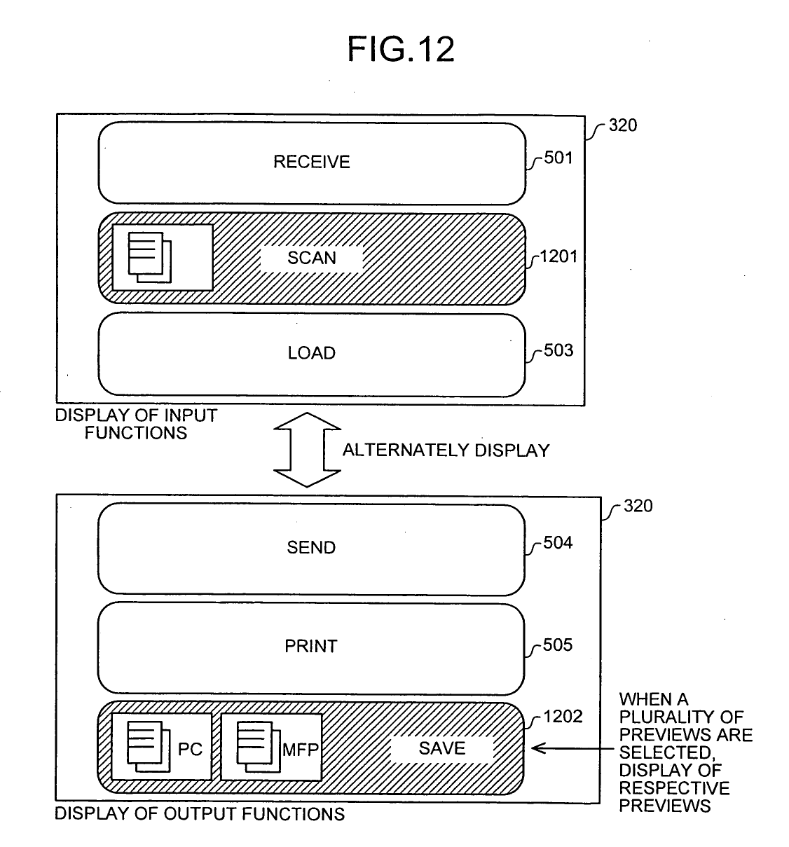

FIG. 12 is a diagram of an example of a screen displayed on the liquid crystal touch panel 320 by the display processing unit 401 when selection of sub-item keys PC and MFP is selected as writing destinations after selection of the item key SCAN 502 of an input function and selection of the item key SAVE 506 indicating an output function is accepted. As shown in the figure, the display processing unit 401 displays, in an item key SCAN 1201, a preview schematically indicating image data subjected to input processing. Moreover, the display processing unit 401 displays, in an item key SAVE 1202, a preview schematically indicating a result of output processing for output to output destinations corresponding to the sub-item keys PC and MFP, selection of which is accepted, using the image data subjected to the input processing.

When the user depresses the start key 308 after the selection shown in FIG. 12 is accepted, the output processing unit 412 saves image data inputted from a paper original in the PC and the MFP 1 using a writing function corresponding to SAVE 1202. It is possible to output one image data subjected to the input processing in this way to a plurality of output processing destinations.

Operability in accepting selection of item keys and the like in the screen displayed by the display processing unit 401 is improved. This makes it easy to execute processing that uses functions corresponding to the item keys in the processing explained with reference to FIGS. 11 and 12.

Referring back to FIG. 4, the execution processing unit 405 includes the input processing unit 411 and the output processing unit 412 and performs input and output processing that uses the functions of the MFP 1. The respective control units included in the service layer 452 controls the hardware resources based on the details of the processing of the execution processing unit 405. As a result, processing that uses hardware is performed.

The input processing unit 411 subjects the image data that uses an input function corresponding to the item key, selection of which is accepted by the selection accepting unit 403, to input processing. In other words, when the selection accepting unit 403 accepts selection of the item key SCAN 502, the input processing unit 411 controls a not-shown scanner using the scanner control unit 421 to perform processing for reading the paper original. When the selection accepting unit 403 accepts selection of the item key RECEIVE 501, the input processing unit 411 controls a not-shown network communication function using the communication control unit 426 to perform processing for accepting the image data. When the selection accepting unit 403 accepts selection of the item key LOAD 503, the input processing unit 411 controls the storing unit 404 included in the MFP 1 using the storage control unit 423 or controls the HD included in the PC, which is connected to the MFP 1 via the network, using the communication control unit 426 to perform processing for reading the image data.

The output processing unit 412 subjects the image data to output processing using an output function corresponding to the item key, selection of which is accepted by the selection accepting unit 403. In other words, when the selection accepting unit 403 accepts selection of the item key PRINT 505, the output processing unit 412 controls a not-shown plotter using the plotter control unit 422 to control processing for printing the image data as a paper original. When the selection accepting unit 403 accepts selection of the item key SEND 504, the output processing unit 412 controls the network communication function using the communication control unit 426 to perform processing for transmitting the image data. When the selection accepting unit 403 accepts selection of the item key SAVE 506, the output processing unit 412 controls the storing unit 404 included in the MFP 1 using the storage control unit 423 or controls the HD included in the PC or the like, which is connected to the MFP 1 via the network, using the communication control unit 426 to perform processing for writing the image data.

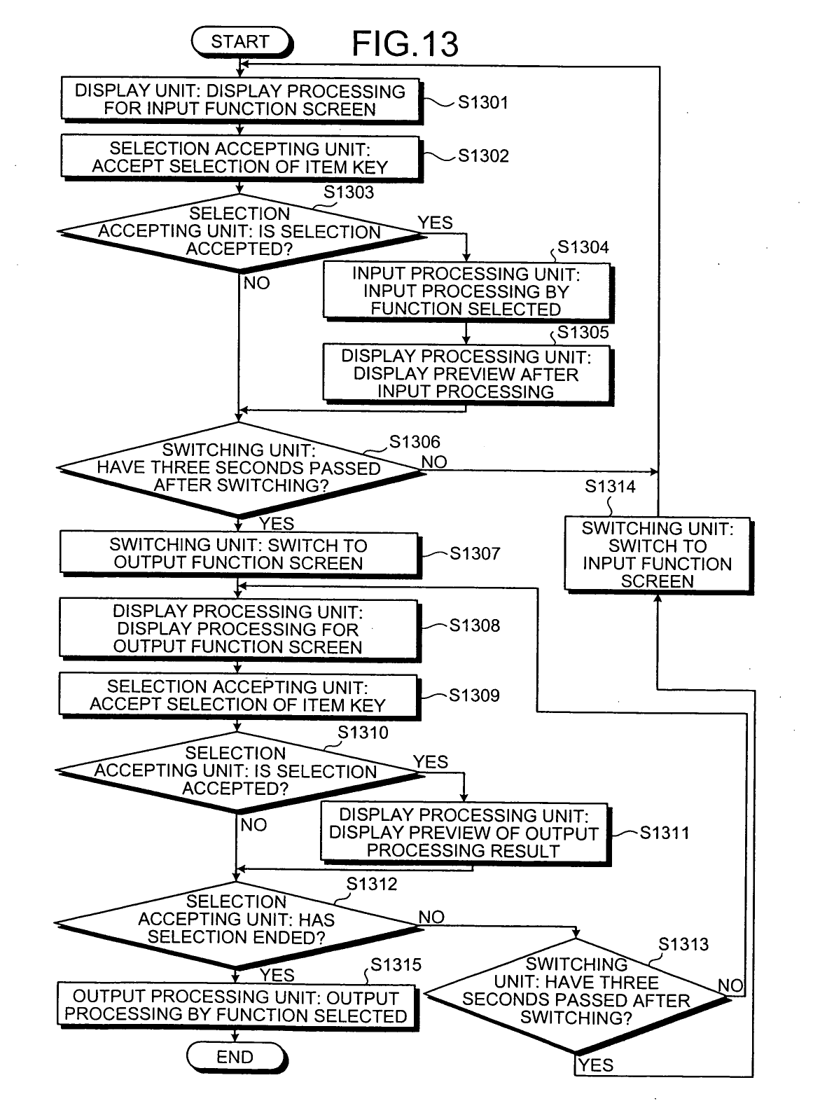

Processing from display processing for a screen of input functions until selection by a user is accepted and output processing is performed in the MFP 1 according to this embodiment constituted as described above is explained. FIG. 13 is a flowchart of a procedure of the processing in the MFP 1 according to this embodiment.

First, the display processing unit 401 displays a screen of input functions (step S1301). The selection accepting unit 403 accepts selection of an item key indicating an input function (step S1302).

The selection accepting unit 403 judges whether the selection of the item key indicating an input function is accepted (step S1303). When the selection accepting unit 403 judges that the selection is accepted (“Yes” at step S1303), the input processing unit 411 performs input processing by an input function corresponding to the item key, selection of which is accepted (step S1304). After the input processing is performed, the display processing unit 401 displays a preview schematically indicating a result of the input processing on the liquid crystal touch panel 320 (step S1305).

When the selection accepting unit 403 judges that the selection is not accepted (“No” at step S1303), the input processing unit 411 does not perform processing in particular.

The switching unit 402 judges whether three seconds have passed after the screen of input functions is displayed (step S1306).

When the switching unit 402 judges that three seconds have not passed after the screen of input functions is displayed (“No” at step S1306), the switching unit 402 does not switch the screen and the display processing unit 401 directly performs processing for displaying the screen of input functions (step S1301).

When the switching unit 402 judges that three seconds have passed after the screen of input functions is displayed (“Yes” at step S1306), the switching unit 402 controls the display processing unit 401 to switch the screen to a screen of output functions (step S1307).

The display processing unit 401 performs processing for displaying the screen of output functions (step S1308).

The selection accepting unit 403 accepts selection of an item key indicating an output function from the user (step S1309). The selection accepting unit 403 judges whether the selection of the item key indicating an output function is accepted from the user (step S1310). When it is judged that the selection is accepted (“Yes” at step S1310), the display processing unit 401 displays, on the liquid crystal touch panel 320, a preview of a result of output processing performed using the image data subjected to the input processing (step S1311).

When the selection accepting unit 403 judges that the selection is not accepted (“No” at step S1310), the display processing unit 401 does not perform processing in particular.

The selection accepting unit 403 judges whether the reception of the selection by the user has ended (step S1312). Specifically, the selection accepting unit 403 judges, according to whether the user has depressed the start key 308, whether the reception of the selection by the user has ended. However, the selection accepting unit 403 judges whether the reception of the selection has ended only when the selection of the item key indicating an input function is accepted at step S1303 and the selection of the item key indicating an output function is accepted at step S1310. When these conditions are not satisfied, a warning to that effect is displayed on the liquid crystal touch panel 320.

When the selection accepting unit 403 judges that the reception of the selection has not ended (“No” at step S1312), the output processing unit 412 does not perform processing in particular. The switching unit 402 judges whether three seconds have passed after the screen of output functions is displayed (step S1313).

When the switching unit 402 judges that three seconds have not passed after the screen of output functions is displayed (“No” at step S1313), the switching unit 402 does not switch the screen and the display processing unit 401 directly performs processing for displaying the screen of output functions (step S1308).

When the switching unit 402 judges that three seconds have passed after the screen of output functions is displayed (“Yes” at step S1313), the switching unit 402 controls the display processing unit 401 to switch the screen to a screen of input functions (step S1314).

When the selection accepting unit 403 judges that the reception of the selection has ended (“Yes” at step S1312), the output processing unit 412 applies output processing by an output function corresponding to the item key, selection of which is accepted at step S1310, to the image data already subjected to the input processing at step S1304 (step S1315).

The processing procedure makes it easy for the user to select functions used in input processing and output processing and makes it possible to perform processing of image data using a requested function. The processing procedure indicates an example of a processing procedure from processing for displaying a screen of input functions until selection by the user is accepted and output processing is performed. The embodiment is not limited to this processing procedure.

In this embodiment, the display processing unit 401 arranged rectangular item keys lengthwise on the liquid crystal touch panel 320. However, the arrangement of the item keys is not limited to such an arrangement. As described below, various arrangements are conceivable. Other than the arrangements described below, any arrangement may be adopted as long as it is possible to switch an item key indicating an input function and an item key indicating an output function.

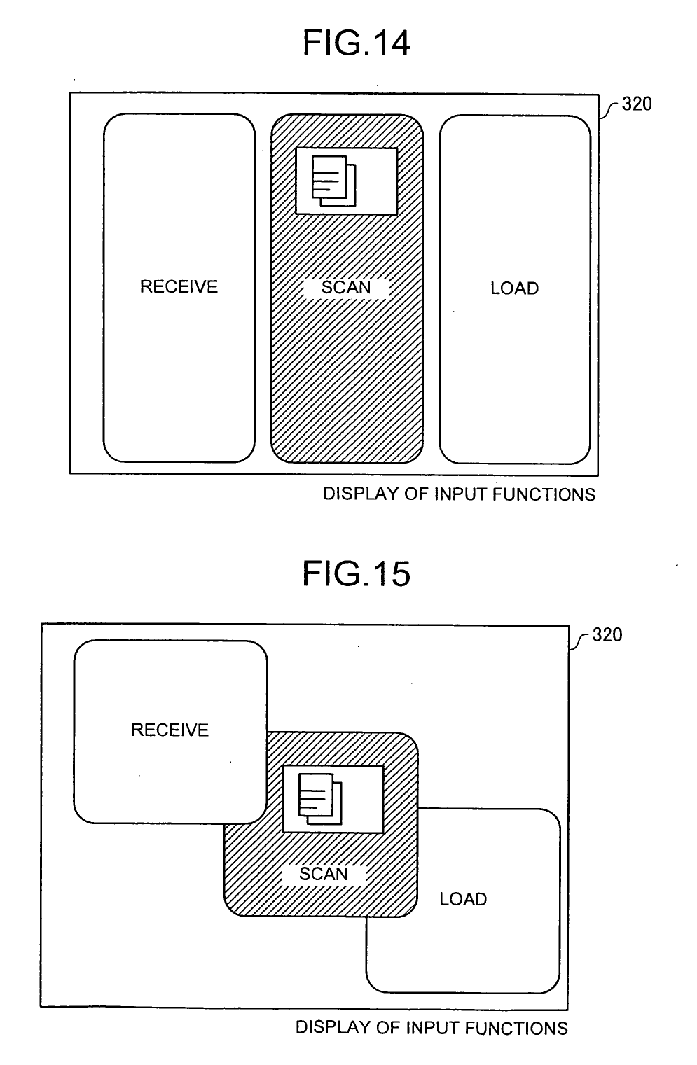

FIG. 14 is a diagram of an example in which item keys displayed on the liquid crystal touch panel 320 are arranged sideways. Except the arrangement of the item keys shown in the figure; the same processing as this embodiment is performed. The same holds true for FIGS. 15, 16, and 17.

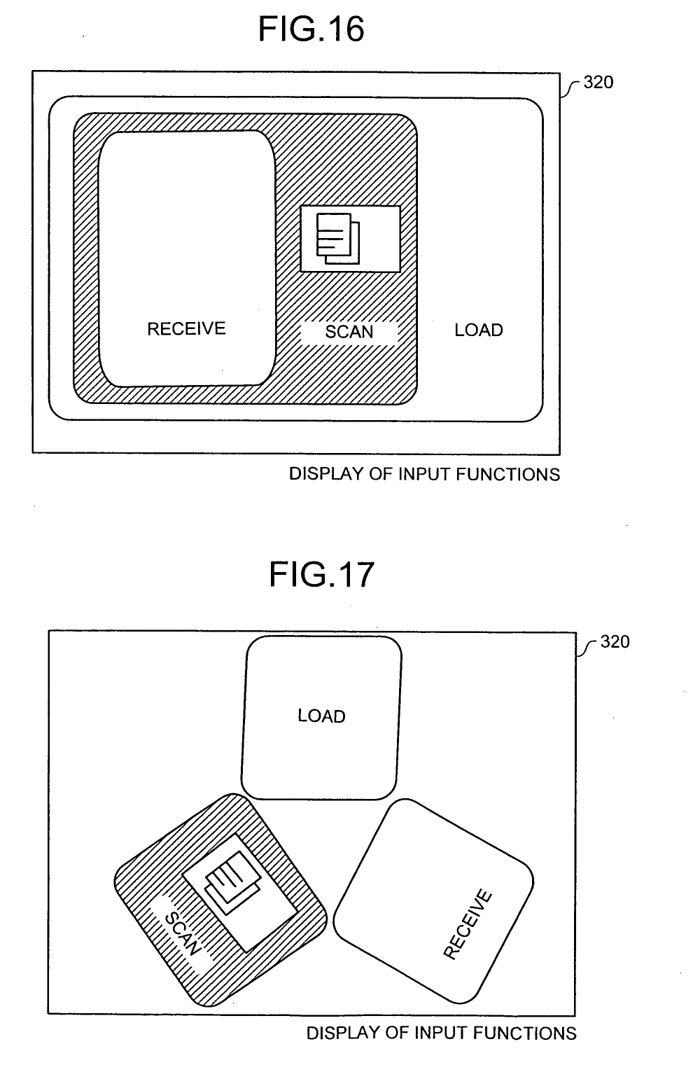

FIG. 15 is a diagram of an example in which item keys are arranged obliquely. FIG. 16 is a diagram of an example in which item keys are arranged in a telescopic structure. FIG. 17 is a diagram of an example in which item keys are arranged radially. In this way, diverse variations are possible for the arrangement of item keys.

A shape of an item key is not limited to a rectangular shape. The item key may be formed in any shape such as a circular shape.

The display processing unit 401 is not limited to explicit display of areas of a rectangular shape or the like as item keys on the liquid crystal touch panel 320. For example, the display processing unit 401 may display only a character string indicating a function without displaying an area for each item. In this case, it is conceivable that, when the character string indicating the function is depressed, the selection accepting unit 403 accepts selection of an area surrounding the character string and the display processing unit 401 changes a character color or the like of the character string, selection of which is accepted, and displays the character string.

This embodiment does not limit a color arrangement of item keys arranged in a screen of input functions and a screen of output functions displayed. The item keys may be displayed in any color arrangement. In this embodiment, a color arrangement of item keys displayed is varied according to a difference between the screen of input functions and the screen of output functions. As a specific example, the display processing unit 401 changes a color of an item key of an input function, selection of which is accepted, to blue and changes a color of an item key of an output function, selection of which is accepted, to red to display the item keys. This allows the user to easily recognize visually whether a function, selection of which is accepted, is an input function or an output function. As an example of a color arrangement different from this embodiment, it is conceivable to set the same color arrangement for all item keys displayed regardless of whether a screen is a screen of input functions or a screen of output functions or set different color arrangements for the respective item keys.

The display processing unit 401 according to this embodiment displays item keys in the screen of input functions and item keys in the screen of output functions in the same rectangular shape. However, the item keys may be displayed in the screen of input functions and the screen of output functions in different shapes. As a specific example, it is conceivable to display the item keys in any shapes in such a manner as to display the item keys in the screen of input functions in an elliptical shape and display the item keys in the screen of output functions in a rectangular shape.

In this embodiment, an input function marking and an output function marking arranged in an item key displayed by the display processing unit 401 are displayed as character strings.

However, the input function marking and the output function marking according to this embodiment are not limited to character strings. Any markings may be used as long as the markings make it possible to recognize an input function and an output function. For example, figures such as icons or marks indicating the input function and the output function may be used or signs or the like may be used as markings indicating the input function and the output function.

This embodiment does not specifically limit an order of accepting selection of an item key indicating an input function and an item key indicating an output function. In this embodiment, either the item key indicating an input function or the item key indicating an output function may be selected first. Selection of the item key indicating an input function and the item key indicating an output function only has to be accepted before output processing is actually performed.

When it is possible to accept selection of the item key indicating an input function after accepting selection of the item key indicating an output function, the display processing unit 401 does not display a preview at a stage when the selection of the item key of an output function is accepted. After the selection of the item key of an output function is accepted later, the display processing unit 401 display a preview for each item key, selection of which is accepted, using image data subjected to input processing by the input processing unit 411.

As an example different from this embodiment, it is conceivable that the selection accepting unit does not perform control for accepting selection of an item key indicating an output function before accepting selection of an item key indicating an input function. In this case, it is conceivable that, for example, the selection accepting unit performs control for accepting selection of the item key indicating an output function only after accepting selection of the item key indicating an input function.

In this embodiment, the MFP 1 switches and displays an item key indicating an input function and an item key indicating an output function every predetermined time. Thus, even the liquid crystal touch panel 320 having limited resolution and size of a screen to be displayed can display item keys for all functions. Since the item keys are switched every predetermined time to switch an item key to be displayed, it is possible to cause the user to grasp the item keys indicating an input function and an output function even if the user does not perform particular operation. This makes it possible to set an input function and an output function corresponding to a request of the user when processing is performed. Since the item keys are switched every three seconds, the user does not have to perform processing for switching a function to be displayed. Thus, operability is improved. Moreover, since it is possible to accept selection of an input function and an output function when the item keys are displayed, operability is improved.

In the first embodiment, the display processing unit 401 displays sub-item keys only when the selection accepting unit 403 accepts selection of an item key, or displays the sub-item keys in a hierarchical structured. Display of item keys and sub-item keys is not limited to such display. Thus, in the following explanation of a first modification of the first embodiment, item keys and sub-item keys are displayed in advance.

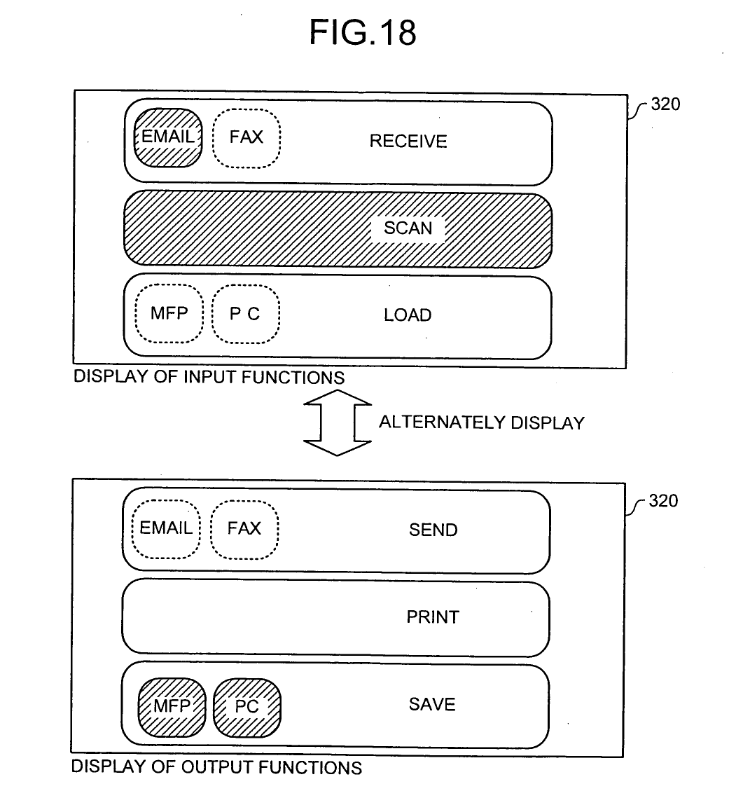

FIG. 18 is a diagram of an example of a screen displayed on the liquid crystal touch panel 320 by the display processing unit. As shown in the figure, the display processing unit according to this modification displays all item keys and sub-item keys in advance, or displays a plurality of functions and input processing sources and output processing destinations for the respective functions as a list.

In this modification, colors of an item key and a sub-item key, selection of which is accepted, are only changed and a preview is not displayed. The display processing unit may only display a function, selection of which is accepted, without displaying a preview.

Input processing sources and output processing destinations of a plurality of functions and each of the functions may be displayed as a list. When the selection accepting unit 403 accepts selection of an input processing source and an output processing destination, the display processing unit 401 may display previews corresponding to the input processing source and the output processing source, selection of which is accepted. As another example, it is also possible that display of sub-item keys is controlled in advance but, only when selection of a sub-item key is accepted after an item key is depressed, the item key, selection of which is accepted, is displayed in a different color. In this way, it is possible to display the item keys and the sub-item keys by combining the constitution described above with various constitutions.

The operation may be performed using a voice of a user. For example, a predetermined keyword corresponding to an input function or an output function switched and displayed is set in advance and, when the user says the keywords, the selection accepting unit 403 accepts selection of the input or output function or cancels the selection.

In the first embodiment, the display processing unit 401 two-dimensionally arranges and displays the item keys indicating the functions on the liquid crystal touch panel 320. However, the first embodiment does not limit display of the item keys to the two-dimensional arrangement and display. For example, when an area for each function is switched and displayed, it is also conceivable to show the area for each function on a virtual three-dimensional shape model and the virtual three-dimensional shape model is rotated to switch the area.

In a second embodiment of the present invention described below, a virtual cube is displayed on the liquid crystal touch panel 320.

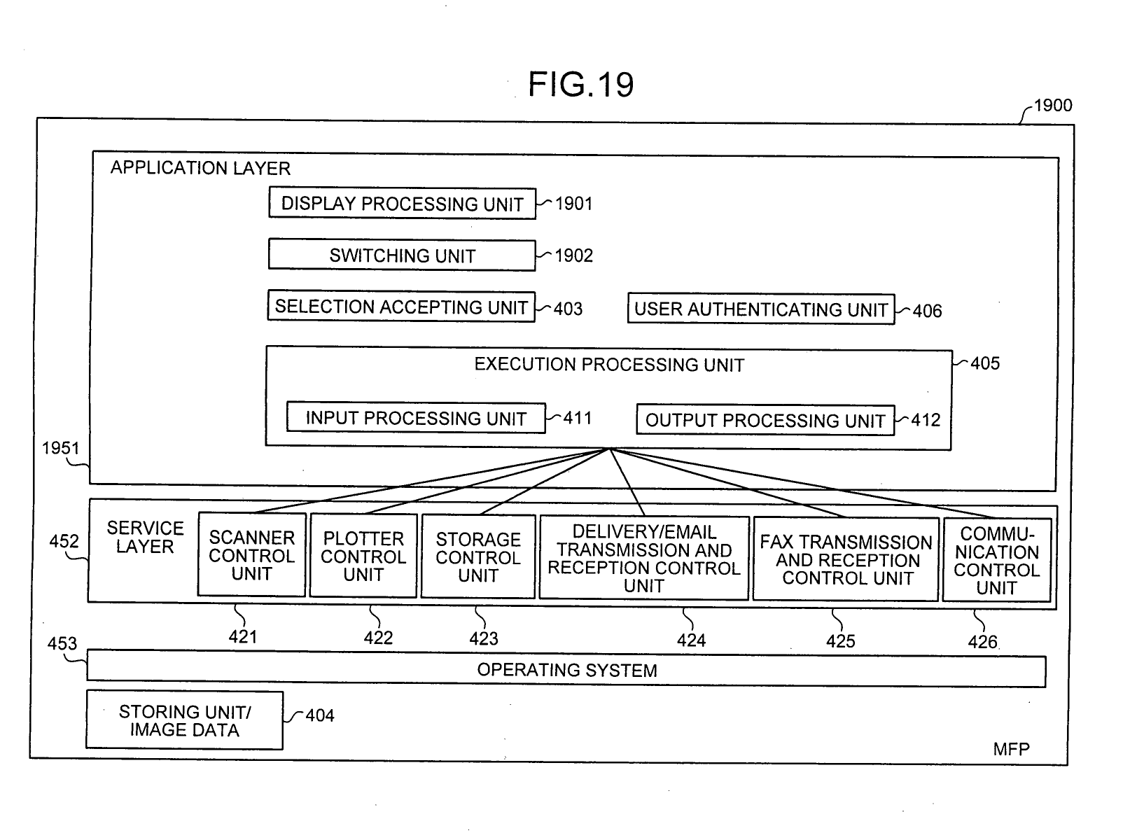

FIG. 19 is a functional block diagram of an MFP 1900 according to the second embodiment. As shown in the figure, the MFP 1900 is different from the MFP 1 according to the first embodiment in that the application layer 451 is changed to an application layer 1951 that performs different processing. In the following explanation, components identical with those in the first embodiment are denoted by the identical reference numerals and signs. Explanations of the components are omitted.

The MFP 1900 according to this embodiment includes the same network environment as the MFP 1 according to the first embodiment and includes the operation panel 300 shown in FIG. 3.

The application layer 1951 is different from the application layer 451 according to the first embodiment in that the display processing unit 401 is changed to a display processing unit 1901 that performs different processing and the switching unit 402 is changed to a switching unit 1902 that performs different processing.

The display processing unit 1901 displays a virtual cube held in advance on the liquid crystal touch panel 320. The display processing unit 1901 arranges an input function marking, which is a character string indicating an input function, and an output function marking, which is a character string indicating an output function, on each of predetermined areas of an outer surface of the virtual cube. In this embodiment, the predetermined areas are respective surfaces of the virtual cube. The input function marking or the output function marking is displayed on each of the surfaces.

The display processing unit 1901 arranges an input function marking and an output function marking, which are in a predetermined relation, on two opposed surfaces of the virtual cube, that is, surfaces in the front and the rear of the virtual cube. In other words, in this embodiment, the surface having the input function marking shown thereon is an input instruction area and the surface having the output function marking shown thereon is an output instruction area. Consequently, the input instruction area and the output instruction area, which are in the predetermined relation, are arranged to be opposed to each other.

In this embodiment, a virtual cube generated in advance is held in the display processing unit 1901 and displayed on the liquid crystal touch panel 320. However, a virtual cube to be displayed does not always have to be generated in advance and held. A virtual cube may be generated every time display of the virtual cube on the liquid crystal touch panel 320 is required. The virtual cube may be held in any form in the MFP 1900 as long as a user can recognize the virtual cube as a cube when the virtual cube is displayed on the liquid crystal touch panel 320. In other words, it does not matter whether the virtual cube is processed as a virtual cube in the MFP 1900.

FIG. 20 is a diagram of an example of a screen displayed on the liquid crystal touch panel 320 by the display processing unit 1901. As shown in the figure, a virtual cube is displayed on the liquid crystal touch panel 320 as a function selection screen. After rotation control of the virtual cube is performed by the switching unit 1902 described later, the display processing unit 1901 displays a plurality of surfaces having input function markings shown thereon or a plurality of surfaces having output function markings shown thereon. When the user depresses a surface having an input function marking shown thereon or a surface having an output function marking shown thereon, the selection accepting unit 403 accepts selection of the surface having the input function marking shown thereon or the surface having the output function marking shown thereon.

Since the acceptance of the selection of a function is the same as that in the first embodiment, the acceptance is not explained. In this embodiment, the input function markings and the output function markings are represented as character strings. However, the functions may be represented by figures such as marks, signs, and the like.

The switching unit 1902 performs control for switching display of a virtual cube subjected to display processing by the display processing unit 1901. In this embodiment, the switching unit 1902 controls switching of the display by instructing the display processing unit 1901 to rotate the virtual cube.

In this embodiment, the switching unit 1902 instructs the display processing unit 1901 to rotate the virtual cube at every time interval optimum for the user to set functions in the MFP 1. The switching unit 1902 instructs the display processing unit 1901 to rotate the virtual cube every three seconds as the optimum time interval. It goes without saying that this embodiment does not limit a predetermined time for rotating the virtual cube to three seconds.

This embodiment does not limit the instruction of the switching unit 1902 for rotating the virtual cube to be performed every predetermined time. The switching unit may instruct the display processing unit to rotate the virtual cube when a selection accepting unit accepts an input instructing to rotate the virtual cube from the user. The switching unit may instruct the display processing unit to rotate the virtual cube based on any conditions.

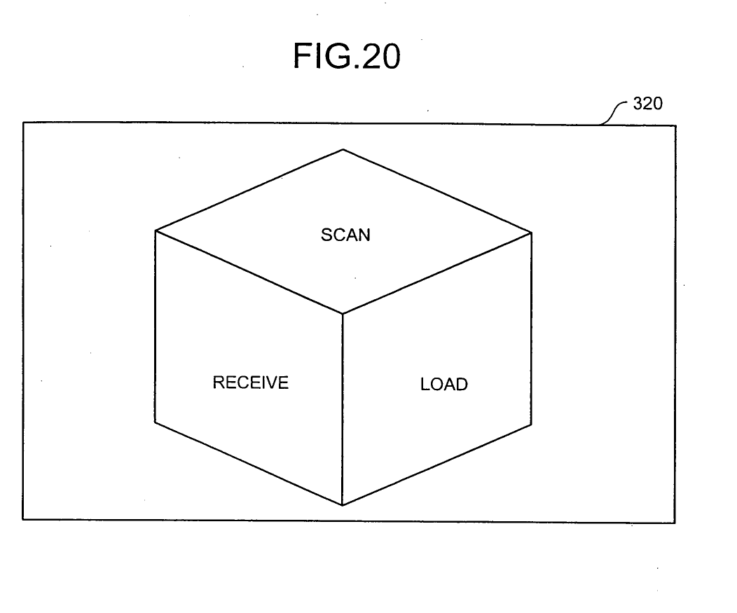

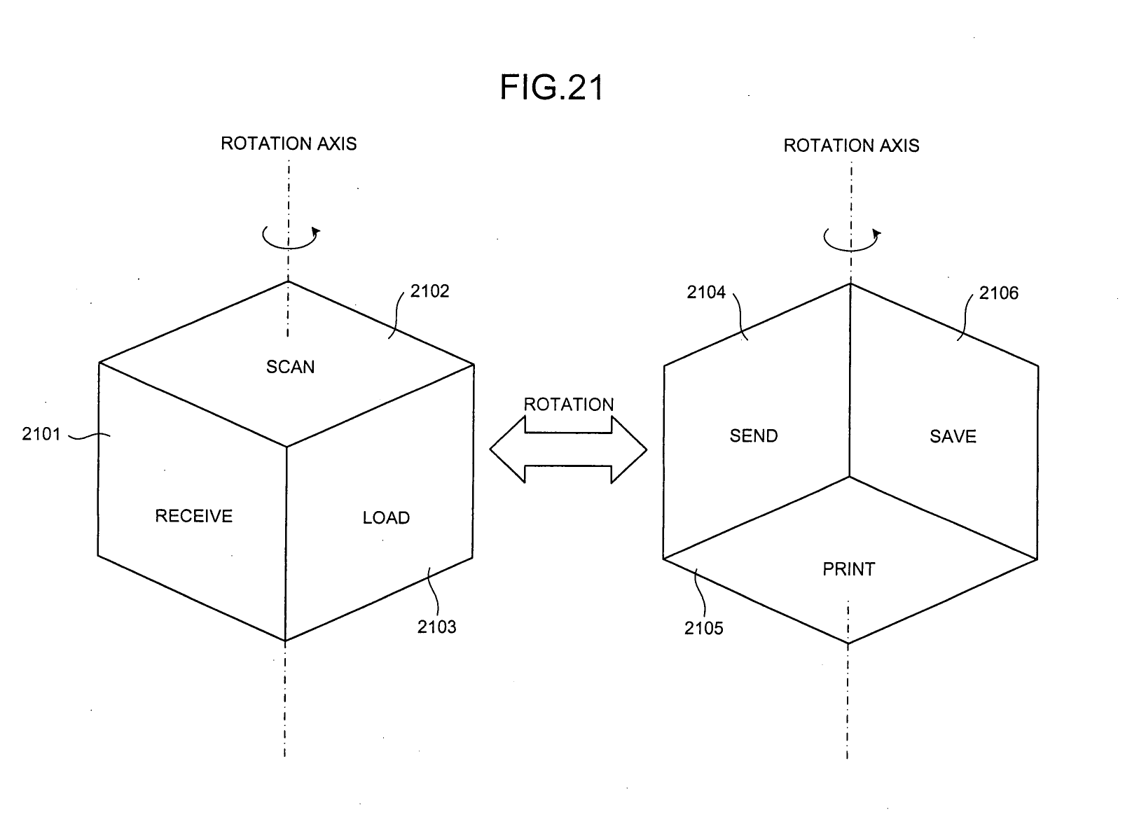

FIG. 21 is a diagram for explaining an example at the time when the display processing unit 1901 rotates the virtual cube according to the control by the switching unit 1902. As shown in the figure, the switching unit 1902 controls the rotation of the virtual cube and switches the surfaces having the input function markings shown thereon and the surfaces having the output function markings shown thereon. Specifically, the display processing unit 1901 and the switching unit 1902 rest the virtual cube in a state in which the surfaces having the input function markings shown thereon or the surfaces having the output function markings shown thereon are displayed on the liquid crystal touch panel 320. When three seconds pass after the virtual cube rests, the display processing unit 1901 and the switching unit 1902 rotate the virtual cube by half. After the half rotation of the virtual cube, the display processing unit 1901 and the switching unit 1902 rest the virtual cube in a state in which the surfaces having the input function markings shown thereon or the surfaces having the output function markings shown thereon, which are not displayed earlier, are shown on the liquid crystal touch panel 320. The display processing unit 1901 and the switching unit 1902 repeat this processing.

When the surfaces having the input function markings shown thereon are displayed on the liquid crystal touch panel 320, the display processing unit 1901 displays a surface 2101 having RECEIVE shown thereon, a surface 2102 having SCAN shown thereon, and a surface 2103 having LOAD shown thereon. When the surfaces having the output function markings shown thereon are displayed on the liquid crystal touch panel 320, the display processing unit 1901 displays SEND 2104, PRINT 2105, and SAVE 2106. Since these functions are the same as those in the first embodiment, explanations of the functions are omitted.

The display processing unit 1901 rotates the virtual cube on the liquid crystal touch panel 320 around a rotation axis shown in FIG. 21. The virtual cube is repeatedly rotated and rested on the liquid crystal touch panel 320. In a stationary state, the display processing unit 1901 displays the virtual cube, using the rotation axis, such that an area of the surfaces having the input function markings shown thereon and an area of the surfaces having the output function markings shown thereon are substantially equal. This rotation axis does not pierce through vertexes of corners of the virtual cube but pierces through surfaces of the virtual cube. When the display processing unit 1901 displays the virtual cube in this way, areas of the respective surfaces, selection of which is accepted, are equal. Thus, it is easy for the user to depress the respective surfaces.

This embodiment does not limit an arrangement of the rotation axis to the arrangement described above. For the rotation axis, any arrangement may be adopted as a reference for rotating the virtual cube.

As shown in FIG. 21, the display processing unit 1901 displays a surface having an input function marking shown thereon and a surface having an output function marking shown thereon, which are in a predetermined relation, on opposed surfaces of the virtual cube, respectively. The predetermined relation is the same as that explained in the first embodiment. For example, the display processing unit 1901 arranges the surface 2102 having shown thereon the input function marking SCAN for subjecting a paper original to reading processing and the surface having shown thereon the output function marking PRINT for subjecting the paper original to print processing in opposed positions of the virtual cube. Since the input and output functions in the predetermined relation are shown on opposed surfaces, it is possible to urge the user to intuitively understand the functions. As a specific example, by referring to the virtual cube shown in FIG. 21, the user can understand that a combination of the input function indicated by the input function marking SCAN and the output function indicated by the output function marking PRINT for a paper original realizes a copy function that is a combination of the input and output functions for a paper medium. By arranging the surfaces in this way, it is easy for the user to understand a relation among the respective functions. Thus, visibility and predictability of the user concerning functions are improved.

The same holds true for other input functions and output functions having the predetermined relation. The display processing unit 1901 arranges the surface 2101 having shown thereon the input function marking RECEIVE for reception from the network and the surface 2104 having shown thereon the output function marking SEND for transmission to the network in opposed positions of the virtual cube. The display processing unit 1901 arranges the surface 2103 having shown thereon the input function marking LOAD for reading out image data from the storing unit 404 and the surface 2106 having shown thereon the output function marking SAVE for writing image data in the storing unit 404 in opposed positions of the virtual cube.

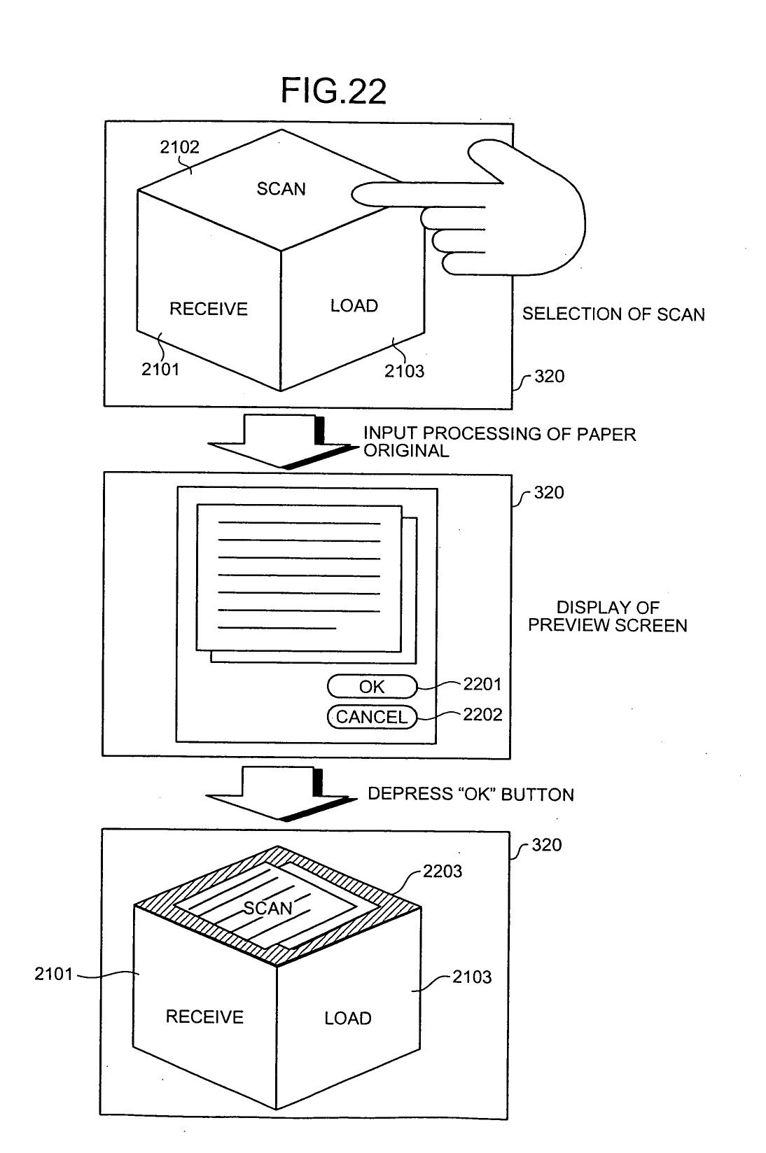

FIG. 22 is a diagram for explaining a procedure from display of a virtual cube, in which selection of a surface having an input function marking shown thereon is not accepted, to display of a virtual cube, in which selection of a surface having an input function marking shown thereon is accepted, on the liquid crystal touch panel 320 according to this embodiment. As shown in the figure, when the liquid crystal touch panel 320 displays input functions, the surface 2102 having the input function marking RECEIVE shown thereon, the surface having SCAN shown thereon, and the surface 2103 having LOAD shown thereon are displayed on the virtual cube.

When the user depresses the surface 2102 having SCAN shown thereon, the display processing unit 1901 enlarges the surface depressed and displays a screen for selecting an input object on the surface enlarged. The screen for selecting an input object is described later. When the user selects paper as an input object from the screen for selecting an input object, the selection accepting unit 403 accepts the selection of the surface 2102 having SCAN shown thereon and accepts the selection of paper as the input object.

When the selection accepting unit 403 accepts the selection of the surface 2102 having SCAN shown thereon and accepts the selection of paper as the input object, the input processing unit 411 reads the selection as an input function, judges that a paper original is accepted as a reading object, reads the paper original, and subjects the paper original to input processing as image data. The display processing unit 1901 displays a summary of a result of subjecting the selected input object to the input processing as a preview on the enlarged screen. This screen is a screen shown in the middle section of FIG. 22. Consequently, the user can easily recognize the result of the input processing.

When the user judges, with reference to the preview screen, that there is no problem in the input processing, the user depresses an OK button 2201. When image data different from what the user has assumed is displayed, the user depresses a CANCEL button 2202. When the CANCEL button 2202 is depressed, the display processing unit 1901 displays the screen shown at the top of FIG. 22 again from the preview screen.

When the OK button 2201 is depressed, assuming that the selection of the surface 2102 having the input function marking SCAN shown thereon is accepted, the display processing unit 1901 displays a screen shown at the lower section of FIG. 22. The display processing unit 1901 displays a surface 2203 having SCAN shown thereon, a color of which is changed and in which a summary of image data of a result of the input processing is shown. The summary is an image changed to be displayable on the liquid crystal touch panel 320. In this embodiment, specifically, the image is reduced to a displayable size and simplified. This makes it easy to urge the user to understand input processing performed by a function, selection of which is accepted, and makes it easy to understand image data to be outputted after the input processing is performed. When selection of the surface 2101 having RECEIVE shown thereon or the surface 2103 having LOAD shown thereon is accepted, input processing is performed according to the same processing procedure.

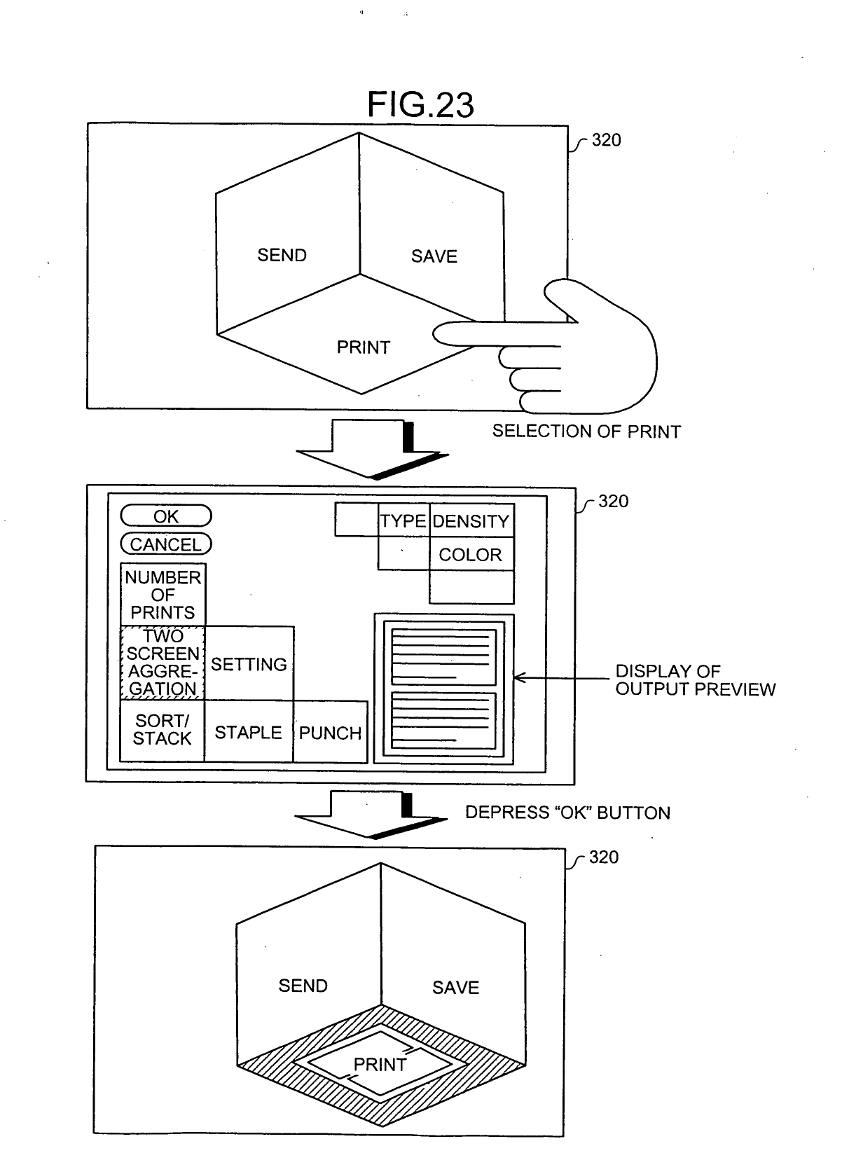

FIG. 23 is a diagram for explaining a procedure from display of a virtual cube, in which selection of a surfaced having an output function marking shown thereon is not accepted, to display of a virtual cube, in which selection of a surface having an output function marking shown thereon is accepted, on the liquid crystal touch panel 320 according to this embodiment. As shown in the figure, when the liquid crystal touch panel 320 displays output functions, the surface 2104 having the output function marking SEND shown thereon, the surface 2105 having the PRINT shown thereon, and the surface 2106 having SAVE shown thereon are displayed on the virtual cube.

When the user depresses the surface 2105 having PRINT shown thereon, the selection accepting unit 403 accepts selection of the surface 2105 having PRINT shown thereon. The display processing unit 1901 enlarges the surface depressed and performs display for accepting selection of an output destination on the enlarged surface. The display for accepting selection of an output destination is described later and is not shown in the figure. When the user accepts selection of paper as an output destination from the screen for selecting an output destination, the selection accepting unit 403 accepts the selection of the surface 2105 having PRINT shown thereon and accepts the selection of paper as an output destination.

When the selection accepting unit 403 accepts selection of the surface 2102 having SCAN shown thereon and accepts selection of paper as an input object, the input processing unit 411 reads the selection as an input function, judges that a paper original is accepted as a reading object, reads the paper original, and subjects the paper original to input processing as image data. The display processing unit 1901 displays a summary of a result of subjecting the selected input object to the input processing on the enlarged screen as a preview. This screen is a screen shown in the middle section of FIG. 22. Consequently, the user can easily recognize the result of the input processing.

When the user accepts selection of an output destination from this enlarged screen, the display processing unit 1901 displays a preview showing a summary of a result of output processing for output to the output destination, selection of which is accepted, on the enlarged screen. This screen is a screen shown in the middle section of FIG. 23. In this screen, blocks are shown for respective items that can be set in performing output processing. Detailed setting is possible for the respective blocks. Details of a setting procedure are described later.

The user checks the preview screen and, when it is judged that there is no problem, depresses an OK button 2301. When image data different from what the user has assumed is displayed, the user depresses a CANCEL button 2302. When the CANCEL button 2302 is depressed, the display processing unit 1901 displays the screen shown at the top of FIG. 23 again from the preview screen.

When the OK button 2301 is depressed, assuming that the surface 2105 having the output function marking PRINT shown thereon is selected and setting for printing ends, the display processing unit 1901 displays a screen shown at the lower section of FIG. 23. The display processing unit 1901 changes a color of a screen 2303 having PRINT shown thereon, selection of which is accepted, and displays a preview showing a summary of a result of the output processing in the surface. By performing such display, it is possible to clearly show processing performed using a function corresponding to a surface, selection of which is accepted, and the user can intuitively understand an output result. In other words, the user can intuitively understand functions compared with the color conversion or the like of item keys, which has been often used conventionally or the explanation of functions by text explanation. When the selection accepting unit 403 accepts selection of a surface having another output function shown thereon, that is, the surface 2104 having SEND shown thereon or the surface 2106 having SAVE shown thereon, the output processing is performed according to the same processing procedure.

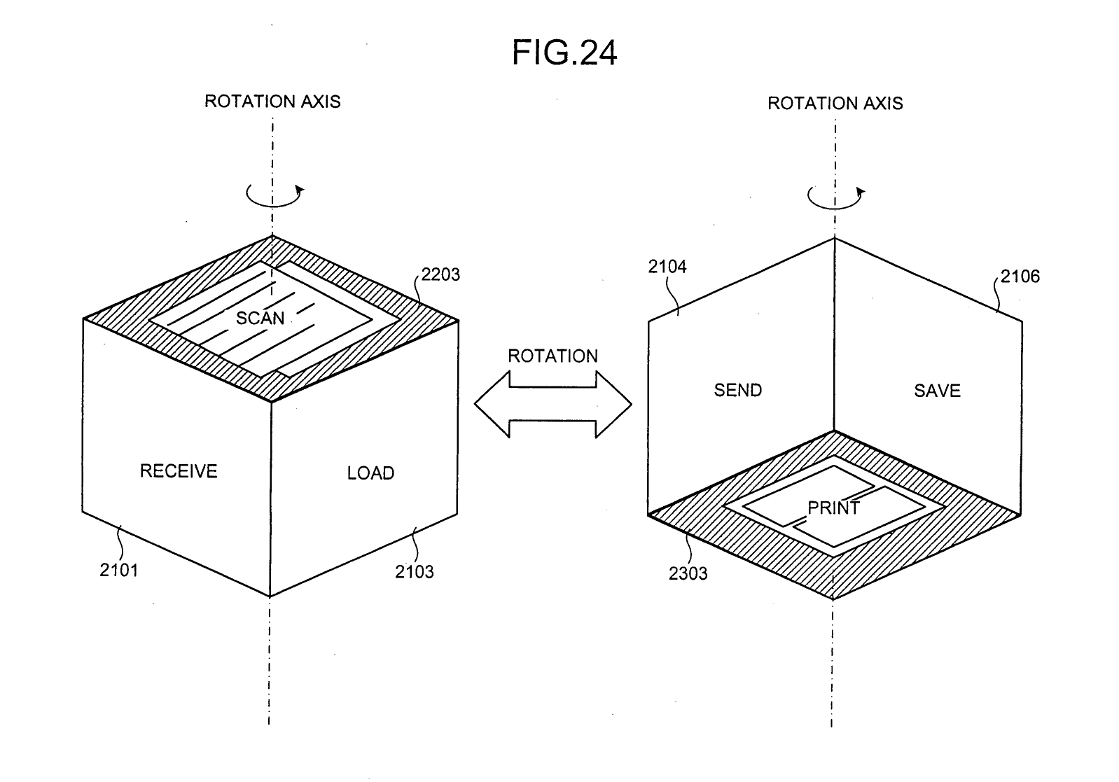

FIG. 24 is a diagram for explaining an example of a virtual cube displayed by the display processing unit 1901 after the selection accepting unit 403 accepts selection of the surface 2303 having SCAN shown thereon and the surface 2105 having PRINT shown thereon from the virtual cube displayed on the liquid crystal touch panel 320. As shown in the figure, the display processing unit 1901 changes colors of the surface 2203 having SCAN shown thereon and the surface 2303 having PRINT shown thereon, selection of which is received, in the rotating virtual cube and displays a preview showing a summary of a result of the processing. Consequently, the user can recognize functions, selection of which is accepted, and intuitively understand result of input processing and output processing.

Even when the selection accepting unit 403 has already accepted selection of a surface having an input function marking shown thereon, the selection accepting unit 403 can accept selection of a surface having another input function marking shown thereon. Similarly, even when the selection accepting unit 403 has already accepted selection of a surface having an output function marking shown thereon, the selection accepting unit 403 can accept selection of a surface having another output function marking shown thereon. In other words, the MFP 1900 can accept selection of a plurality of surfaces for one or more of a surface having an input function marking shown thereon and a surface having an output function marking shown thereon every time processing is performed. Since a plurality of surfaces are accepted as one or more of a surface having an input function marking shown thereon and a surface having an output function marking shown thereon, processing is executed using a plurality of input functions and output functions corresponding to the surfaces. This makes it possible to perform processing with functions set in detail according to a request of the user. As a result, convenience and operability are improved.

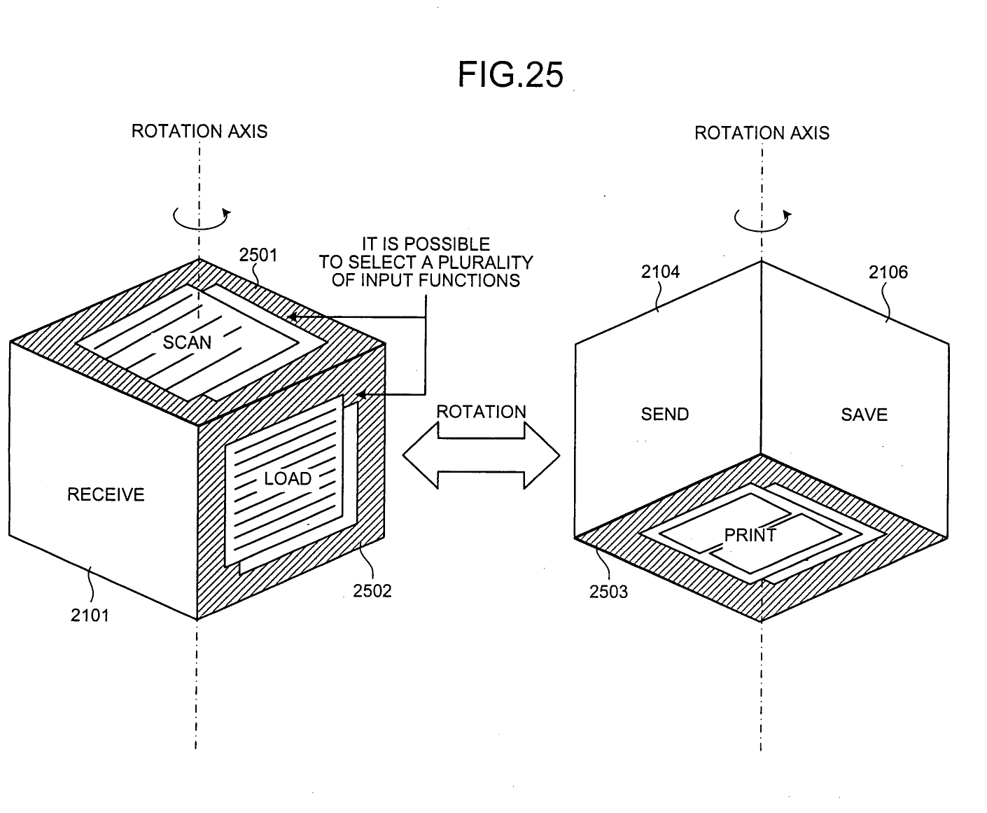

FIG. 25 is a diagram of an example of a virtual cube subjected to display processing by the display processing unit 1901 after the selection accepting unit 403 accepts selection of the surface 2501 having the input function marking SCAN shown thereon and the surface 2502 having LOAD shown thereon and accepts selection of the surface 2503 having the output function marking PRINT shown thereon from the virtual cube displayed on the liquid crystal touch panel 320. As shown in the figure, when the selection accepting unit 403 accepts selection of a plurality of surfaces having function markings thereon, the display processing unit 1901 displays a preview on each of the surfaces, selection of which is accepted.

When the selection accepting unit 403 accepts selection of a plurality of surfaces having input function markings shown thereon, the output processing unit 412 performs output processing using a plurality of image data generated by input processing of respective input functions corresponding to the surfaces, selection of which is accepted, and using output functions corresponding to the surfaces, selection of which is accepted. The display processing unit 1901 displays a preview showing a summary of a result obtained by performing output processing with output functions corresponding to the surfaces, selection of which is accepted, in the surfaces having the output function markings shown, selection of which is accepted, using the image data generated by the input processing. Consequently, the user can intuitively understand a result obtained by performing output processing when a plurality of input function markings are selected.

When the selection accepting unit 403 accepts selection of a plurality of surfaces having output function markings shown thereon, as in the case of the selection of a plurality of input function markings, the display processing unit 1901 changes colors of the surfaces having the function markings shown thereon, selection of which is accepted. The display processing unit 1901 displays a preview showing a result of output processing on each of the surfaces.

In the MFP 1900 according to this embodiment, the user can select a plurality of input objects from one input function or select a plurality of output destinations from one output function.

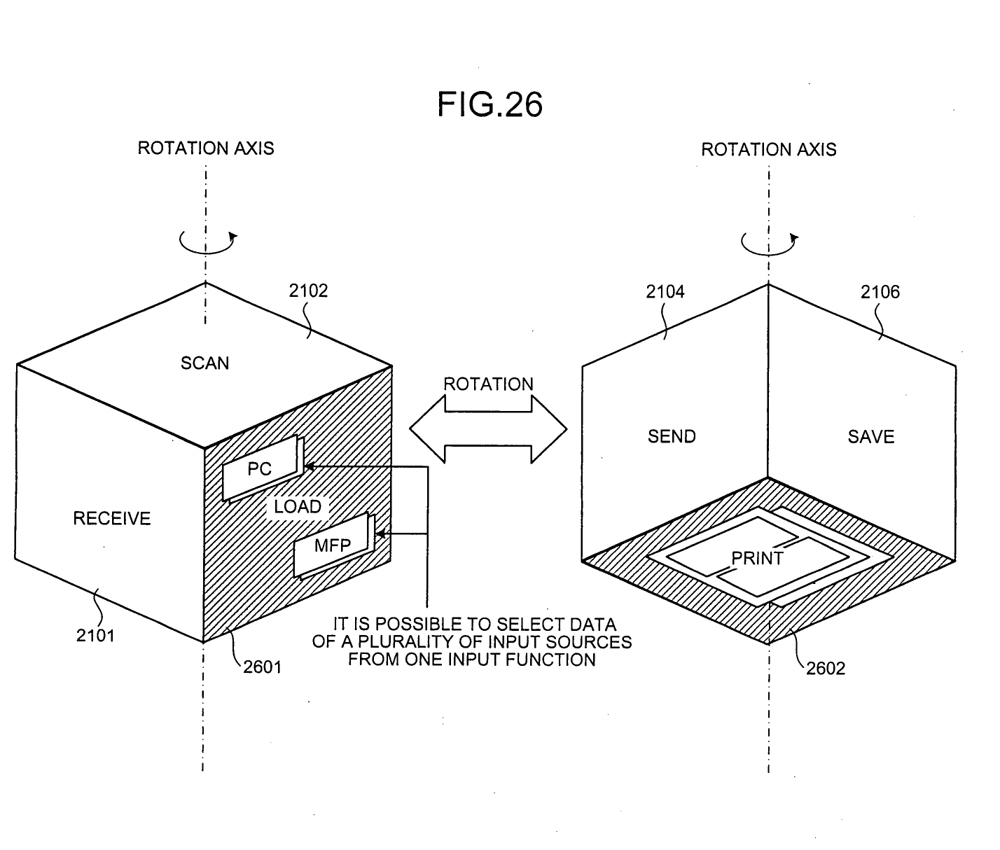

FIG. 26 is a diagram of an example of a virtual cube displayed by the display processing unit 1901 after the selection accepting unit 403 accepts selection of a surface having an input function marking LOAD shown thereon, accepts selection of PC and MFP as input objects, that is, reception sources, and accepts selection of a surface 2602 having an output function marking PRINT shown thereon. A procedure for displaying a screen shown in the figure is explained. First, when the user depresses PC as an input object after depressing the surface 2601 having LOAD shown thereon, the input processing unit 411 performs input processing of image data stored in the PC. When the user depresses MFP as an input object after depressing the surface 2601 having LOAD shown thereon again, the input processing unit 411 performs input processing for image data stored in the MFP 1900. Consequently, the display processing unit 1901 displays a preview of a summary of a result obtained by performing the input processing for each of the PC and the MFP 1900, which are input objects, selection of which is accepted.

Thereafter, when selection of a surface 2603 having an output function marking PRINT shown thereon is accepted, detailed setting and the like are performed. The display processing unit 1901 displays a preview showing a summary of a result obtained by performing output processing using the image data acquired by the input processing in the surface 2603 having PRINT shown thereon. Thereafter, when the user depresses the start key 308, output processing by the output processing unit 412 is performed. In this way, when the selection accepting unit 403 accepts selection of a plurality of input objects from one input function, the input processing unit 411 can perform input processing of the image data using the identical input function. Moreover, the output processing unit 412 can subject one or more image data generated from the image data subjected to the input processing to output processing.

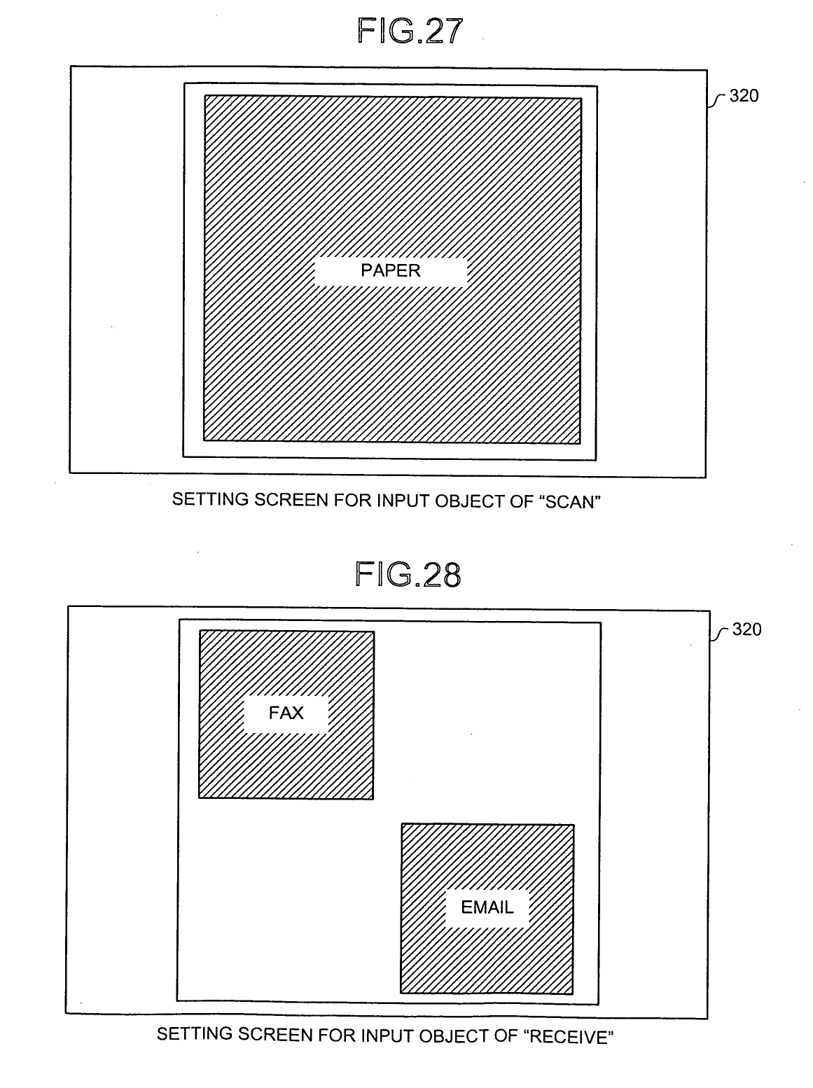

FIG. 27 is a diagram of an example of a screen for accepting selection of an input object displayed by the display processing unit 1901 when selection of a surface having SCAN shown thereon of the virtual cube is accepted. The display processing unit 1901 performs enlarged display processing for one surface of the virtual cube. As shown in the figure, an item key indicated as PAPER is displayed on the surface enlarged. When the user depresses the item key PAPER, the selection accepting unit 403 accepts selection of the item key PAPER and considers that paper is accepted as an input object. Consequently, the input processing unit 411 judges that selection of paper as an input object is accepted and starts input processing of a paper original. When there is only one item key as shown in the figure, this processing may be omitted. Thereafter, the display processing unit 1901 displays a preview showing a summary of a result obtained by performing the input processing. When surfaces having other input functions shown thereon are depressed, processing up to display of a preview showing a summary of a result obtained by performing input processing is performed according to the same processing procedure.

FIG. 28 is a diagram of an example of a screen for accepting selection of input objects displayed by the display processing unit 1901 when selection of a surface having RECEIVE shown thereof of the virtual cube is accepted. As in the processing procedure described above, item keys indicated as FAX and EMAIL are displayed on an enlarged surface. When the user depresses the item key FAX, the selection accepting unit 403 accepts selection of the item key FAX and considers that a Fax original is accepted as an input object. When the user depresses the item key EMAIL, the selection accepting unit 403 accepts selection of the item key EMAIL and considers that an e-mail received in the name of the user authenticated by the user authenticating unit 406 is accepted as an input object. The input processing unit 411 applies input processing to the input objects for which these selections are accepted.

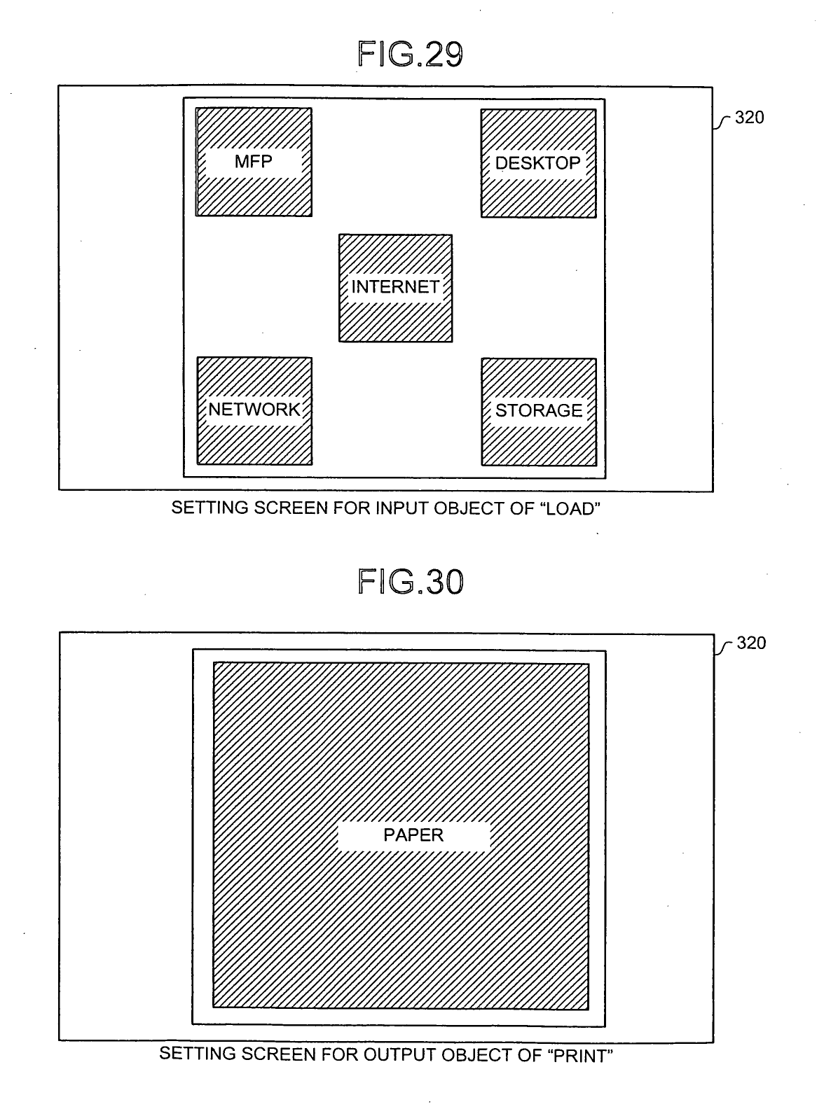

FIG. 29 is a diagram of an example of a screen for accepting selection of input objects displayed by the display processing unit 1901 when selection of a surface having LOAD shown thereon of the virtual cube is accepted. As shown in the figure, the display processing unit 1901 displays items keys MFP, DESKTOP, INTERNET, NETWORK, and STORAGE on an enlarge surface. When the user depresses any one of these item keys, the selection accepting unit 403 accepts selection of the item key depressed and considers that selection of a corresponding medium as an input object.

FIG. 30 is a diagram of a screen for accepting selection of an output destination displayed by the display processing unit 1901 when selection of a surface having PRINT shown thereon of the virtual cube is accepted. The display processing unit 1901 performs enlarged display processing for a surface of the virtual cube. As shown in the figure, the display processing unit 1901 displays an item key PAPER on this enlarged surface. When the user depresses the item key PAPER, the selection accepting unit 403 accepts selection of the item key depressed and considers that a paper medium is accepted as an output destination. When there is only one item key as shown in the figure, this processing may be omitted. After that, the display processing unit 1901 displays a preview at the time when output processing is performed by this function and a detailed setting screen. When surfaces having other output function markings shown thereon are depressed, in the same processing, the display processing unit 1901 performs processing up to display of a preview showing a summary of a result obtained by performing output processing.

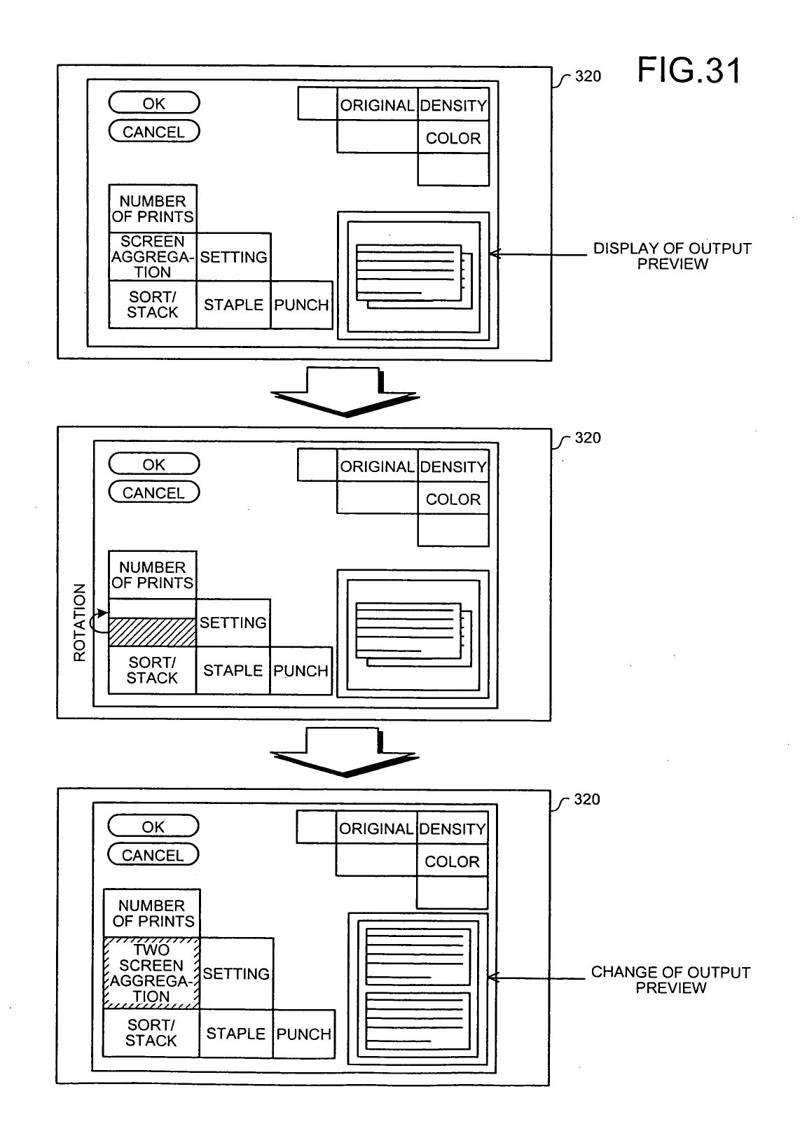

FIG. 31 is a diagram for explaining the preview and the detailed setting screen displayed by the display processing unit 1901 when the selection accepting unit 403 accepts the selection of the item key PAPER. As shown in the figure, the display processing unit 1901 displays a preview showing a summary of a result of output processing and a detailed setting screen based on image data subjected to input processing. In this screen, respective setting items for performing detailed setting are displayed in block units around the preview screen. Conditions presently set in the respective items are displayed in these blocks. When the user depresses any one of the blocks, the selection accepting unit 403 is informed that the block is depressed. The display processing unit 1901 rotates a virtual polyhedron arranged in the block depressed and displays a surface having a different condition shown thereon. The selection accepting unit 403 accepts the new condition displayed in the block as being set.

Specifically, as shown in the figure, when a block indicated as SCREEN AGGREGATION is depressed, the selection accepting unit 403 accepts the block as being selected. The display processing unit 1901 performs display in which a virtual polyhedron arranged in the block and performs display for resting the virtual polyhedron at a point when a surface having TWO SCREEN AGGREGATION of the virtual polyhedron rotated comes to a position of the block. The selection accepting unit 403 accepts TWO SCREEN AGGREGATION as being selected. The display processing unit 1901 changes the result on the preview in the screen to a result obtained by performing output processing in TWO SCREEN AGGREGATION, selection of which is accepted, and displays the preview. Consequently, when the user depresses various setting items displayed in block units, the display processing unit 1901 displays a preview corresponding to a condition set anew in each of the items. Consequently, the user can easily understand an output processing result. Even when the user does not know a function of each of the blocks, when the user depresses the block, a preview showing a summary of a result obtained by performing output processing is changed. Thus, the user can intuitively understand content of the item of each of the blocks. Since the various setting items are shown in block units, it is possible to easily perform customization, for example, addition, change, or deletion of an arrangement of setting items available for each MFP 1900.

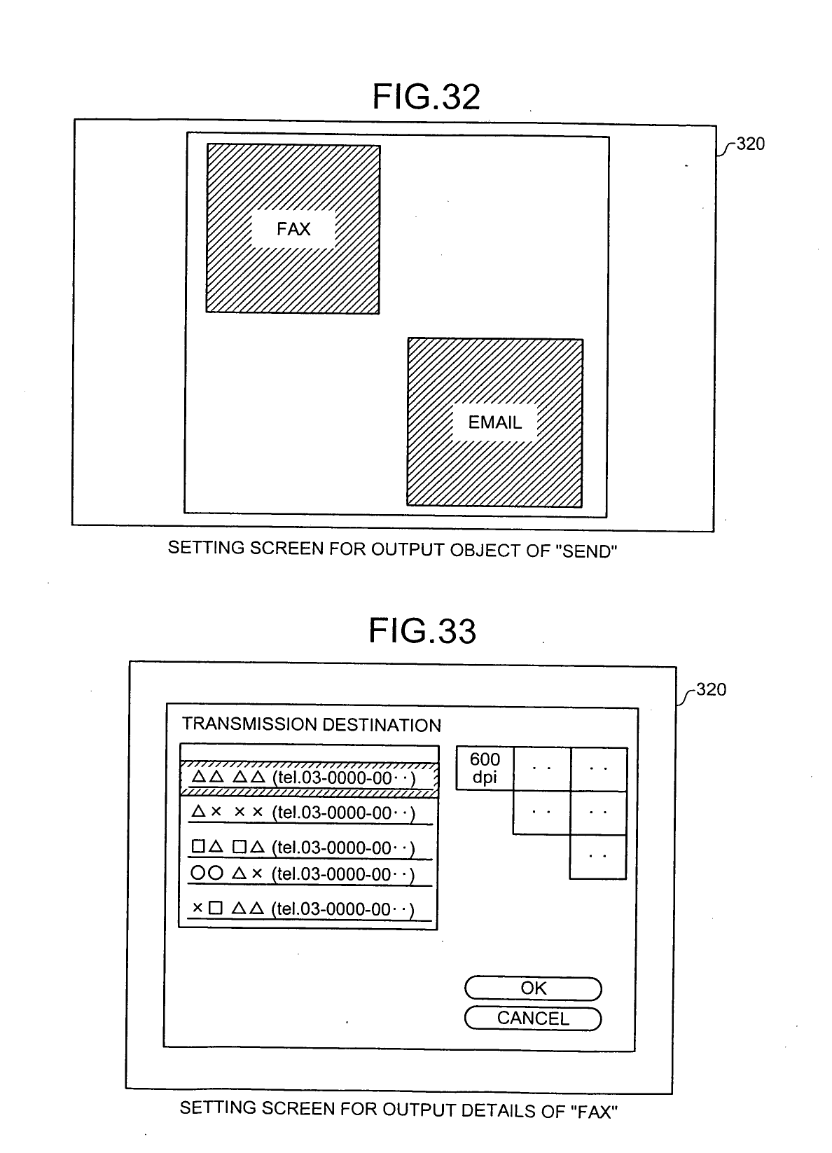

FIG. 32 is a diagram of an example of a screen for accepting selection of an output destination displayed by the display processing unit 1901 when the selection accepting unit 403 accepts selection of a surface having SEND shown thereon. As in the processing procedure described above, the display processing unit 1901 displays the items keys FAX and EMAIL on an enlarged surface. When the user depresses the item key FAX, the selection accepting unit 403 accepts selection of the item key FAX and considers that a Fax original is selected as an output destination. When the user depresses the item key EMAIL, the selection accepting unit 403 accepts selection of the item key EMAIL and considers that selection of transmission of an e-mail in the name of the user authenticated by the user authenticating unit 406 is accepted.

When an item key accepts selection, the screen may be switched to a screen for setting an input object or an output destination in detail. FIG. 33 is a diagram of an example of a screen displayed by the display processing unit 1901 after the selection accepting unit 403 accepts selection of the item key FAX. As shown in the figure, after the selection of the item key FAX is accepted, the display processing unit 1901 displays a screen for performing detailed setting for output. When the user selects a transmission destination of a facsimile, resolution in transmission, and the like in detail, the selection accepting unit 403 accepts the selections. The display processing unit 1901 displays a preview reflecting the selections accepted.

Although different from this embodiment, a preview may be simultaneously displayed in the screen for setting the transmission destination and the like in detail shown in the figure. In the above explanation, the selection of the item key FAX is accepted. However, when selection of other item keys is accepted, the display processing unit 1901 may display a screen for setting details in the same manner.

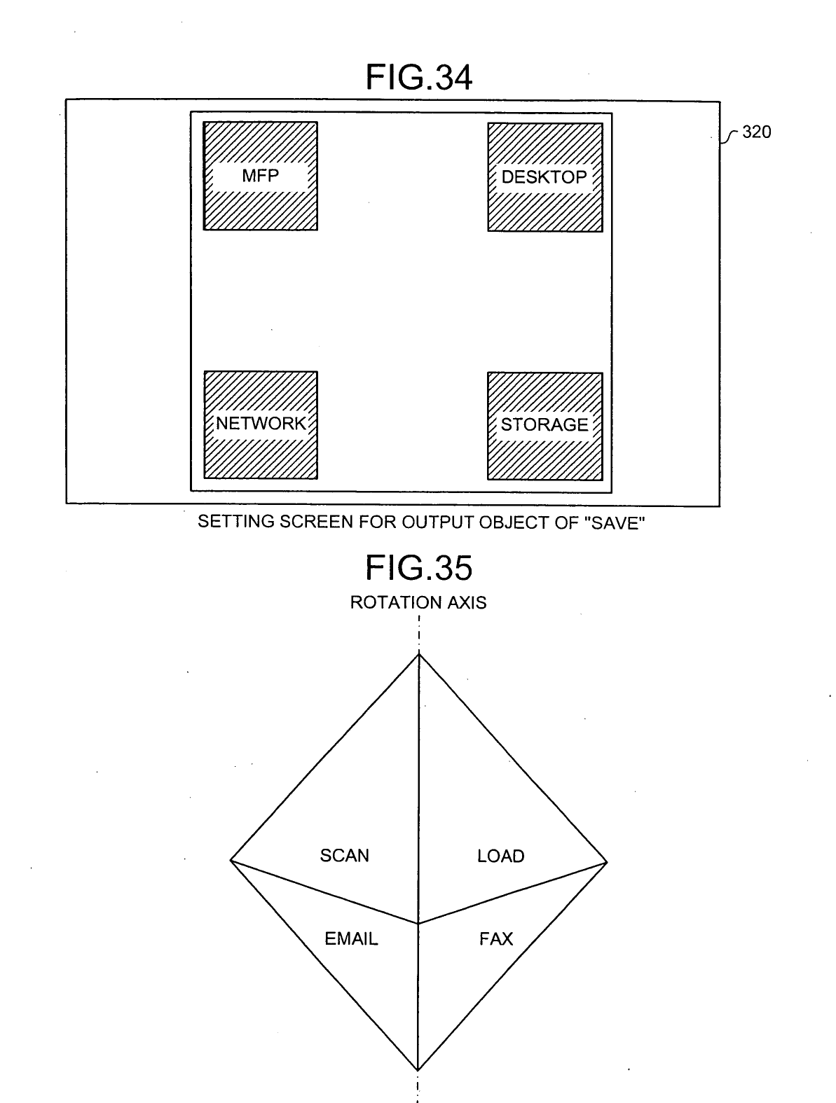

FIG. 34 is a diagram of an example of a screen for accepting selection of an output destination displayed by the display processing unit 1901 when the selection accepting unit 403 accepts selection of a surface having SAVE shown thereon of the virtual cub. As shown in the figure, the display processing unit 1901 displays the item keys MFP, DESKTOP, NETWORK, and STORAGE on an enlarged surface. When the user depresses any one of these item keys, the selection accepting unit 403 accepts selection of the item key depressed and considers that a medium corresponding to the item key is accepted as an output destination.

In this way, an item key indicating an input object or an output destination is displayed after a surface having a function shown thereon is depressed. Consequently, the user can set input processing and output processing easily and in detail.

A processing procedure from the display processing for the input function screen to the output processing performed by accepting selection by the user in the MFP 1900 according to this embodiment is the same as the processing procedure shown in FIG. 13 of the first embodiment except only the following point. The input function screen consists of a plurality of surfaces having input function markings shown thereon of the virtual cube and the output function screen consists of a plurality of surfaces having output function markings shown thereon of the virtual cube. Thus, explanations of the processing procedure are omitted.

In this embodiment, the display processing unit 1901 uses a cube as a three-dimensional shape model for displaying functions on the liquid crystal touch panel 320. However, the three-dimensional shape model displayed is not limited to the cube. Various three-dimensional shape models are conceivable as described below. Besides the three-dimensional shape models described below, any three-dimensional shape model may be used as long as input function markings and output function markings are shown on an external surface thereof.

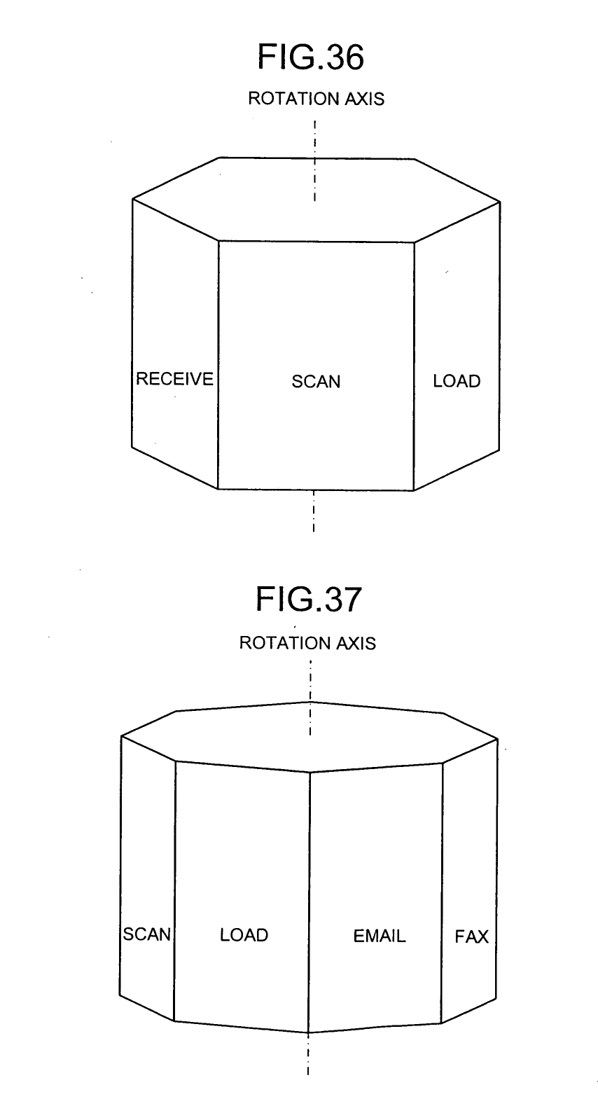

FIG. 35 is a diagram for explaining an example in which a regular octahedron having functions indicated on respective surfaces thereof is used. In the case of a three-dimensional shape model shown in the figure, since surfaces having functions in a predetermined relation shown thereon are arranged on opposed surfaces, the user can intuitively understand the functions. Even when the three-dimensional shape model shown in the figure is displayed on the liquid crystal touch panel 320, an MFP can accept selection of a surface having a function shown thereon as in the embodiment described above and execute processing according to the function corresponding to the surface, selection of which is accepted. The same holds true for FIGS. 36, 37, 38, and 39 described later. The embodiment described above does not limit the three-dimensional shape model to a regular polyhedron. Thus, in the following explanation, a prism is used.

FIG. 36 is a diagram for explaining an example in which a hexagonal prism having functions shown on respective sides thereof is used. FIG. 37 is a diagram for explaining an example in which an octagonal prism having functions shown on respective sides thereof is used. As shown in FIGS. 36 and 37, functions may be shown on respective surfaces of the prism. Further, a plurality of predetermined areas may be provided on a side of a cylinder, which can be derived when the number of surfaces of the prism is increased, to show functions in the respective areas.

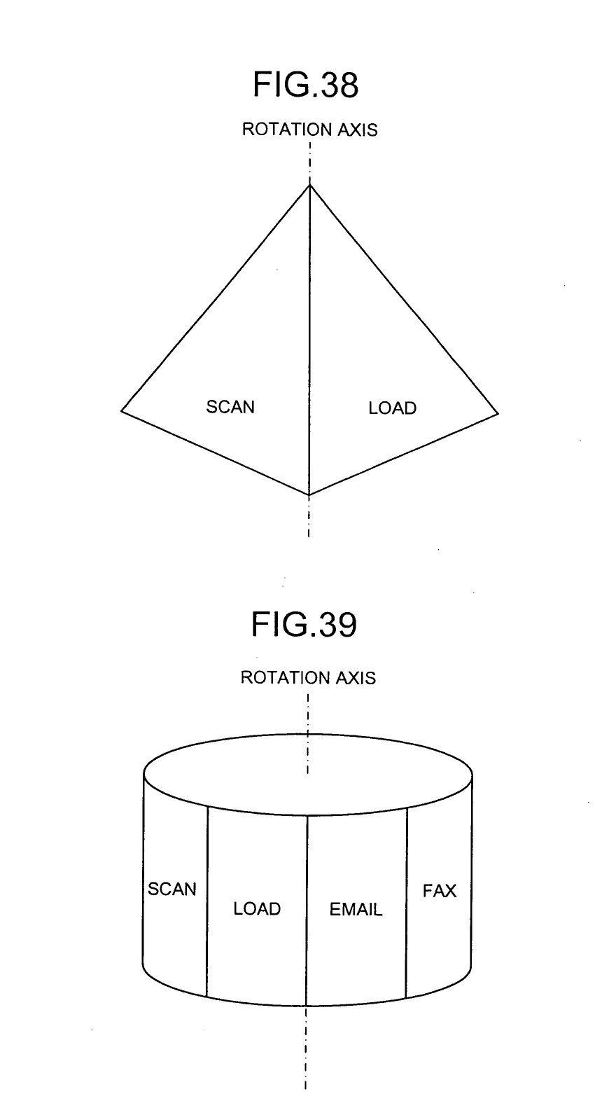

In the embodiment described above, the surface having an input function shown thereon and the surface having an output function shown thereon, which have a predetermined relation, are arranged on opposed surfaces of the virtual polyhedron. However, the embodiment is not limited to such display. FIG. 38 is a diagram for explaining an example in which a regular tetrahedron having functions shown on respective surfaces thereof is used. Since the regular tetrahedron does not have opposed surfaces, it is impossible to arrange a surface having an input function shown thereon and a surface having an output function shown thereon, which have a predetermined relation, in positions opposed to each other. However, by rotating the regular tetrahedron to switch a surface displayed on a liquid crystal touch panel, it is possible to urge the user to recognize functions that can be provided.

Alternatively, a plurality of functions may be shown on a side or the like of a cylinder. FIG. 39 is a diagram for explaining an example in which a cylinder having input functions and output functions shown on respective predetermined areas on a side thereof is used. As shown in the figure, in display of a cylinder on a liquid crystal touch panel, a state in which the input functions are shown in the respective predetermined areas is changed to a state in which the output functions are shown in the respective predetermined areas by rotating the cylinder in the same manner as the embodiment described above and switching areas displayed of the cylinder. A display processing unit that displays such a cylinder on the liquid crystal touch panel may arrange an area having an input function shown therein and an area having an output function shown therein, which have a predetermined relation, in opposed positions of the cylinder as in the embodiment described above.

In the embodiment described above, in a stationary state, the display processing unit displays only a plurality of surfaces having input functions shown thereon or a plurality of surfaces having output functions shown thereon on the virtual cube. However, the embodiment does not limit display of a three-dimensional shape model to such display. For example, the display processing unit may simultaneously display a surface having an input function shown thereon and a surface having an output function shown thereon in the stationary state. Further, the display processing unit arranges input function markings and output function markings on the respective surfaces such that a surface having the input function SCAN shown thereon and a surface having the output function PRINT shown thereon, which have a predetermined relation, are simultaneously displayed in the stationary state.

In this embodiment, an order of accepting selection of a surface having an input function marking shown thereon and a surface having an output function marking shown thereon is not limited as in the first embodiment.

The display processing unit 1901 of the MFP 1900 described in this embodiment performs display for rotating the virtual cube having function markings shown on the respective surfaces thereof to switch display of a surface having an input function marking shown thereon and a surface having an output function marking shown thereon. Consequently, the same effects as those described in the first embodiment are obtained. Moreover, it is possible to stereoscopically grasp a positional relation of the surface having the input function marking shown thereon and the surface having the output function marking shown thereon by performing display for rotating the virtual cube. In this embodiment, since surfaces having a predetermined relation are arranged in opposed positions, the user can intuitively understand functions shown on the respective surfaces regardless of whether the surfaces are displayed.

In the second embodiment, after the selection accepting unit 403 accepts selection of a surface of the virtual cube on the liquid crystal touch panel 320, the display processing unit 1901 displays an item key indicating an input object or an output destination corresponding to the surface, selection of which is accepted. The display processing unit displays a plurality of functions, selection of which can be accepted, in advance and displays items corresponding to the functions when the selection of the functions is accepted. In other words, a so-called hierarchical structure is formed. However, the embodiment is not limited to control of the items displayed in a hierarchical manner.

Thus, in a first modification of the second embodiment, all items are displayed from the beginning, or item keys corresponding to respective surfaces are displayed in advance.

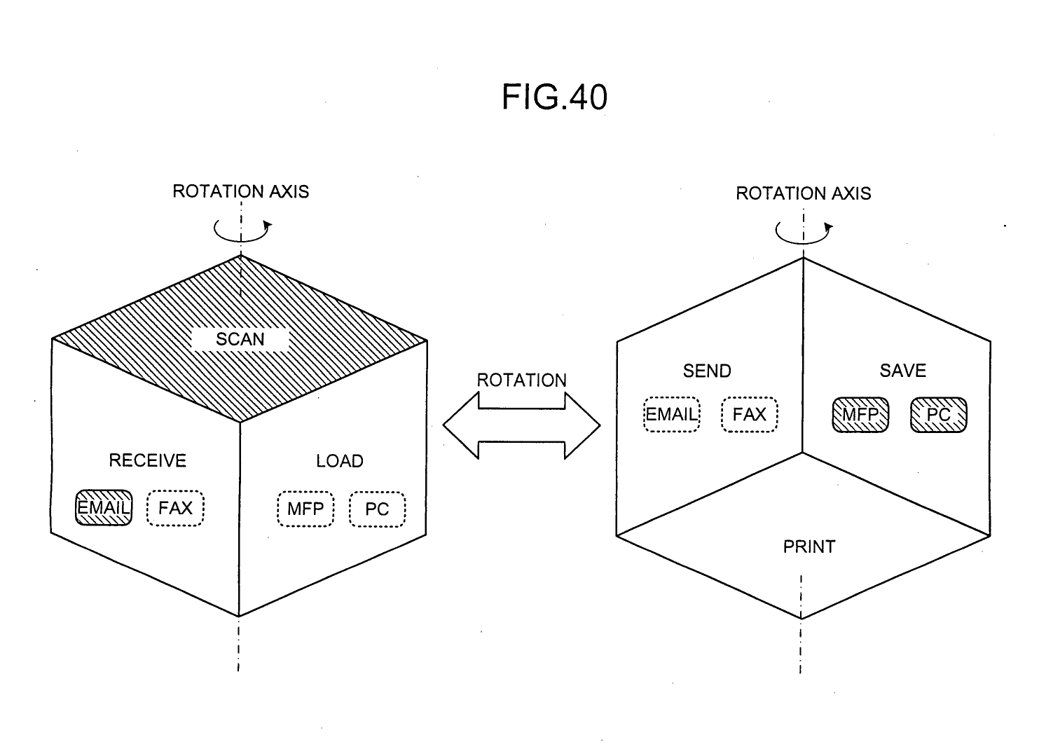

FIG. 40 is a diagram of an example of a screen displayed on the liquid crystal touch panel 320 by the display processing unit. As shown in the figure, the display processing unit according to this modification displays all item keys indicating input objects or output destinations on respective surfaces from the beginning. In other words, input objects and output destinations corresponding to respective functions are displayed as a list.

In this modification, a color of a surface or an item key, selection of which is accepted, is simply changed and display of a preview is not performed. As in this modification, the display processing unit may only perform display of an item key having a function, selection of which is accepted, shown thereon without displaying a preview.

Although different from this modification, it is also possible that item keys are displayed as a list for respective surfaces in advance and, only when selection of an item key is accepted by the user, a preview corresponding to the item key, selection of which is accepted, is displayed.

As another different example, the display processing unit does not display item keys on respective surfaces of the virtual cube first and, when selection of a surface of the virtual cube is accepted, displays an item key included in the surface. It is conceivable that, for example, when the user depresses the item key displayed, the display processing unit does not display the item keys not depressed, displays the depressed item key on the surface with a color of the item key changed, and does not perform preview as in the embodiment described above. In this way, it is possible to display the item keys by combining the constitution described above with various constitutions.

In the second embodiment, the display processing unit 1901 displays one three-dimensional shape model on the liquid crystal touch panel 320. However, the number of three-dimensional shape models displayed on the liquid crystal touch panel 320 is not limited to one. In a fifth embodiment of the present invention, a plurality of virtual cubes are displayed.

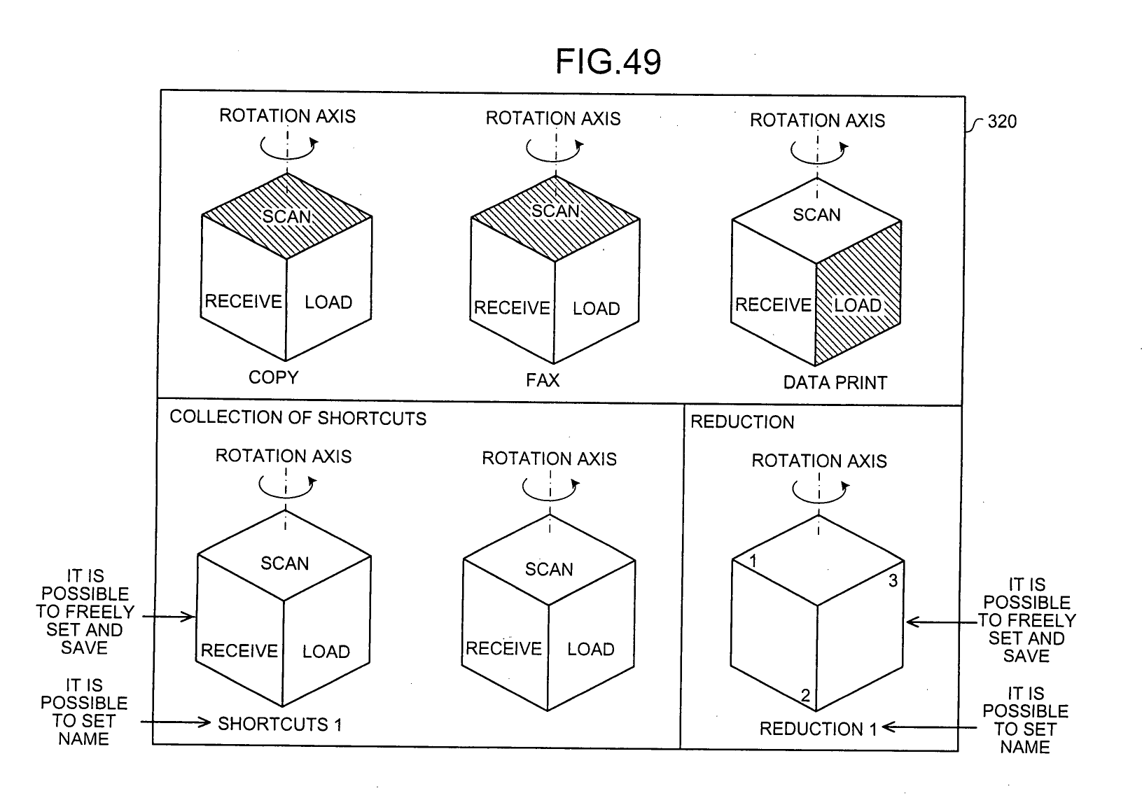

FIG. 49 of the fifth embodiment is a diagram of an example of a screen displayed on the liquid crystal touch panel 320 by the display processing unit according to this modification. As shown in the figure, the display processing unit displays respective virtual cubes by rotating the virtual cubes at predetermined time intervals as in the embodiments described above to switch display of a plurality of surfaces having input function markings shown thereon and display of a plurality of surfaces having output function marking shown thereon.

When the selection accepting unit accepts selection of a surface having an input function marking shown thereon and a surface having an output function marking shown thereon to customize a virtual cube described in a shortcut space, it is possible to save this virtual cube. Consequently, when the customer logs in again, the display processing unit displays the virtual cube in the saved state. The selection accepting unit accepts selection of a surface, selection of which was accepted last time, and the display processing unit changes a color of the surface, selection of which is accepted, and displays the virtual cube. This makes it possible to perform processing using a function corresponding to the surface, selection of which was accepted last time. In other words, since it is unnecessary to set complicated processing every time the processing is performed, it is possible to easily execute the processing.

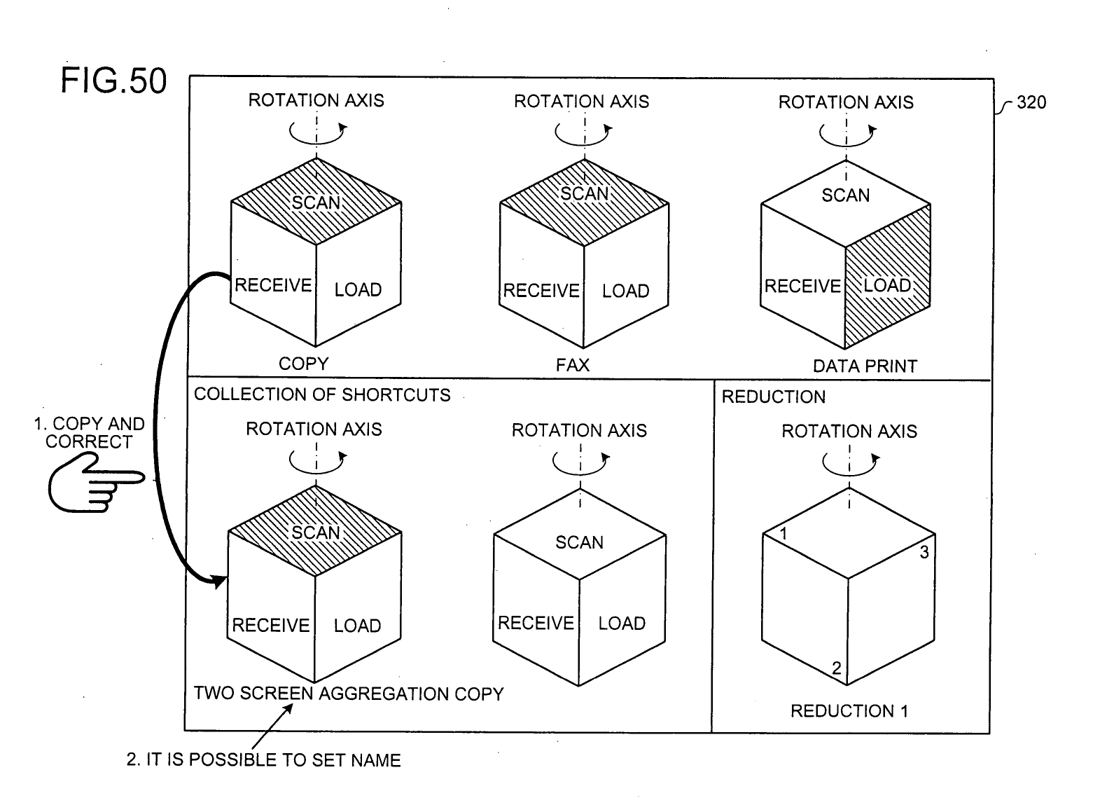

When detailed setting or the like is applied to the virtual cube displayed as the conventional function as shown in FIG. 50, if the user judges that it is likely that the user uses the virtual cube later, it is possible to easily move the virtual cube to the shortcut space and save the virtual cube therein.

In the second embodiment, when selection of a surface having an output function marking shown thereon is accepted and selection of an output destination is accepted on the liquid crystal touch panel 320, the display processing unit 1901 displays a summary of a result obtained by performing output processing for output to the output destination selected as a preview. In displaying the preview, the display is not limited to the display of only the preview of the result obtained by performing the output processing. A preview of a summary of a result obtained by performing input processing may be simultaneously displayed. In a third modification of the second embodiment, selection of a surface having an output function marking shown thereon is accepted, selection of an output destination is accepted, and, then, a preview of a summary of a result obtained by performing output processing and a preview of a summary of a result obtained by performing input processing are displayed and a setting screen showing setting items of output functions is displayed. Since other screens and a processing procedure are the same as those in the second embodiment, explanations of the screens and the processing procedure are omitted.

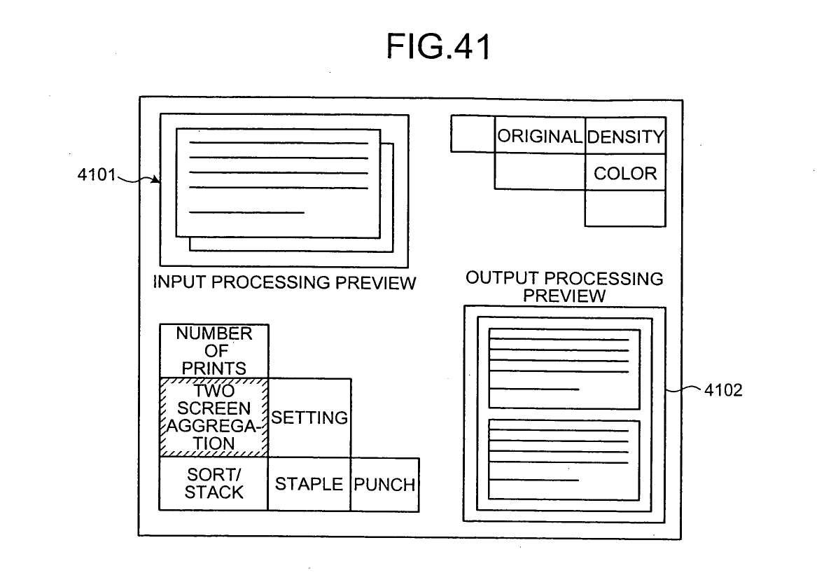

FIG. 41 is a diagram for explaining, as a modification of the second embodiment, an example of previews and a setting screen showing setting items displayed by the display processing unit when the selection accepting unit accepts selection of a surface having the output function marking PRINT shown thereon and accepts selection of the item key PAPER as an output destination. As shown in the figure, an input processing preview 4101 showing a summary of a result obtained by performing input processing is displayed in an upper left area of the screen and an output processing preview 4102 showing a summary of a result obtained by performing output processing is displayed in a lower right area of the screen. As described in the embodiments described above, various setting items for performing detailed setting are displayed around the preview screens in block units.

When the user depresses a block and the display processing unit rotates a virtual polyhedron arranged in the block to display surfaces showing different conditions, the selection accepting unit accepts the conditions displayed in the block as being set anew. Consequently, when the user depresses the block, it is possible to set a new condition in a setting item corresponding to the block. The display processing unit displays a result of output processing using the condition, which is set anew in the setting item, in the output processing preview 4101. Consequently, it is possible to grasp, before an output, the result obtained by performing the output processing. In this case, it is possible to compare the input processing preview 4101 with the output processing preview 4102 and check the input processing preview 4101. Thus, it is possible to visually grasp what kind of setting is made to perform the output processing. Since it is possible to set conditions in block units in this way, operability is improved. Since it is possible to compare an input processing result and an output processing result on the previews, convenience is improved.

In the embodiments described above, the MFP that implements the display processing apparatus is explained. However, the display processing apparatus is not limited to the MFP.

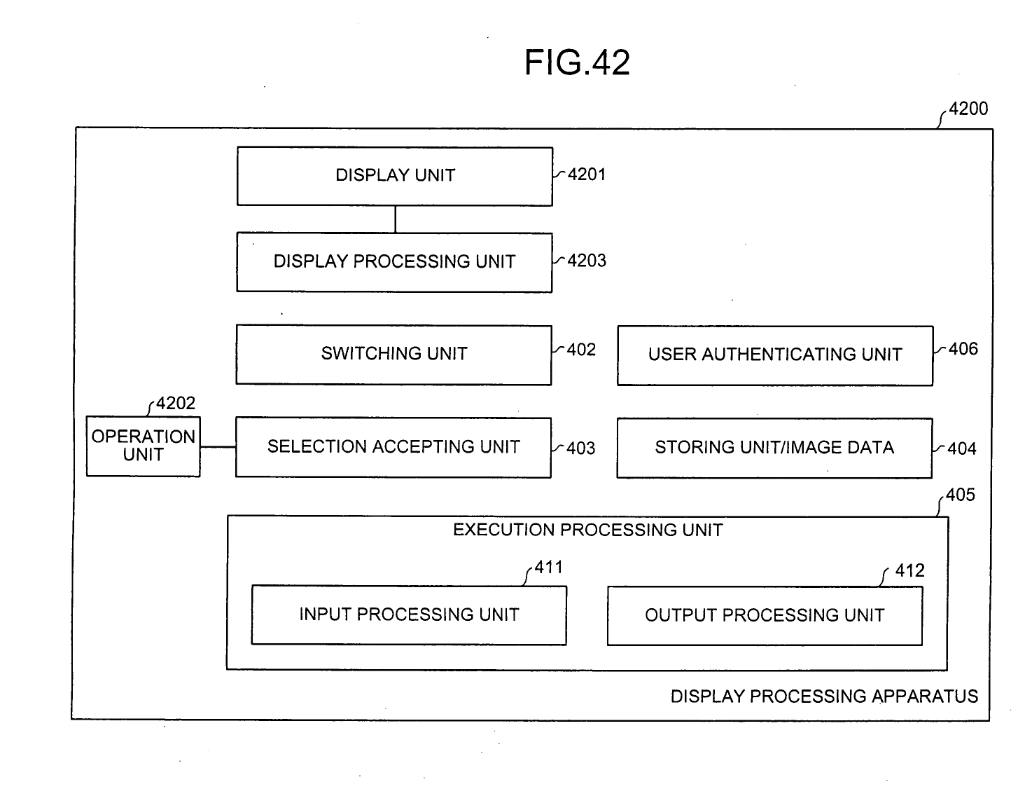

FIG. 42 is a functional block diagram of a display processing apparatus 4200 according to a third embodiment of the present invention. As shown in the figure, the display processing apparatus 4200 has substantially the same structure as that in the application layer 1951 of the MFP 1900 according to the second embodiment. As a difference, the display processing unit 1901 is changed to a display processing unit 4203 and a display unit 4201 and an operation unit 4202 are added. The display processing apparatus 4200 includes the storing unit 404 provided outside the application layer 451.

As in the second embodiment, the display processing unit 4203 displays a plurality of surfaces having input function markings shown thereon and a plurality of surfaces having output function markings shown thereon on a virtual cube. The input function markings and the output function markings displayed by the display processing unit 4203 indicate functions that can be executed when selection thereof is accepted by the display processing unit 4203. In other words, specific markings are different from those of the MFP 1900 according to the second embodiment. Otherwise, the display processing unit 4203 is the same as the display processing unit 1901 of the MFP 1900 according to the second embodiment. Thus, further explanations of the display processing unit 4203 are omitted. The display processing unit 4203 may display a plurality of virtual cubes or may display one virtual cube.

Although different from this embodiment, the display processing unit may display the item keys having the input function markings shown thereon and the item keys having the output function markings shown thereon as in the first embodiment without using the virtual cube.

The display processing unit 4203 may display, when the selection accepting unit 403 accepts selection of an item key, a setting screen for setting a function corresponding to the item key, selection of which is accepted.

A virtual cube on which a plurality of surface having input function markings shown thereon and a plurality of surfaces having output function markings shown thereon are arranged is displayed on the display unit 4201 by the display processing unit 401. Examples of the display unit 4201 include a liquid crystal panel or the line built in the portable display processing apparatus 4200. The display unit 4201 has a display area of a predetermined size.

The predetermined size of the display area of the display unit 4201 is not limited. However, since the display unit 4201 is provided in the display processing apparatus 4200, a size smaller than the display processing apparatus 4200 is preferable. Under this condition, in this embodiment, a size of the display area of the display unit 4201 is a size designed for the purpose of urging the user to recognize executable functions.

As a display processing apparatus including a display unit having a size designed for the purpose of urging the user to recognize executable functions, there are various apparatuses that include a necessary and sufficient display unit that can display the functions and are designated with higher priority given to portability, reduction in space, and other functions than a size of the display unit. Examples of the display processing apparatus include the image forming apparatus explained in the embodiments described above, an audio visual apparatus, a portable terminal, and a cellular phone.

The display unit having the size designed for the purpose of urging the user to recognize executable functions excludes displays of a personal computer (PC) and the like having high universality that specifically have a plurality of different sizes despite the fact that the displays urge the user to recognize identical functions, or that are designed without assuming a state in which functions are displayed. This is because, in designing layouts for displaying functions in the PC and the like, the layouts are usually designed taking into account display areas of the displays. In other words, the displays are different from the device described above in that the displays are main factors of judgment.

The operation unit 4202 is an interface provided for the user to apply operation to the display processing apparatus 4200. The operation unit 4202 may be any mechanism as long as the mechanism is an interface with which the user can input selection of a surface having an input function marking shown thereon and a surface having an output function marking shown thereon.

The selection accepting unit 403 accepts selection according to an input from the operation unit 4202. This means that a liquid crystal panel provided as the display unit as in the first and the second embodiments does not have to be a liquid crystal touch panel on which the user can input data by touching the same with a finger or the like as in the embodiments described above.

Examples of the apparatus including the display processing apparatus 4200 according to this embodiment include an AV apparatus capable of storing music data and, for example, outputting the data to other apparatuses or reproducing the data. In other words, the apparatus may be any apparatus as long as the apparatus is an apparatus that includes an input function and an output function, an apparatus that is capable of performing display on a display unit such as a liquid crystal panel provided in the apparatus, or an apparatus that includes an interface having a liquid crystal touch panel, a plurality of buttons, and the like for selecting a function.

As another example, the display processing apparatus 4200 according to this embodiment may be built in a car navigation apparatus.

It is also possible to provide the display processing apparatus 4200 according to this embodiment in an apparatus and the like that include a display unit and an interface and are carried for use. The display unit is of a size necessary and sufficient for displaying a virtual cube for holding a plurality of surfaces having input functions shown thereon and a plurality of surfaces having output functions shown thereon. Examples of the apparatus include a portable terminal including a liquid crystal touch panel such as a personal digital assistant (PDA).

It is possible to apply the display processing apparatus 4200 to a cellular phone and the like. As an example of use of the cellular phone, a built-in program or the like is started, a surface having an input function shown thereon and a surface having an output function shown thereon for performing some processing are displayed, and selection of the surfaces is accepted. In this case, as in the embodiments described above, display of a plurality of surfaces having input functions shown thereon and display of a plurality of surfaces having output functions shown thereon are alternately switched on a display screen of the cellular phone. Consequently, even if an area that can be used for displaying the functions is small, it is possible to display more surfaces having input functions shown thereon and surfaces having output functions shown thereon by switching the display. This makes it possible to appropriately accept selection of a surface having an input function shown thereon or a surface having an output function shown thereon even when the cellular phone has a plurality of functions.

As an example of acceptance of selection of a surface having an input function shown thereon and a surface having an output function shown thereon in the case of the cellular phone, the user can select these surfaces and accept the selection by depressing dial buttons allocated with UP, DOWN, LEFT, RIGHT and DETERMINE. In this way, the user can accept selection of a desired input function and output function even with a standard interface included in the cellular phone.

The display processing apparatus 4200 may also be used in a portable game terminal and the like. In this way, even in the apparatuses in which a display unit and an interface are not sufficient, it is easy to set input and output functions and operability is improved.

Although different from this embodiment, a touch panel or the like may be used in the operation unit of the display processing apparatus. For example, in an apparatus including a touch panel, a rotating virtual cube is displayed on a display unit and a user depresses the touch panel to accept selection of a surface on which an input function marking shown thereon and a surface having an output function marking shown thereon are displayed. In this way, in the apparatus with a limited input interface, an area having an input function shown therein and an area having an output function shown therein are automatically switched and displayed. This makes it easy to recognize selectable input and output functions and set of the input output functions. As a result, operability is improved.

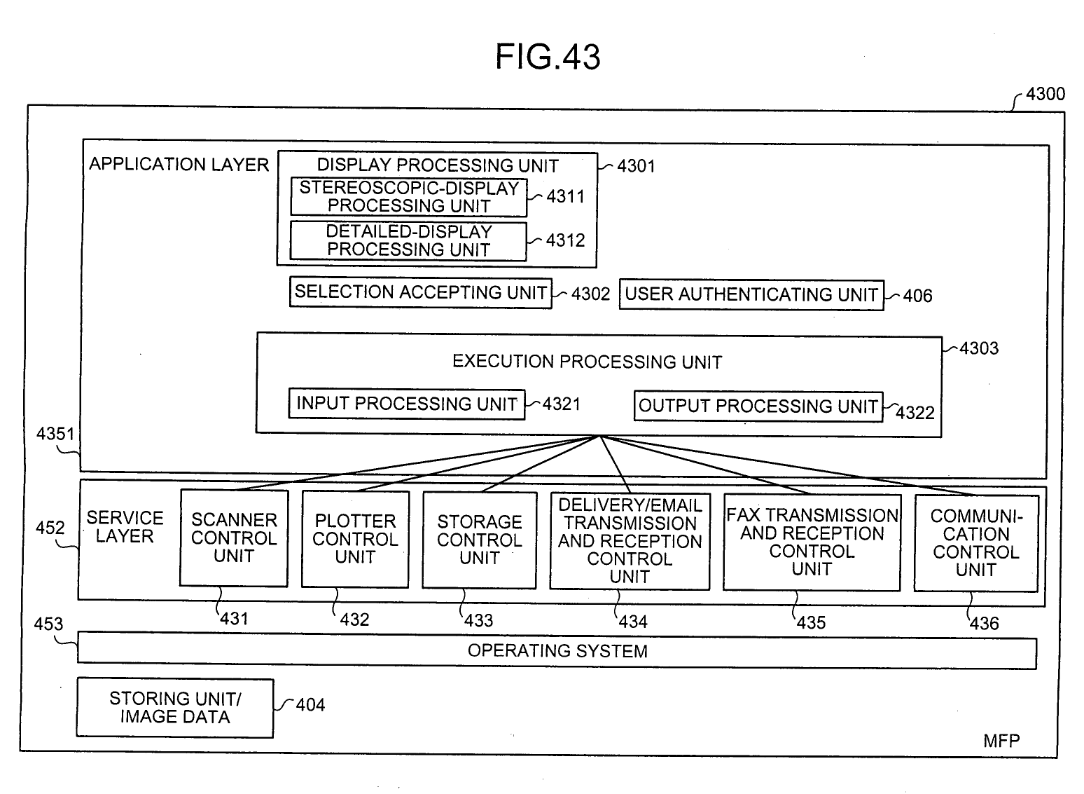

FIG. 43 is a functional block diagram of an MFP 4300 that can execute functions of a display processing apparatus according to a fourth embodiment of the present invention. As shown in the figure, the MFP 4300 includes the operating system 453, the service layer 452, an application layer 4351, and the storing unit 404. As the display processing apparatus according to this embodiment, an image forming apparatus other than the MFP including the constitution described above may be used. In the following explanation, components identical with those in the first embodiment are denoted by the identical reference numerals and signs. Explanations of the components are omitted.

The MFP 4300 according to this embodiment includes the same network environment as that of the MFP 1 according to the first embodiment shown in FIG. 1 and includes the operation panel 300 shown in FIG. 3.

The application layer 4351 includes a display processing unit 4301, a selection accepting unit 4302, an execution processing unit 4303, and the user authenticating unit 406. The application layer 4351 displays a virtual three-dimensional shape model on the liquid crystal touch panel 320. In this embodiment, a shape of the virtual three-dimensional shape model is cubic. In the following explanation, a virtual three-dimensional shape model displayed is referred to as a virtual cube. The application layer 4351 represents an area for each function on the virtual cube, accepts selection of the area for each function represented, and executes a function corresponding to the area accepted.

The virtual cube may be held in any form in the MFP 4300 as long as the user can recognize the virtual cube as a cube when the virtual cube is displayed on the liquid crystal touch panel 320. In other words, it does not matter whether the virtual cube is processed as a three-dimensional shape model in the MFP 4300.

The display processing unit 4301 includes a stereoscopic-display processing unit 4311 and a detailed-display processing unit 4312. The display processing unit 4301 displays a virtual cube on the liquid crystal touch panels 320.

The stereoscopic-display processing unit 4311 displays a virtual cube having functions shown on respective surfaces thereof. The stereoscopic-display processing unit 4311 performs display for rotating the virtual cube around a predetermined rotation axis every predetermined time.

In this embodiment, a virtual cube generated in advance is held in the stereoscopic-display processing unit 4311 and displayed on the liquid crystal touch panel 320. However, a virtual cube may be generated every time display is required on the liquid crystal touch panel 320.

In this embodiment, surfaces of the virtual cube are allocated to respective functions executable in the MFP 4300. The functions are shown on the respective surfaces. Specifically, the stereoscopic-display processing unit 4311 displays markings representing the functions allocated to the surfaces in characters. In this embodiment, as types of the functions, there are a function for performing input processing (hereinafter, “input function”) and a function for performing output processing (hereinafter, “output function”). Consequently, the stereoscopic-display processing unit 4311 displays a surface having one input function shown thereon or a surface having one output function shown thereon on each of the surfaces of the virtual cube.

The stereoscopic-display processing unit 4311 rotates the virtual cube displayed on the liquid crystal touch panel 320 to switch a surface of the virtual cube displayed on the liquid crystal touch panel 320. Further, the stereoscopic-display processing unit 4311 arranges a surface having an input function shown thereon and a surface having an output function shown thereon, which are in a predetermined relation, on two opposed surfaces of the virtual cube, respectively. A positional relation of these surfaces is explained in detail later.

As shown in FIG. 20, the stereoscopic-display processing unit 4311 displays a virtual cube as a function selection screen of the liquid crystal touch panel 320. The stereoscopic-display processing unit 4311 displays one marking indicating an input function or one marking indicating an output function on each of the surfaces of the virtual cube. In this embodiment, the marking indicating an input function or the marking indicating an output function is displayed as a character string. However, a function may be displayed by a figure such as an icon or a mark, a sign, or the like.

As shown in FIG. 25, the stereoscopic-display processing unit 4311 switches and displays a plurality of surfaces having input functions shown thereon and a plurality of surfaces having output functions shown thereon every time the virtual cube is rotated.

Specifically, the stereoscopic-display processing unit 4311 performs display for resting the virtual cube in a position where the surfaces having input functions shown thereon are displayed on the liquid crystal touch panel 320, when three seconds pass after the virtual cube rests, rotating the virtual cube by half, and resting the virtual cube in a position where the surfaces having the output functions shown thereon are displayed on the liquid crystal touch panel 320. Thereafter, in the same processing procedure, the stereoscopic-display processing unit 4311 performs display for, for example, rotating the virtual cube by half and resting the virtual cube in a position where the surfaces having the input functions shown thereon are displayed on the liquid crystal touch panel 320. The stereoscopic-display processing unit 4311 repeatedly performs such display. Consequently, it is possible to alternately switch the surfaces having the input functions shown thereon and the surfaces having the output functions shown thereon.

Since the input functions and the output functions shown on the respective surfaces are the same as those in the first embodiment, explanations of the functions are omitted. In this embodiment, a surface having an input function shown thereon means an input instruction area. A surface having an output function shown thereon means an output instruction area.

A surface having an input function shown thereon and a surface having an output function thereon, which are arranged on opposed surfaces in the virtual cube, have a predetermined relation. Since the predetermined relation is the same as that in the embodiments described above, an explanation of the predetermined relation is omitted.

The user grasps the predetermined relation. Thus, when the virtual cube is displayed on the liquid crystal touch panel 320, the user can easily understand content of a function indicated on a presently displayed surface based on a function displayed on a surface opposed to the surface. In addition, predictability of a function shown on a surface not displayed is improved.

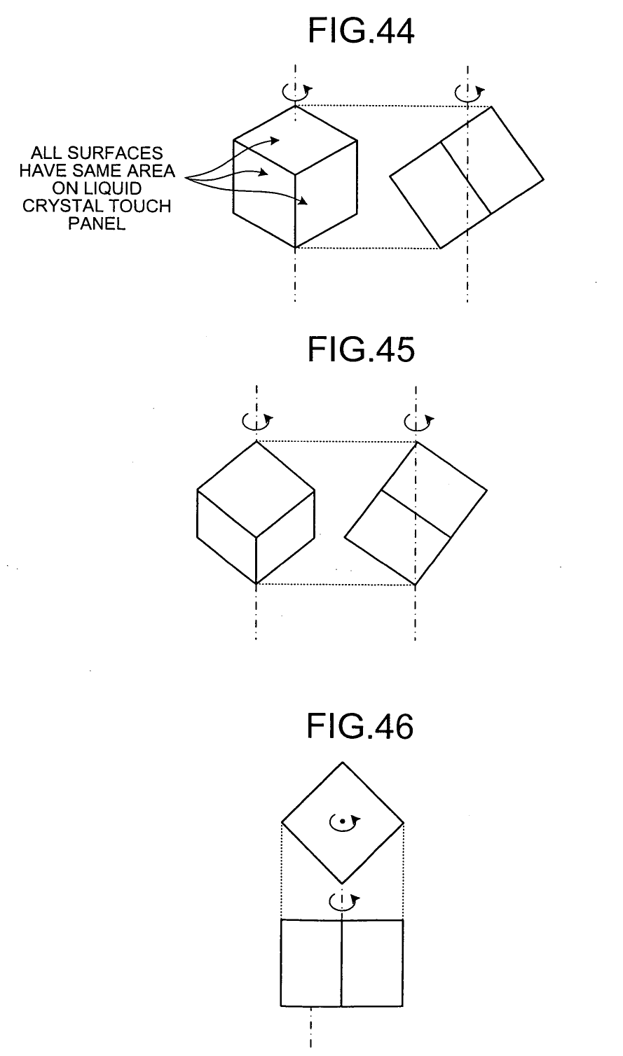

The stereoscopic-display processing unit 4311 rotates the virtual cube on the liquid crystal touch panel 320 around a rotation axis arranged in a predetermined position. FIG. 44 is a diagram for explaining an arrangement of the rotation axis for rotating the virtual cube according to this embodiment. On the left of the figure, a front view of the virtual cube displayed on the liquid crystal touch panel 32 and the rotation axis for rotating the virtual cube is shown. On the right of the figure, a side view for urging the user to understand a positional relation between the rotation axis and the virtual cube is shown. The stereoscopic-display processing unit 4311 rotates the virtual cube around the rotation axis shown in the figure. The rotation and the rest around the rotation axis are repeated for the virtual cube on the liquid crystal touch panel 320. In a stationary state, the stereoscopic-display processing unit 4311 displays, using the rotation axis, the surfaces having the input functions shown thereon and the surfaces having the output functions shown thereon such that areas of the respective surfaces are substantially equal. The rotation axis does not pierce through vertexes of corners of the virtual cube but pierces through the surfaces of the virtual cube. Since the stereoscopic-display processing unit 4311 displays the surfaces in this way, areas of the respective surfaces to be depressed to select the respective functions are equal. Thus, the user can easily select a function.

In this embodiment, the stereoscopic-display processing unit 4311 arranges the rotation axis and the virtual cube such that areas of the respective surfaces of the virtual cube are displayed substantially equal. However, this embodiment does not limit the arrangement. The rotation axis and the virtual cube may be arranged in any way as long as it is possible to display the respective surfaces of the virtual cube on the liquid crystal touch panel 320 by rotating the virtual cube around the rotation axis.

FIG. 45 is a diagram for explaining an arrangement of a rotation axis for rotating a virtual cube by a stereoscopic-display processing unit according to the first embodiment different from this embodiment. On the left of the figure, a virtual cube displayed on a liquid crystal touch panel is shown. In the embodiment shown in the figure, the rotation axis is arranged to pass the center of gravity and vertexes of the virtual cube.

FIG. 46 is a diagram for explaining an arrangement of a rotation axis for rotating a virtual cube by a stereoscopic-display processing unit according to the second embodiment different from this embodiment. In the lower section of the figure, a virtual cube displayed on a liquid crystal touch panel is shown. In the second embodiment shown in the figure, the rotation axis is arranged to pass the center of gravity of the virtual cube and the center of gravity of opposed two surfaces of the virtual cube.

In this way, even when the rotation axes of the embodiments different from this embodiment are used, it is possible to display the respective surfaces of the virtual cube. Thus, it is possible for the user to select the respective surfaces displayed.

Referring back to FIG. 43, when the selection accepting unit 4302 described later accepts selection of a surface having a function shown thereon of the virtual cube, the detailed-display processing unit 4312 displays, on the liquid crystal touch panel 320, a screen for performing detailed setting of a function corresponding to the surface. Specifically, when the selection accepting unit 4302 accepts selection of a surface of the virtual cube from the user, the detailed-display processing unit 4312 enlarges the surface depressed and displays a screen for selecting an input object or an output destination on the surface enlarged. When the selection accepting unit 4302 accepts selection of an input object or an output destination from the user on this screen, the detailed-display processing unit 4312 displays a preview screen or a preview and a detailed setting screen at the time when the input object or the output destination is processed by the function, selection of which is accepted. The screen displayed by the detailed-display processing unit 4312 is described later.

The selection accepting unit 4302 accepts selection of a surface of the virtual cube on the function selection screen displayed by the stereoscopic-display processing unit 4311. Specifically, when the user depresses a surface having an input function or an output function shown thereon of the virtual cube displayed on the liquid crystal touch panel 320 by the stereoscopic-display processing unit 4311, the selection accepting unit 4302 accepts the surface depressed as being selected.

The selection accepting unit 4302 also accepts, in a screen for accepting selection of an input object or an output destination described later, selection of an item key and a condition set by the user on the preview and the detailed setting screen.

When the user depresses a surface having an input function shown thereon displayed on the virtual cube, the selection accepting unit 4302 accepts selection of the surface depressed. A screen for accepting selection of an input object displayed by the detailed-display processing unit 4312 by enlarging the surface depressed is displayed.

FIG. 27 is a diagram of an example of a screen for accepting selection of an input object displayed by the detailed-display processing unit 4312 after selection of item key SCAN 2102 of the virtual cube is accepted. When item key SCAN 2102 is depressed, the selection accepting unit 4302 accepts item key SCAN 2102 as being selected. The detailed-display processing unit 4312 displays a selection screen of an input object of an input function corresponding to item key SCAN 2102 accepted on the liquid crystal touch panel 320.

As shown in FIG. 27, the detailed-display processing unit 4312 displays the depressed surface of the virtual cube in enlargement and, then, displays an item key PAPER on the surface enlarged. When the user depresses the item key PAPER, the selection accepting unit 4302 accepts the item key PAPER as being selected. Consequently, an input processing unit 4321 described later judges that the input object is a paper original and starts input processing for the paper original. When there is only one item key as shown in the figure, since an item key to be depressed has already been decided, the screen for accepting selection of an input object may be omitted. Thereafter, the detailed-display processing unit 4312 displays a preview of a summary of a result obtained by performing the input processing. This preview is described later. When surfaces indicating other input functions such as RECEIVE 2101 and LOAD 2103 are depressed, similarly, after accepting selection of an input object and subjecting the input object to input processing, the detailed-display processing unit 4312 displays a preview of a summary of a result obtained by performing the input processing.

FIG. 28 is a diagram of an example of a screen for accepting selection of an input object displayed by the detailed-display processing unit 4312 after receiving selection of RECEIVE 2101 of the virtual cube. The detailed-display processing unit 4312 displays item keys FAX and EMAIL on an enlarged surface in the same processing as the processing procedure. When the user depresses the item key FAX, the selection accepting unit 4302 accepts the item key FAX as being selected and the input processing unit 4321 described later judges that the input object is a Fax original. When the user depresses EMAIL, the input processing unit 4321 judges that an e-mail received in the name of the user authenticated by the user authenticating unit 406 is an input object. The input processing unit 4321 applies the input processing to the input objects.

FIG. 40 is a diagram of an example of a screen for accepting selection of an input object displayed by the detailed-display processing unit 4312 after receiving selection of LOAD 2103 of the virtual cube. As shown in the figure, the detailed-display processing unit 4312 displays item keys MFP, DESKTOP, INTERNET, NETWORK, and STORAGE on a surface enlarged. When the user depresses any one of the item keys, the selection accepting unit 4302 accepts a medium corresponding to the item key depressed as an input object.

When the user depresses a surface having an output function shown thereon, which is displayed on the virtual cube, a screen for accepting selection of an output destination displayed by the detailed-display processing unit 4312 by enlarging the surface depressed is displayed. Thereafter, a detailed setting screen is displayed.

FIG. 30 is a diagram of an example of a screen for accepting selection of an output destination displayed by the detailed-display processing unit 4312 after accepting selection of PRINT 2105 of the virtual cube.

As shown in FIG. 30, the detailed-display processing unit 4312 displays a surface depressed of the virtual cube in enlargement and, then, displays an item key PAPER on the surface enlarged. When the user depresses the item key PAPER, the selection accepting unit 4302 accepts the item key PAPER as being selected. When there is only one item key as shown in the figure, since an item key to be depressed has already been decided, the screen for accepting selection of an output destination may be omitted. Thereafter, the detailed-display processing unit 4312 displays a preview of a summary of a result obtained by performing the output processing with a function corresponding to the surface, selection of which is accepted, and a detailed setting screen. When surfaces indicating other output functions such as SEND 2104 and SAVE 2106 are depressed, similarly, the detailed-display processing unit 4312 displays a preview of a summary of a result obtained by performing the output processing for output to an output destination and a detailed setting screen.

FIG. 31 is a diagram for explaining an example of a preview and a detailed setting screen displayed by the detailed-display processing unit 4312 when the item key PAPER is accepted as an output destination after selection of PRINT 2105 is accepted. As shown in the figure, the detailed-display processing unit 4312 displays a preview showing a summary of a result obtained by performing output processing and a detailed setting screen based on image data subjected to input processing. On this screen, setting items for performing detailed setting are arranged in block units around an area where the preview is shown. The detailed-display processing unit 4312 displays conditions presently set for the respective items in these blocks. When the user depresses an arbitrary block, the detailed-display processing unit 4312 rotates a virtual polyhedron arranged for each of the blocks to display a surface on which a different condition is shown. The selection accepting unit 4302 accepts the condition shown on the surface displayed by the rotation of the virtual polyhedron as being set anew.

Specifically, as shown in the figure, when the user depresses a block indicated as SCREEN AGGREGATION, the detailed-display processing unit 4312 displays the virtual polyhedron arranged in the block as rotating. When a surface indicated as TWO SCREEN AGGREGATION of the virtual polyhedron comes to a position coinciding with an area of the block, the detailed-display processing unit 4312 displays the virtual polyhedron as resting. The detailed-display processing unit 4312 changes the image data displayed in the area of the preview to image data subjected to TWO SCREEN AGGREGATION and displays the image data. Consequently, when the user depresses the various setting items arranged in block units to change a condition displayed, the selection accepting unit 4302 accepts the condition changed and the detailed-display processing unit 4312 displays image data according to the condition set anew as a preview. Therefore, the user can easily grasp a result obtained by performing output processing under the condition changed as a preview. Even when the user does not know a function shown in a block, when the user depresses the block, the detailed-display processing unit 4312 changes a condition shown in the block and displays the condition. The detailed-display processing unit 4312 further displays a preview of a summary of a result obtained by performing output processing under the condition changed. Consequently, the user can intuitively understand content of an item for each of the blocks by depressing the block. Moreover, since the various setting items are shown in block units, it is possible to easily perform customization, for example, addition, change, or deletion of setting items available for each MFP. In other words, it is possible to easily change setting items provided according to a request or the like of the user.

FIG. 32 is a diagram of an example of a screen for accepting selection of an output destination displayed by the detailed-display processing unit 4312 after accepting selection of SEND 2104 of the virtual cube. According to the same processing as the processing procedure described above, the detailed-display processing unit 4312 displays item keys FAX and EMAIL on enlarged surfaces. When the user depresses the item key FAX, the selection accepting unit 4302 accepts the item key FAX as being selected. Consequently, an output processing unit 4322 described later judges that a Fax original is selected as an output destination. When the user depresses the item key EMAIL, the output processing unit 4322 judges that transmission of an e-mail in the name of the user authenticated by the user authenticating unit 406 is selected.

When an item key is selected, the screen may be switched to a detailed setting screen for an output destination. FIG. 33 is a diagram of an example of a screen displayed by the detailed-display processing unit 4312 when the item key FAX is accepted as an output destination after selection of SEND 2104 is accepted. As shown in the figure, after the user selects FAX, the detailed-display processing unit 4312 displays a screen for performing detailed setting for transmission to an output destination. When the user selects a transmission destination of Fax, resolution in transmission, and the like in detail in the screen, the selection accepting unit 4302 accepts the setting selected. The detailed-display processing unit 4312 displays a preview reflecting the selections accepted. The preview may be added to a transmission destination and detailed setting items shown in the figure and displayed on the identical screen.

FIG. 34 is a diagram of an example of a screen for accepting selection of an output destination displayed by the detailed-display processing unit 4312 after selection of the output function marking SAVE of the virtual cube is accepted. When the user depresses any one of the item keys, the selection accepting unit 4302 accepts a medium corresponding to the item key depressed as an output destination.

In this way, after a surface indicating a function is depressed, an item key indicating an input object or an output destination is displayed to accept selection of the item key. Consequently, the user can set input processing and output processing easily and in detail.

FIG. 22 is a diagram for explaining transition of a screen displayed on the liquid crystal touch panel 320 according to this embodiment from a function selection screen in which a virtual cube, in which selection of a surface having an input function shown thereon is not accepted, is shown to a function selection screen after selection of one screen having an input function shown thereon is accepted.

As shown in the upper section of FIG. 22, when the user depresses item key SCAN 2102 of the virtual cube from above the liquid crystal touch panel 320, the selection accepting unit 4302 accepts item key SCAN 2102 as being selected. The detailed-display processing unit 4312 enlarges the surface depressed and displays an item key for accepting selection of an input object on the surface enlarged. Since this screen is the same as that shown in FIG. 27, the screen is not shown. When the user depresses the item key, the selection accepting unit 4302 accepts the item key depressed as being selected.

The input processing unit 4321 described later judges an input object corresponding to the item key accepted by the selection accepting unit 4302. When the input processing unit 4321 judges that a paper original is selected as an input object, the input processing unit 4321 reads the paper original and subjects the paper original to input processing as image data. The detailed-display processing unit 4312 displays a preview showing a summary of a result obtained by performing input processing in the screen enlarged. An example of the screen in which the preview is displayed is the screen shown in the middle section of FIG. 22. Consequently, the user can easily recognize a result of the input processing.

The user checks the preview and, when it is judged that there is no problem, depresses the OK button 2201. When image data different from what the user has assumed is displayed, the user depresses the CANCEL button 2202. When the selection accepting unit 4302 accepts selection of the CANCEL button 2202, the image data subjected to the input processing is canceled. The detailed-display processing unit 4312 displays the screen shown in the upper section of FIG. 22 again.

When the selection accepting unit 4302 accepts selection of the OK button 2201, assuming that the user judges that there is no problem in a result obtained by performing input processing with a scan function corresponding to item key SCAN 2103, the stereoscopic-display processing unit 4311 displays a screen shown in the lower section of FIG. 22. The detailed-display processing unit 4312 changes a color of item key SCAN 2203 and displays a preview showing a summary of the image data subjected to the input processing in item key SCAN 2203. The summary is an image changed to be displayable on the liquid crystal touch panel 320. In this embodiment, specifically, the image is reduced to a displayable size and simplified. This makes it easy to urge the user to understand input processing performed by a function, selection of which is accepted, and makes it easy to understand image data to be outputted after the input processing is performed. When selection RECEIVE 2101 or LOAD 2103 is accepted, input processing is performed according to the same processing procedure.

The number of images subjected to the input processing displayed on the preview, which are shown in the middle and the lower sections of FIG. 22, may be identical with the number of images actually subjected to input processing or may be abbreviated. This means that, for example, when there are one or two images, the images are displayed to allow the user to grasp the number but, when there are three or more images, the images are displayed to urge the user to simply recognize that there are a plurality of images.

FIG. 23 is a diagram for explaining transition of a screen displayed on the liquid crystal touch panel 320 according to this embodiment from a function selection screen in which a virtual cube, in which selection of a surface having an output function shown thereon is not accepted, is shown to a function selection screen after selection of one screen having an output function shown thereon is accepted. As shown in the figure, when the user depresses PRINT 2105 of the virtual cube from above the liquid crystal touch panel 320, the selection accepting unit 4302 accepts PRINT 2105 as being selected. The detailed-display processing unit 4312 enlarges a surface depressed and displays an item key for accepting selection of an output destination on the surface enlarged. Since this screen is the same as that shown in FIG. 30, the screen is not shown. When the user depresses the item key, the selection accepting unit 4302 accepts the item key depressed as being selected.

When the selection accepting unit 4302 accepts the selection of the item key, the detailed-display processing unit 4312 displays a preview showing a summary of a result obtained by performing output processing for output to an output destination corresponding to the item key, selection of which is accepted, and a detailed setting screen on the surface enlarged. An example of this screen is a screen shown in the middle section of FIG. 23. This screen allows the user to make detailed setting in performing output processing. Details of a setting procedure are described later.

The user performs setting or the like of a condition for each of the items as required in the screen shown in the middle section of FIG. 23 and checks, on a preview, a result obtained by performing output processing according to the condition set. When the user checks the preview and judges that there is no problem, the user depresses the OK button 2301. When a function selected is wrong, the user depresses the CANCEL button 2302. When the user depresses the CANCEL button 2302, the conditions and the like set in the screen shown in the middle section of FIG. 23 is canceled. The stereoscopic-display processing unit 4311 displays the screen in the upper section of FIG. 23 again.

When the selection accepting unit 4302 accepts selection of the OK button 2301, judging that setting of a print function corresponding to PRINT 2105 is completed, the stereoscopic-display processing unit 4311 displays a screen in the lower section of FIG. 23. The stereoscopic-display processing unit 4311 changes a color of PRINT 2305 and displays a preview of a summary of image data of a result, which is obtained by performing output processing, in PRINT 2303. Consequently, the user can easily grasp a result of output performed by the function selected. In other words, the user can intuitively understand a result of processing by the function selected compared with the color conversion or the like of item keys or the explanation of functions by text explanation, which has been often used conventionally. The output processing is performed according to the same processing procedure when SEND 2104 or SAVE 2106 is selected.

The number of images displayed on the preview, which shows a summary of the result obtained by performing the output processing, may be identical with the number of images actually subjected to output processing or may be abbreviated.

FIG. 24 is a diagram for explaining an example of a virtual cube displayed by the stereoscopic-display processing unit 4311 when selection of item key SCAN 2203 and PRINT 2303 is accepted. As shown in the figure, the stereoscopic-display processing unit 4311 changes colors of item key SCAN 2203 and PRINT 2303, selection of which is accepted in the virtual cube, and displays the item keys. The stereoscopic-display processing unit 4311 also displays previews showing summaries of results of processing by the functions on surfaces of the item keys. Thus, the user can recognize the functions selected and intuitively understand results of input processing and output processing.

Even after the selection accepting unit 4302 has already accepted selection of a surface having one input function shown thereon, the selection accepting unit 4302 can further accept selection of a surface having another input function shown thereon. Similarly, even after the selection accepting unit 4302 has already accepted selection of a surface having one output function shown thereon, the selection accepting unit 4302 can further accept selection of a surface having another output function shown thereon. In other words, it is possible to accept selection of a plurality of input functions and output functions by performing processing once. In this way, it is possible to accept selection of one or more input functions and output functions. This makes it possible to execute processing desired by the user and improves operability and convenience.

FIG. 25 is a diagram of an example of a virtual cube displayed by the stereoscopic-display processing unit 4311 when selection of PRINT 2503 is accepted after selection of item key SCAN 2501 and LOAD 2502 is accepted. As shown in the figure, when the selection accepting unit 4302 accepts selection of a plurality of surfaces having input functions shown thereon and a plurality of surface having output functions shown thereon, the stereoscopic-display processing unit 4311 displays a preview for each surface selected.

When the selection accepting unit 4302 accepts selection of a plurality of surfaces having input functions shown thereon, a plurality of image data are generated by input functions corresponding to the surfaces, selection of which is accepted. The output processing unit 4322 described later applies output processing to the image data generated. Before the output processing is performed, the stereoscopic-display processing unit 4311 displays a preview of a summary of a result, which is obtained by performing output processing using the image data generated by the input functions, on the surfaces having the output functions shown thereon, selection of which is accepted. Consequently, the user can easily grasp a result obtained by performing the output processing when selection of the surfaces having the input functions shown thereon is accepted.

When the selection accepting unit 4302 accepts selection of a plurality of surfaces having output functions shown thereon, as in the case of the selection of a plurality of surfaces having input functions shown thereon, the stereoscopic-display processing unit 4311 changes colors of the surfaces, selection of which is accepted, and displays preview showing summaries of results of output processing on the respective surfaces.

In the MFP 4300 according to this embodiment, the user can accept selection of a plurality of input objects from a surface having one input function shown thereon. The user can also accept selection of a plurality of output destinations from a surface having one output function shown thereon.

FIG. 26 is a diagram of an example of a screen displayed on the liquid crystal touch panel 320 by the stereoscopic-display processing unit 4311 when the selection accepting unit 4302 accepts selection of LOAD 2601, accepts selection of item keys PC and MFP, and accepts selection of PRINT 2602. In a screen shown in the figure, first, the user depresses the item key PC after depressing LOAD 2103. The user depresses the item key MFP after depressing LOAD 2103 again. Then, the stereoscopic-display processing unit 4311 displays LOAD 2601 on the virtual cube. Thereafter, after the user depresses PRINT 2105 and depresses the item key PAPER, the stereoscopic-display processing unit 4311 displays the virtual cube shown in FIG. 26.

In the example shown in FIG. 26, the selection accepting unit 4302 accepts selection of PRINT 2105 and conditions are set on a preview and a detailed setting screen. Then, the stereoscopic-display processing unit 4311 subjects input objects corresponding to the item key PC and the item key MFP, selection of which has already been accepted, to input processing to generate a plurality of image data. The stereoscopic-display processing unit 4311 displays a preview showing a summary of an output processing result, which is generated based on the image data, in PRINT 2602. Thereafter, when the user depresses the start key 308, output processing by the output processing unit 4322 is performed. In this way, when the selection accepting unit 4302 accepts selection of a plurality of input objects from one input function, the input processing unit 4321 subjects image data of the input objects selected by the identical input function to input processing. Moreover, the output processing unit 4322 can subject one or more image data, which are generated from the image data subjected to the input processing, to output processing.

Referring back to FIG. 43, the execution processing unit 4303 includes the input processing unit 4321 and the output processing unit 4322. The execution processing unit 4303 performs input and output processing using the function of the MFP 4300. The service layer 452 controls hardware resources based on content processed by the execution processing unit 4303. As a result, processing using hardware is performed.

The input processing unit 4321 judges an input function corresponding to a surface having an input function shown thereon, selection of which is accepted by the selection accepting unit 4302, and subjects image data to input processing using the input function judged. As a specific example, when selection of item key SCAN 2102 is accepted, the input processing unit 4321 judges that an input function is a function for reading a paper original and controls a not-shown scanner with a scanner control unit 431 to perform processing for reading the paper original. When selection of RECEIVE 2101 is accepted, the input processing unit 4321 judges that the input function is a reception function and controls a not-shown network communication function with a communication control unit 436 to perform processing for receiving image data. When selection of LOAD 2103 is accepted, the input processing unit 4321 judges that the input function is a function for reading from a hard disk (HD) and controls a storage control unit 433 to perform processing for reading image data from the storing unit 404 included in the MFP 4300 or controls the communication control unit 436 to perform processing for reading image data from an HD included in the PC.

The output processing unit 4322 judges an output function corresponding to a surface having an output function shown thereon, selection of which is accepted by the selection accepting unit 4302, and subjects image data to output processing using the output function judged. As a specific example, when selection of PRINT 2105 is accepted, the output processing unit 4322 judges that the output function is a function for printing a paper original and controls a not-shown plotter from the plotter control unit 432 to subject the paper original to print processing. When selection of SEND 2104 is accepted, the output processing unit 4322 judges that the output function is a transmission function and controls the not-shown network communication function with the communication control unit 436 to perform processing for transmitting image data. When selection of SAVE 2106 is accepted, the output processing unit 4322 judges that an output function is a function for storage in the HD and controls the storage control unit 433 to perform processing for writing image data in the storing unit 404 included in the MFP 4300 or controls the communication control unit 436 to perform processing for writing image data in the HD included in the PC or the like connected via the network.

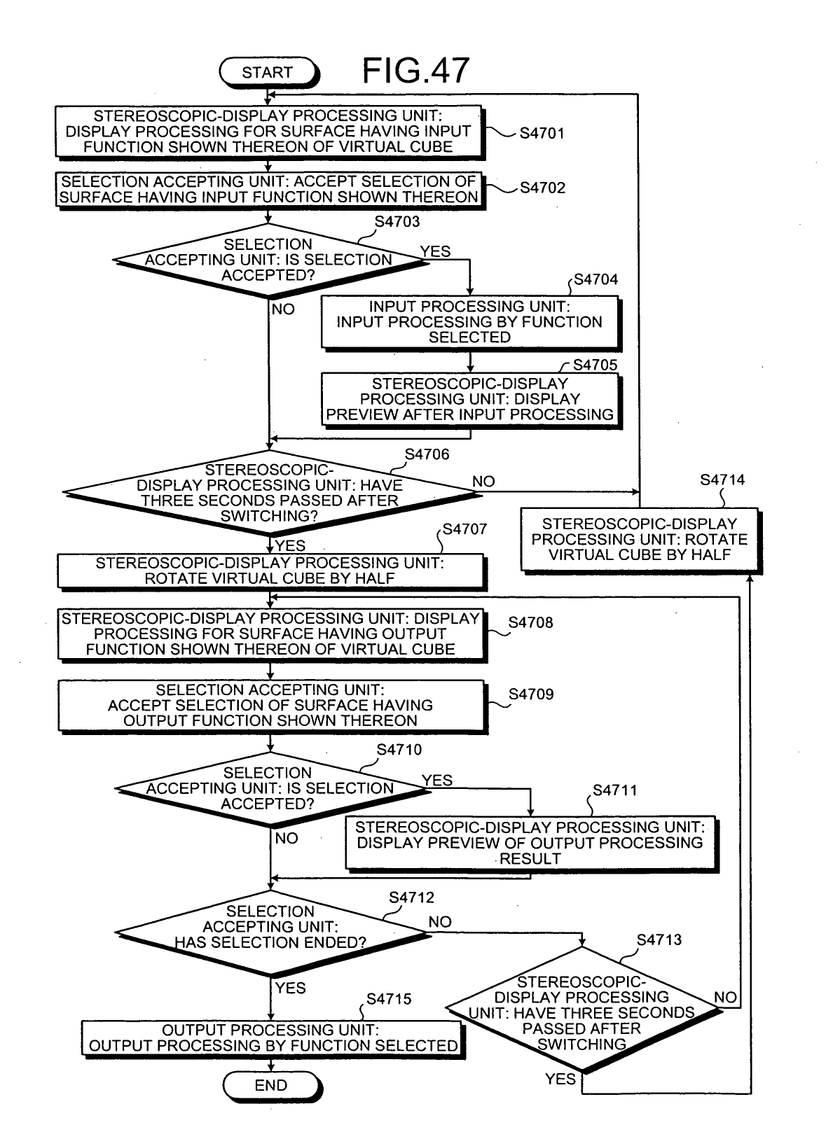

Processing from display processing for a surface having an input function shown thereon of the virtual cube until selection of surfaces having an input function and an output function shown thereon is accepted and output processing is performed in the MFP 4300 according to this embodiment is explained. FIG. 47 is a flowchart of a procedure of the processing in the MFP 4300 according to this embodiment.

First, the stereoscopic-display processing unit 4311 displays, on the liquid crystal touch panel 320, a virtual cube in a state in which the user can refer to a plurality of surfaces having input functions shown thereon (step S4701). The selection accepting unit 4302 accepts selection of a surface having an input function shown thereon according to the touch of the user on the liquid crystal touch panel 320 (step S4702).

The selection accepting unit 4302 judges whether selection of the surface having the input function shown thereon is accepted (step S4703). When the selection accepting unit 4302 judges that the selection is accepted (“Yes” at step S4703), the input processing unit 4321 performs input processing using an input function corresponding to the surface, selection of which is accepted (step S4704). After the input processing is performed, the stereoscopic-display processing unit 4311 displays a preview showing a summary of a result obtained by performing the input processing on a surface of the virtual cube (step S4705).

When the selection accepting unit 4302 judges that the selection of a surface is not accepted (“No” at step S4703), no processing is performed in particular.

The stereoscopic-display processing unit 4311 judges whether three seconds have passed after the surfaces having the input functions shown thereon are displayed (step S4706).

When the stereoscopic-display processing unit 4311 judges that three seconds have not passed after the surfaces having the input functions shown thereon are displayed (“No” at step S4706), the stereoscopic-display processing unit 4311 directly displays the surfaces having the input functions shown thereon (step S4701).

When the stereoscopic-display processing unit 4311 judges that three seconds have passed after the surfaces having the input functions shown thereon are displayed (“Yes” at step S4706), the stereoscopic-display processing unit 4311 rotates the virtual cube around a rotation axis thereof by half and displays the virtual cube (step S4707).

After rotating the virtual cube by half, the stereoscopic-display processing unit 4311 displays the virtual cube in a state in which the user can refer to a plurality of surfaces having output functions shown thereon on the liquid crystal touch panel 320 (step S4708).

The selection accepting unit 4302 accepts selection of a surface having an output function shown thereon according to the touch of the user on the liquid crystal touch panel 320 (step S4709). The selection accepting unit 4302 judges whether selection of the surface having the output function shown thereon is accepted (step S4710). When the selection accepting unit 4302 judges that the selection is accepted (“Yes” at step S4710), the stereoscopic-display processing unit 4311 displays, based on the image data subjected to the input processing, a preview of a result obtained by performing output processing using the output function corresponding to the surface, selection of which is accepted, on the surface, selection of which is accepted, of the virtual cube (step S4711).

When the selection accepting unit 4302 judges that the selection is not accepted (“No” at step S4710), no processing is performed in particular.

The selection accepting unit 4302 judges whether the acceptance of the selection of surfaces from the user has ended (step S4712). Specifically, the selection accepting unit 4302 judges whether the acceptance of the selection of surfaces from the user has ended according to whether the user depresses the start key 308. The selection accepting unit 4302 judges that the acceptance of the selection has ended only when the functions for performing the input processing at step S4704 and the output processing at step S4710 are selected. Although not shown in the figure, when these conditions are not satisfied, a warning indicating that a surface is not selected is displayed on the liquid crystal touch panel 320.

When the selection accepting unit 4302 judges that the acceptance of the selection of surfaces from the user has not ended (“No” at step S4712), the stereoscopic-display processing unit 4311 judges whether three seconds have passed after the surfaces having the output functions shown thereon are displayed (step S4713).

When the stereoscopic-display processing unit 4311 judges that three seconds have not passed after the surfaces having the output functions shown thereon are displayed (“No” at step S4713), the stereoscopic-display processing unit 4311 directly displays the surfaces (step S4708).

When the stereoscopic-display processing unit 4311 judges that three seconds have passed after the surfaces having the output functions shown thereon are displayed (“Yes” at step S4713), the stereoscopic-display processing unit 4311 rotates the virtual cube around the rotation axis by half and displays the virtual cube (step S4714).

When the selection accepting unit 4302 judges that the acceptance of the selection of surfaces from the user has ended (“Yes” at step S4712), the output processing unit 4322 applies output processing by the output function corresponding to the surface having the output function shown thereon, selection of which is accepted at step S4710, to the image data subjected to the input processing at step S4704 (step S4715).

According to the processing procedure described above, it is possible to perform processing using the input and output functions corresponding to the surfaces, selection of which is accepted from the user. Specifically, since a surface having a function shown thereon only has to be depressed, the user can easily select functions used for the input processing and the output processing. The processing procedure is an example of a processing procedure from display of the virtual cube including surfaces having input functions shown thereon according to this embodiment until selection by the user is accepted to perform the output processing. The embodiment is not limited to such a processing procedure.

In this embodiment, the stereoscopic-display processing unit 4311 uses a cube as a three-dimensional shape model for displaying functions on the liquid crystal touch panel 320. However, the three-dimensional shape model displayed is not limited to a cube.

In the embodiments described above, in the stationary state, the display processing unit displays only the surfaces having the input functions shown thereon or the surfaces having the output functions shown thereon on the three-dimensional shape model. However, display of the three-dimensional shape model is not limited to such display. In the stationary state, the surfaces having the input functions shown thereon and the surfaces having the output functions shown thereon may be simultaneously displayed. As an example, it is conceivable that the input functions and the output functions are shown on the respective surfaces of the three-dimensional shape model such that the input function SCAN and the output function PRINT, which have a predetermined relation, are simultaneously displayed in the stationary state.

In this embodiment, a color of the surface having the input function shown thereon, selection of which is accepted, and a color of the surface having the output function shown thereon, selection of which is accepted, are different. As a specific example, the surface having the input function shown thereon is changed to blue when the selection is accepted. The surface having the output function shown thereon is changed to red when the selection is accepted. Consequently, since the user can judge whether a function is an output function or an input function according to a color of a surface, convenience is improved. Alternatively, all surfaces, selection of which is accepted, may be displayed in different colors or may be displayed in the same color.

When selection of a surface having an input function shown thereon or a surface having an output function shown there on is accepted, the stereoscopic-display processing unit 4311 according to this embodiment changes a color of the surface. However, indication of the acceptance of the selection is not limited to the change of a color. The indication may be displayed in any form as long as acceptance of selection of a surface having a function shown thereon is displayed in a visually recognizable form. For example, a font number of characters described on a surface selected may be changed or a color of the characters may be changed.

In this embodiment, as an input function marking on a surface having an input function shown thereon of the virtual cube, a character string indicating the input function is arranged. Similarly, as an output function marking on a surface having an output function shown thereon of the virtual cube, a character string indicating the output function is arranged. However, the input function marking and the output function marking are not limited to such character strings. Any marking may be used. For example, figures such as icons or marks indicating the input function and the output function may be used or signs or the like may be used.

This embodiment does not limit an order of accepting selection of a surface having an input function shown thereon and a surface having an output function shown thereon. In this embodiment, either the surface having the input function shown thereon or the surface having the output function shown thereon may be selected first. Selection of the surfaces only has to be accepted before output processing is actually performed.

When selection of the surface having the input function shown thereon is accepted after selection of the surface having the output function shown thereon is accepted, the display processing unit 4301 does not display a preview at a stage when the selection of the surface having the output function shown thereon is accepted. The display processing unit 4301 displays previews corresponding to the surface having the input function shown thereon and the surface having the output function shown thereon, selection of which is accepted, at a stage when the selection of the surface having the input function shown thereon is accepted later.

As an example different from this embodiment, it is conceivable to provide a limitation on acceptance of the selection of the surface having the output function shown thereon. As a specific example, the selection accepting unit does not perform control for accepting the selection of the surface having the output function shown thereon while the selection of the surface having the input function shown thereon is not accepted. After the selection of the surface having the input function shown thereon is accepted, control for accepting the selection of the surface having the output function shown thereon is performed.

In this embodiment, the MFP 4300 repeats the processing for rotating the virtual cube by half every three seconds and, then, stopping the virtual cube. However, other modification is possible. Display processing for rotation of a virtual cube according to modifications different from this embodiment is explained.

As a first modification, the virtual cube is always automatically rotated at predetermined speed and displayed. Even while the virtual cube is rotating, it is possible to accept selection of a surface having an input function shown thereon and a surface having an output function shown thereon of the virtual cube.

As a second modification, processing for rotating the virtual cube once every predetermined time and resting the virtual cube is repeated. Usually, the same surfaces are displayed before and after the rotation. When selection is accepted from these surfaces, the virtual cube is rotated by half. The rotation may be any rotation other than the full rotation and the half rotation. For example, the rotation may be quarter rotation or the like.

The rotation is not limited to the rotation at every predetermined time and the rotation at the predetermined speed. The virtual cube may rotate when an input from the user satisfies a predetermined condition. As a third modification, a plurality of surfaces having input functions shown thereon of the virtual cube are displayed and, when selection of a surface having an input function shown thereon is accepted from the user, a stereoscopic-display processing unit rotates the virtual cube by half.

The stereoscopic-display processing unit does not always have to control the rotation of the virtual cube. For example, the rotation of the virtual cube may be controlled according to operation of the user. As a fourth modification, the virtual cube is rotated when the user touches an end or the like of the virtual cube displayed on the liquid crystal touch panel with a finger or the like. Consequently, the user can display a surface that the user wishes to refer to. As control for stopping the virtual cube rotated, any control may be used. For example, the virtual cube may be stopped when the user touches the virtual cube with the finger or the like again or may be automatically stopped after the virtual cube is rotated or rotated by half.

When the user controls the rotation, the virtual cube may be always rotated in one direction or may be rotated in different directions or at different speeds according to operation of the user.

This embodiment does not limit a function shown in each area only to an input function or an output function. Any function may be used as long as the function is an executable function provided to the user.

In the embodiments and the modifications described above, there is no specific correspondence relation between the markings of the input functions and the markings of the output functions shown on the surfaces of the virtual cube and the rotating direction of the virtual cube. However, the rotating direction of the virtual cube may be set taking into account the markings of the input functions and the markings of the output functions, although the rotating direction is not specifically limited. Specifically, when the markings are arranged as character strings written from the left to the right, the virtual cube is rotated from the right to the left. Consequently, the user can easily read the markings on the outer surface of the virtual cube even while the virtual cube is rotating.

In this embodiment, the MFP 4300 rotates the three-dimensional shape model, which has the surfaces having the input functions shown thereon and the surfaces having the output functions shown thereon, every three seconds and displays the three-dimensional shape model. Thus, even with the liquid crystal touch panel 320 with resolution and a size of a screen displayed limited, it is possible to urge the user to grasp input functions and output functions, selection of which can be accepted. In selecting functions, the user only has to select a surface having an input function shown thereon and a surface having an output function shown thereon. Since it is easy to select functions even if there are many executable input functions and output functions, operability is improved.

The MFP 4300 does not collectively display all the executable functions. The MFP 4300 rotates the virtual cube including the surfaces having the input functions shown thereon and the surfaces having the output functions shown thereon and switches a state in which the input functions are shown and a state in which the output functions are shown. In other words, the functions are categorized and displayed. Thus, the user can easily understand functions that are selectable for each of the categories. It is possible to display a large number of functions regardless of a size of the liquid crystal touch panel 320. Since the number of functions displayed at a time is limited, display on the liquid crystal touch panel 320 is prevented from being complicated. Consequently, the user can easily check content displayed visually and easily specify a surface having a function used for processing shown thereon from the surfaces having the input functions shown thereon and the surfaces having the output functions shown thereon displayed.

The user can stereoscopically grasp, on the three-dimensional shape model, the surfaces having the selectable input functions shown thereon and the surfaces having the selectable output functions shown thereon. Consequently, acceptance of selection of a function according to a request of the user is facilitated when processing is performed. In the stationary state, only the surfaces having the input functions shown thereon or the surfaces having the output functions shown thereon are displayed. Thus, the user can distinguish the input and output functions in a state in which the functions are displayed on the liquid crystal touch panel 320.

The three-dimensional shape model including a surface having an input function shown thereon and a surface having an output function shown thereon as a pair is rotated. Thus, the user can easily grasp a positional relation between the surface having the input function shown thereon and the surface having the output function shown thereon. In this embodiment, since the surfaces having the predetermined relation are arranged in opposed positions, the user can intuitively understand the functions shown on the respective surfaces regardless of whether the functions are displayed on the liquid crystal touch panel 320.

In the fourth embodiment, after selection of a surface of the virtual cube is accepted on the liquid crystal touch panel 320, an input object corresponding to the surface, selection of which is accepted, or an item key indicating an output destination is displayed. The display processing unit displays surfaces having a plurality of functions shown thereon, selection of which can be accepted, in advance and displays, when selection of a surface having a function shown thereon is accepted, an item corresponding to the function. In other words, a so-called a hierarchical structure is formed. However, the embodiment is not limited to control of the items displayed in a hierarchical manner. Thus, in a first modification of the fourth embodiment, all items are displayed from the beginning. In other words, item keys corresponding to respective surfaces are displayed in advance.

FIG. 40 is a diagram of an example of a screen displayed on the liquid crystal touch panel 320 by a stereoscopic-display processing unit. As shown in the figure, the stereoscopic-display processing unit according to this modification displays all the item keys on the respective surfaces in advance. In other words, the stereoscopic-display processing unit displays input objects and output destinations for respective functions as a list.

In this modification, a color of a surface or an item key selected is only changed and display of a preview is not performed. As in this modification, the display processing unit may perform only display of a function and an item selected without displaying a preview showing a processing result.

Although different from this modification, it is also possible that item keys are displayed on respective surfaces as a list in advance and, only when an item key is selected by a user, a preview corresponding to the item key selected is displayed.

As another different example, the display processing unit does not display item keys on respective surfaces of the virtual cube first and, when selection of a surface of the virtual cube is accepted, displays an item key included in the surface. When the user depresses the item key displayed, the display processing unit does not display the item keys not depressed and continues to display the depressed item key on the surface with a color of the item key changed. In the case of this example, the display processing unit does not perform preview after enlarged displayed by the detailed-display processing unit after selection of a surface as in the embodiments described above. In this way, it is possible to display the item keys by combining the constitution described above with various constitutions.

In the fourth embodiment, when selection of a surface having an output function is accepted and selection of an output destination is accepted on the liquid crystal touch panel 320, the detailed-display processing unit 4312 displays a summary of a result obtained by performing output processing with the function and condition, selection of which is accepted, as a preview. In the case of this display, the display is not limited only to the display of the preview of the result obtained by performing the output processing. For example, a preview of a summary of a result obtained by performing input processing may be simultaneously displayed. Since the simultaneous display of the previews is as described above, an explanation of the display is omitted.

In the explanation of the fourth embodiment, one three-dimensional shape model is displayed on the liquid crystal touch panel 320. However, the number of three-dimensional shape models displayed on the liquid crystal touch panel 320 is not limited to one.

In a fifth embodiment of the present invention, a plurality of virtual cubes are displayed on the liquid crystal touch panel 320.

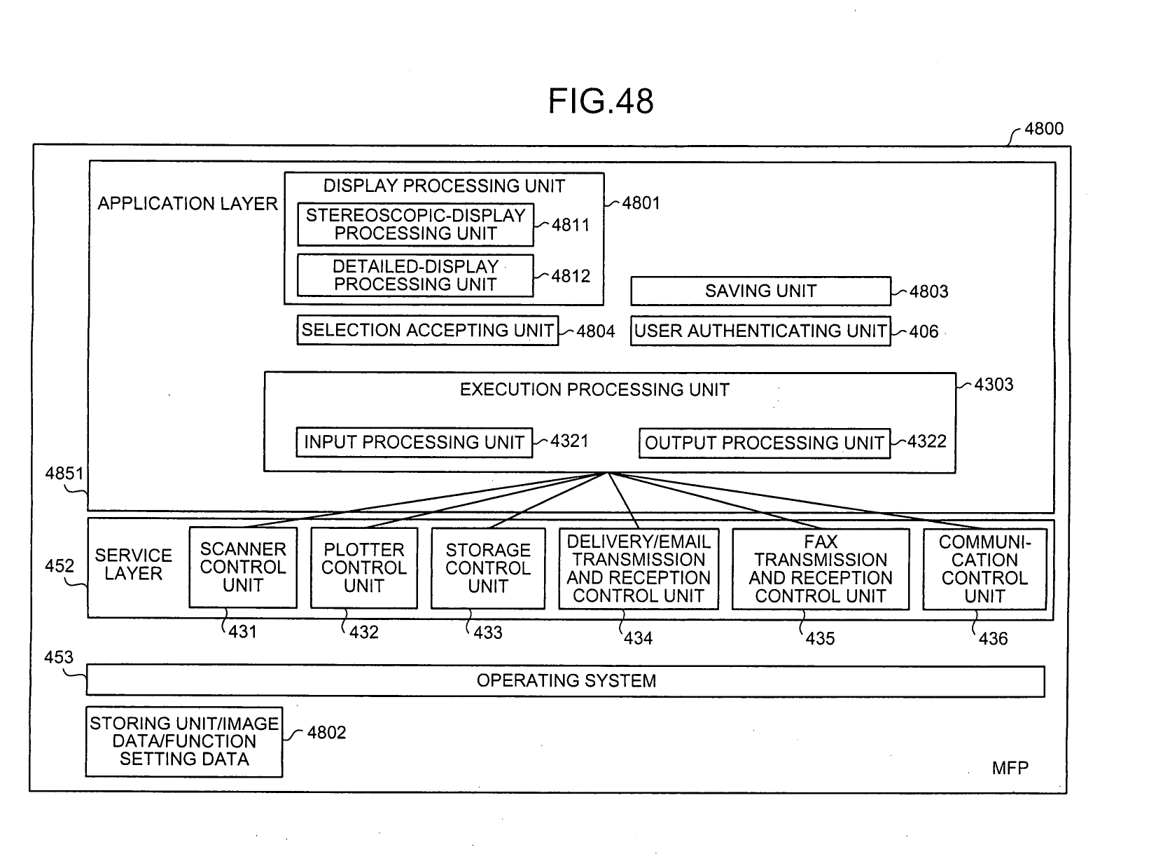

FIG. 48 is a block diagram of a structure of an MFP 4800 according to the fifth embodiment. The MFP 4800 is different from the MFP 4300 according to the fourth embodiment in that the application layer 4351 is changed to an application layer 4851 that performs processing different from the processing of the application layer 4351 and the storing unit 404 is changed to a storing unit 4802. In the following explanation, components identical with those in the fourth embodiment are denoted by the identical reference numerals and signs. Explanations of the components are omitted.

The MFP 4800 according to this embodiment includes the same network environment as that of the MFP 1 according to the first embodiment shown in FIG. 1 and includes the operation panel 300 shown in FIG. 3.

The application layer 4851 is different from the application layer 4351 according to the fourth embodiment in that the display processing unit 4301 is changed to a display processing unit 4801 that performs processing different from the processing of the display processing unit 4301, the selection accepting unit 4302 is changed to a selection accepting unit 4804, and a saving unit 4803 is added.

The storing unit 4802 holds image data in the same manner as the storing unit 404 according to the fourth embodiment. Besides, the storing unit 4802 stores input functions and output functions set on a virtual cube by a user and function setting data concerning the functions.

The selection accepting unit 4804 described later reads out the function setting data stored in the storing unit 4802 after the user is authenticated by the user authenticating unit 406. The selection accepting unit 4804 accepts selection of a surface corresponding to a function included in the function setting data. A stereoscopic-display processing unit 4811 changes a color of the surface, selection of which is accepted, and displays the virtual cube. The stereoscopic-display processing unit 4811 displays a virtual cube, in which selection of a surface has already been accepted according to such function setting data, in a space indicated as a collection of shortcuts of the liquid crystal touch panel 320. Consequently, since it is possible to perform processing using functions set before, convenience is improved.

The function setting data also holds items changed in detailed setting. When selection of a surface shown on the virtual cube displayed in the space indicated as a shortcut is accepted, the detailed-display processing unit 4312 displays a preview reflecting data read from information of the function setting data and a detailed setting screen. This makes it possible to perform processing using detailed setting made before. Consequently, even if the user does not remember content set before, the user can perform processing using the identical content. Thus, convenience is improved. Since the same setting does not have to be repeated, operability is improved.

When the user performs input indicating that the virtual cube is selected to perform processing, the execution processing unit 4303 performs processing using an input function and an output function that can be specified from the information included in the function setting data. When information set on the detailed setting screen is included in the function setting data, the execution processing unit 4303 performs processing using the setting.

The selection accepting unit 4804 accepts selection of a surface having a function shown thereon as in the fourth embodiment and accepts setting of a condition corresponding to the function. Besides, when a virtual cube displayed in the collection of shortcuts or the reduction is, for example, copied, the selection accepting unit 4804 sets a surface, selection of which is accepted, and a condition set in the virtual cube at the copy source in a virtual cube at the copy destination and accepts the setting. A detailed procedure is described later.

The display processing unit 4801 includes the stereoscopic-display processing unit 4811 and the detailed-display processing unit 4312 and displays a screen on the liquid crystal touch panel 320.

The stereoscopic-display processing unit 4811 displays a plurality of virtual cubes having functions shown on respective surfaces thereof on the liquid crystal touch panel 320. The stereoscopic-display processing unit 4811 performs display for rotating the virtual cubes around predetermined rotation axes arranged for the respective virtual cubes as in the fourth embodiment. A method of arranging the rotation axes of the respective virtual cubes is the same as that in the fourth embodiment. An explanation of the method is omitted.

FIG. 49 is a diagram of an example of a screen displayed on the liquid crystal touch panel 320 by the stereoscopic-display processing unit 4811 according to this embodiment. The respective virtual cubes shown in the figure are repeatedly subjected to the processing for rotating the virtual cubes by half and, then, resting the virtual cubes for three seconds as in the fourth embodiment. According to such processing, display of a plurality of surfaces having input functions shown thereon and display of a plurality of surfaces having output functions shown thereon of the respective virtual cubes are switched. Consequently, the same effects as those of the display of the virtual cube described in the fourth embodiment are obtained in the respective virtual cubes. In the figure, only surfaces having SCAN, RECEIVE, and LOAD shown thereon are seen in the respective virtual cubes. However, as in the fourth embodiment, the respective virtual cubes have surfaces having SEND, PRINT, and SAVE shown thereon on the opposite side of the surfaces.

As shown in FIG. 49, virtual cubes corresponding to processing such as COPY, FAX, and DATA PRINT conventionally provided in an MFP are displayed on the liquid crystal touch panel 320. In these virtual cubes, surfaces having input functions shown thereon and surfaces having output functions shown thereon for performing processing described below are selected in advance. Specifically, in the case of a virtual cube indicating COPY, assuming that selection of a surface having SCAN shown thereon and a surface having PRINT shown thereon are accepted in advance, the virtual cube is displayed with color of these surfaces changed. In these virtual cubes, previews showing input processing results and output processing results are not displayed first on the surfaces having the functions, selection of which is accepted, shown thereon.

In this way, the stereoscopic-display processing unit 4811 displays virtual cubes for which selection of surfaces is accepted in advance according to the processing conventionally used. Consequently, for example, the user can recognize that COPY conventionally used is a combination of an input function SCAN and an output function PRINT. The user understands that existing processing is a combination of respective functions with reference to these virtual cubes. Consequently, the user can intuitively understand content of a function actually performed among the respective functions shown on the surfaces. Therefore, since the user understands the respective functions, the user can intuitively create desired processing according to a combination of a surface having an input function shown thereon and a surface having an output function shown thereon.

When the user depresses processing names such as COPY of these virtual cubes, the execution processing unit 4303 executes processing using functions corresponding to surfaces, selection of which is accepted in the virtual cubes. Specifically, in the MFP 4800 according to this embodiment, after the processing names such as COPY are depressed, the input processing unit 4321 performs input processing using input functions corresponding to the surfaces, selection of which has already been accepted in the virtual cubes depressed. As in the fourth embodiment, the stereoscopic-display processing unit 4811 displays previews of input processing results and output processing results on the surfaces, selection of which is accepted, of the virtual cubes depressed. Specifically, when the user depresses COPY, the input processing unit 4321 reads a paper original placed in the ADF. The stereoscopic-display processing unit 4811 displays a preview showing an input processing result of the paper original read on the surface having SCAN shown thereon and displays a preview showing an output processing result on the surface having PRINT shown thereon. In the virtual cube on which COPY and the like are shown, an input object and an output destination have already been set in advance. Thus, it goes without saying that it is unnecessary to perform setting according to the procedure described in the fourth embodiment.

When the user wishes to set an output function in detail after the user refers to the preview displayed on the surface of the virtual cube, the user depresses the surface having PRINT shown thereon on which the preview is displayed. The selection accepting unit 4804 accepts selection of the surface depressed. The detailed-display processing unit 4312 displays a preview and a detailed setting screen corresponding to the surface, selection of which is accepted. The preview and the detailed setting screen are the same as the screen shown in FIG. 23 according to the fourth embodiment. A detailed setting method is also the same as that according to the fourth embodiment. Thus, explanations of the preview and the detailed setting screen are omitted. Consequently, the user can set an output result in detail.

A virtual cube in a collection of shortcuts shown in FIG. 49 can accept selection of a surface having an input function shown thereon and a surface having an output function shown thereon according to the same procedure as the procedure according to the fourth embodiment. It is possible to set detailed conditions on detailed setting screens corresponding to the respective surfaces. The saving unit 4803 described later saves the surfaces, selection of which is accepted, and the detailed conditions in function setting data of the storing unit 4802.

When the user logs in the MFP 4800 again later, the function setting data saved is read. The stereoscopic-display processing unit 4811 reproduces and displays the virtual cube that holds the surface, selection of which is accepted last time, and the detailed conditions. The user depresses the virtual cube reproduced to execute processing using the functions and the detailed conditions set before. In this way, it is possible to save the functions and the detailed setting held by the virtual cube displayed in the collection of shortcuts and execute the functions and the detailed setting later. Thus, convenience is improved.

When the user depresses each of the surfaces of the virtual cube showing the existing processing such as COPY, the selection accepting unit 4804 accepts a function corresponding to the surface depressed and detailed conditions of the function. Consequently, the user can perform addition, change, and deletion of an input function and an output function corresponding to the surface depressed and detailed setting for the respective functions. In this way, it is possible to customize a virtual polyhedron showing the existing processing according to processing that the user wishes to execute. It is possible to save changed setting by copying the virtual polyhedron customized to the collection of shortcuts. Consequently, it is possible to execute processing using the changed setting later and convenience is improved. Naturally, it is also possible to apply acceptance of selection of a surface, setting of detailed conditions, and the like to the virtual cube after being copied to the collection of shortcuts as described above.

FIG. 50 is a diagram for explaining an example in which a virtual cube corresponding to COPY is dragged and copied to a collection of shortcuts and functions of the virtual cubes copied or setting conditions of the respective functions are changed on the liquid crystal touch panel 320. As shown in the figure, the user drags a virtual cube in which selection of a surface having an input function shown thereon and a surface having an output function shown thereon is accepted in advance and copies the virtual cube to the collection of shortcuts. When the user drags the virtual cube, the selection accepting unit 4804 sets the selection of the surface, selection of which has already been accepted in a virtual polyhedron at the drag source, and the detailed conditions, which are set on the functions of the respective surfaces, in the virtual cube displayed in the collection of shortcuts and accepts this setting. Consequently, copying of the virtual cube is performed. Thereafter, the user can change the functions shown on the respective surfaces of the virtual cube copied and the setting of the respective functions. It is possible to save, using the saving unit 4803, the functions and the detailed setting held by the virtual cube customized in this way.

The user can name the virtual cube customized. The saving unit 4803 can save the name of the virtual cube together with the functions and the detailed setting held by the virtual cube. After logging in the MFP 4800 again, the user can recall the function and the detailed conditions saved in the virtual cube with reference to the name of the virtual cube displayed on the liquid crystal touch panel 320. Consequently, when the user wishes to execute processing executed before again, the user can specify a virtual cube in which a function and detailed conditions of the processing are set. As a result, convenience is improved.

It is also possible to combine a plurality of virtual cubes, in which selection of surfaces having other functions shown thereon has already been accepted, with one virtual cube displayed in the space of the collection of shortcuts.

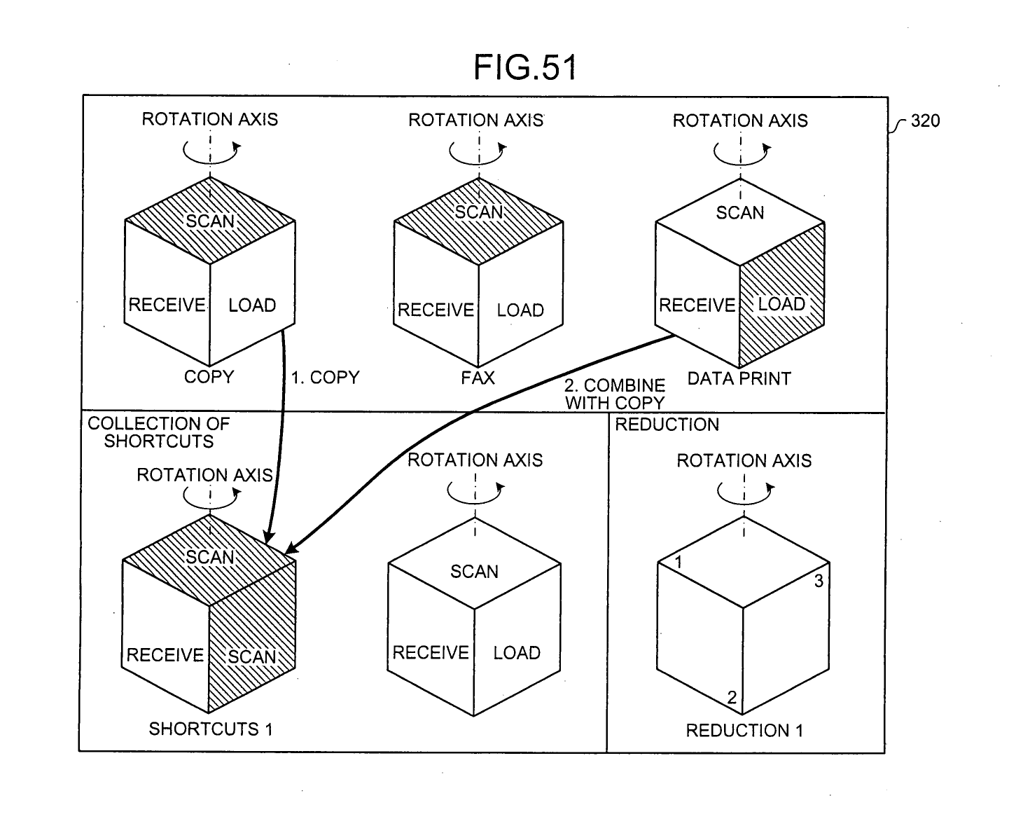

FIG. 51 is a diagram for explaining an example in which a virtual cube corresponding to COPY and a virtual cube corresponding to DATA PRINT are combined to create one virtual cube. In the same manner as the processing described above, the user drags the virtual cube corresponding to COPY to a virtual cube displayed in the collection of shortcuts to copy the virtual cube corresponding to COPY. After copying the virtual cube, the user drags the virtual cube corresponding to DATA PRINT to the virtual cube displayed in the collection of shortcuts. Consequently, the selection accepting unit 4804 sets selection of a surface corresponding to the surface, selection of which has already been accepted in DATA PRINT, and detailed conditions of a function corresponding only to the surface selected in the virtual cube that is a copy of COPY in the collection of shortcuts and accepts this setting. This makes it possible to generate a virtual cube obtained by combining the surfaces, selection of which is accepted in the two virtual cubes. This means that a virtual cube that makes it possible to perform printing, which is an output function corresponding to COPY and DATA PRINT, after performing scan, which is an input function corresponding to COPY, and reading, which is an input function corresponding to DATA PRINT, is generated.

A virtual cube may be displayed in another virtual cube. As an example of use of such a virtual cube having a virtual cube held therein, a virtual cube that performs a plurality of kinds of processing by a plurality of virtual cubes in order is conceivable.

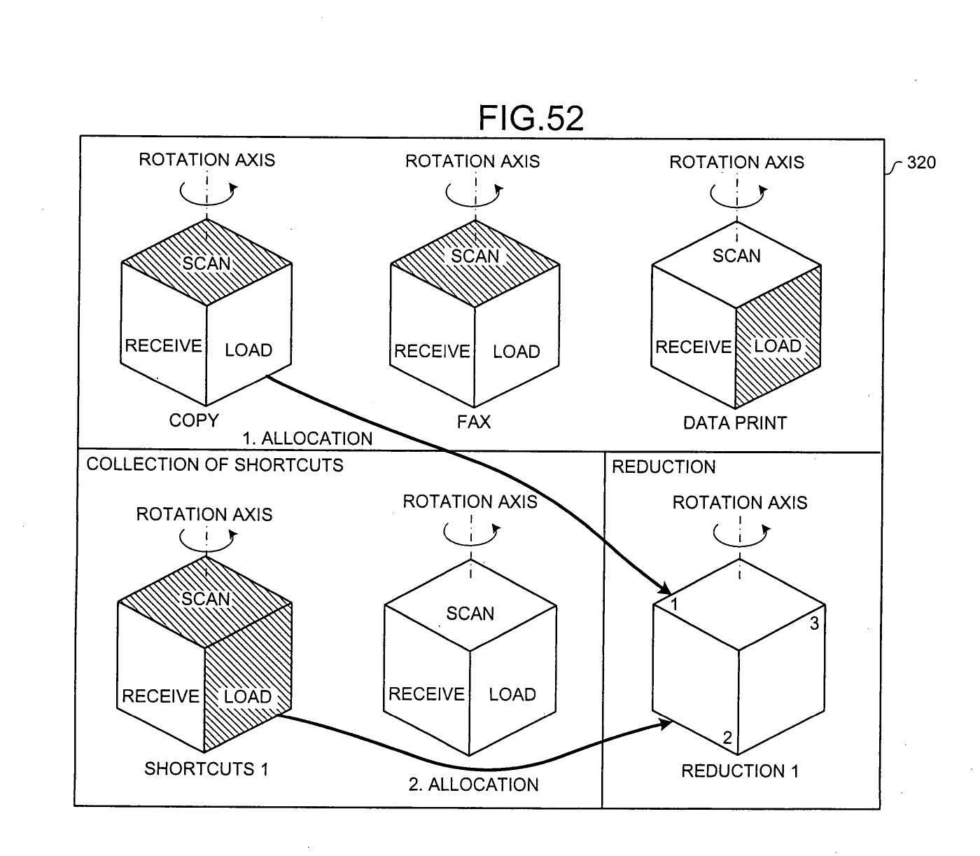

FIG. 52 is a diagram for explaining an example in which a virtual cube corresponding to COPY and a virtual cube corresponding to SHORTCUT 1 are dragged and copied to respective surfaces of a reduced virtual cube in a space of reduction to generate a reduced virtual cube for performing a plurality of kinds of processing in order. As shown in the figure, numbers are affixed to the respective surfaces of the reduced virtual cube displayed in the space of reduction. It is possible to apply virtual cubes to the respective surfaces. The user drags a virtual cube, in which selection of a surface having an input function shown thereon and a surface having an output function shown thereon have already been accepted, and a virtual cube displayed in the space of shortcuts, in which the user has selected a surface, to allocate the virtual cubes to the respective surfaces of the reduced virtual cube with the numbers affixed. Consequently, a virtual polyhedron at the drag source is copied to the respective surfaces of the reduced virtual cube. When the user selects the reduced virtual cube and depresses the start key 308, the execution processing unit 4303 executes the virtual cubes allocated to the respective surfaces of the reduced virtual cube in an order of the numbers.

The reduced virtual cube holds maximum six combinations of input functions and output functions and detailed conditions corresponding to the functions in association with the surfaces thereof. When the user drags a virtual polyhedron and copies the virtual polyhedron on a surface of the reduced virtual cube, the selection accepting unit 4804 sets a surface, selection of which has already been accepted in the virtual cube at the drag source, and a condition corresponding to a function corresponding to the surface in the virtual cube displayed on the surface of the reduced virtual cube and accepts the setting. Consequently, the stereoscopic-display processing unit 4811 displays the virtual polyhedron copied in a surface of a reduced virtual polyhedron. When the user depresses the reduced virtual polyhedron, the execution processing unit 4303 executes processing using input functions and output functions corresponding to surfaces, selection of which is accepted in virtual polyhedrons shown in respective surfaces, in an order of the surfaces. Consequently, since it is possible to execute a plurality of kinds of processing in order, convenience is improved.

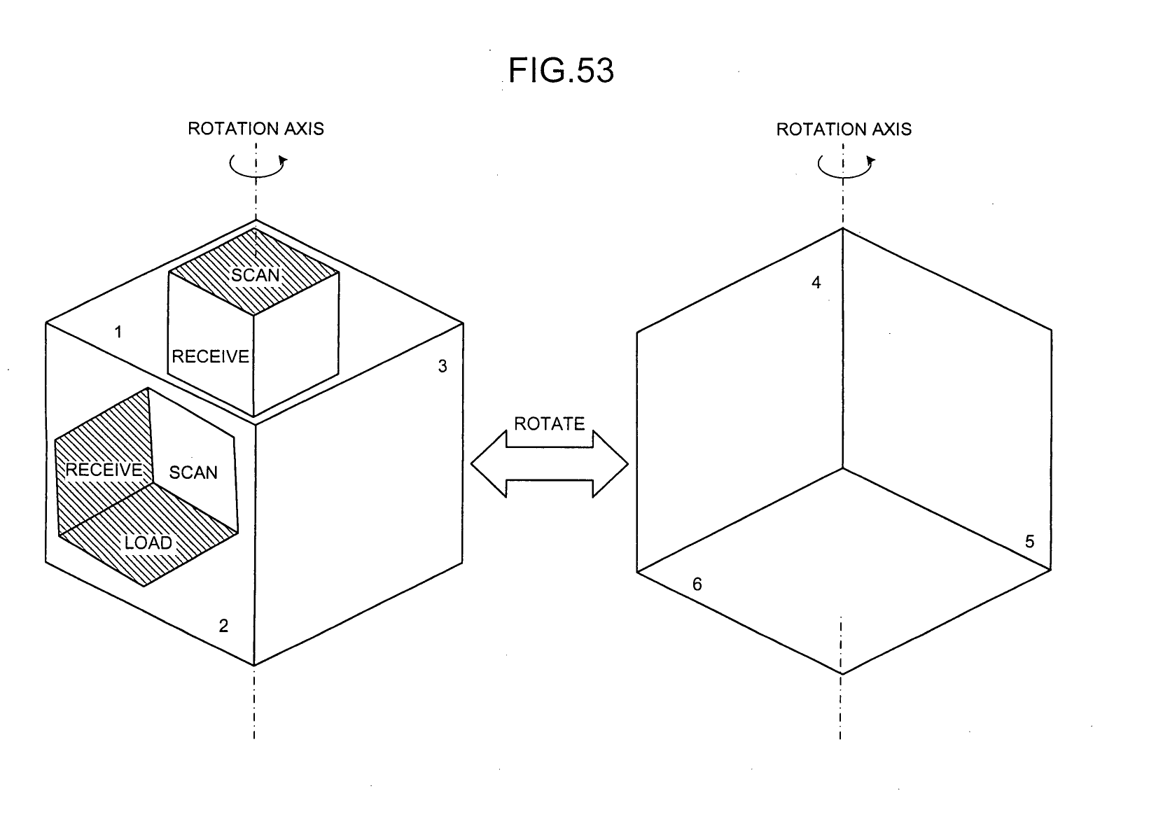

FIG. 53 is a diagram for explaining an example in which the stereoscopic-display processing unit 4811 rotates the reduced virtual cube. As shown in the figure, every time the stereoscopic-display processing unit 4811 rotates the reduced virtual cube, surfaces affixed with numbers 1, 2, and 3 and surfaces affixed with number 4, 5, and 6 are switched. Virtual cubes corresponding to processing to be executed, which are copied by the user, are displayed on the respective surfaces of the reduced virtual cube. The execution processing unit 4303 performs processing that uses functions corresponding to surfaces, selection of which is accepted in the virtual cubes displayed on the respective surfaces, in an order of the numbers of the respective surfaces.

Such a plurality of kinds of processing can be collectively registered in one reduced virtual cube. Consequently, the user can carryout a plurality of kinds of processing easily and without mistake.

Referring back to FIG. 48, after the selection accepting unit 4804 accepts selection of a surface of the virtual cube displayed in the collection of shortcuts, when the user inputs, from the operation unit 20, an indication that the virtual cube is specified and saved, the saving unit 4803 saves input and output functions corresponding to the surface, selection of which is accepted in the virtual cube, and information on set conditions in the storing unit 4802 as function setting data.

When the user logs in the MFP 4800 again, the selection accepting unit 4804 reads the function setting data stored in the storing unit 4802 and accepts selection of a surface corresponding to the input and output functions held in the function setting data from a corresponding virtual cube of the collection of shortcuts. The stereoscopic-display processing unit 4811 changes a color of the surface, selection of which is accepted, to display the corresponding virtual cube. In this way, the virtual cube reflecting the surface, selection of which is once selected, and the set conditions is displayed to make it possible for the user to use the virtual cube. This makes it unnecessary to perform complicated setting every time processing is performed. As a result, convenience is improved.

In the MFP 4800 according to this embodiment, a processing procedure from acceptance of selection of surfaces having input and output functions shown thereon of the respective virtual cubes displayed in the collection of shortcuts until output processing is performed based on image data subjected to input processing is the same as the display processing described in the fourth embodiment. Thus, an explanation of the processing procedure is omitted. In this embodiment, it is possible to perform the processing procedure for each of the virtual cubes displayed. In other words, it is possible to set a plurality of different kinds of processing for the respective virtual polyhedrons. Consequently, convenience is improved.

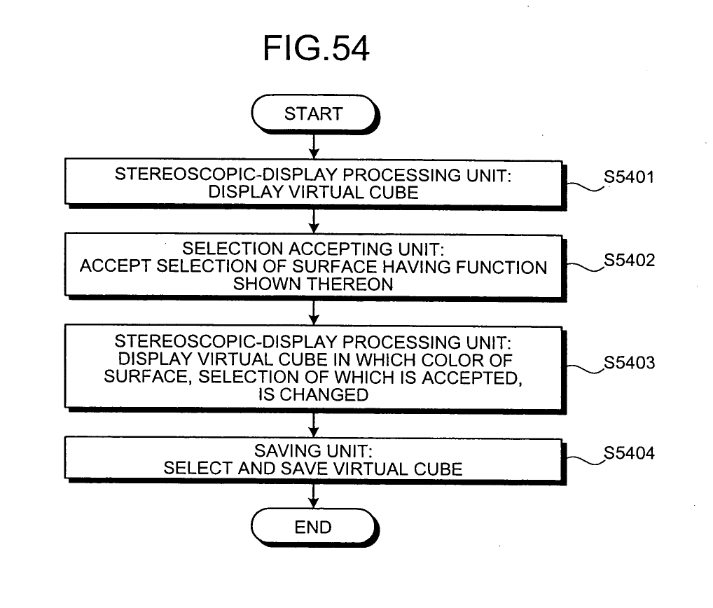

FIG. 54 is a flowchart of a procedure of processing from display processing for a virtual cube until the virtual cube is saved in the MFP 4800 according to this embodiment.

First, the stereoscopic-display processing unit 4811 displays a plurality of virtual cubes on the liquid crystal touch panel 320 (step S5401). When the user depresses a surface having an input function shown thereon and a surface having an output function shown thereon of a virtual cube on the liquid crystal touch panel 320, the selection accepting unit 4804 accepts the selection of the surfaces depressed (step S5402).

The stereoscopic-display processing unit 4811 changes colors of the surfaces, selection of which is accepted at step S5402, and displays the virtual cube (step S5403).

When the user inputs an indication that the user selects and saves the virtual cube to which the setting is applied, the saving unit 4803 saves function setting data including information on the input function and the output function corresponding to the surfaces, selection of which is accepted, in the storing unit 4802 (step S5404).

According to the processing procedure described above, the function setting data including the information and the like of the input function and the output function corresponding to the surfaces, selection of which is accepted from the user, is saved. Consequently, the selection accepting unit 4804 reads the function setting data saved and accepts selection of the surface, selection of which was accepted last time. The stereoscopic-display processing unit 4811 reproduces a state at the time when the saving unit 4803 saved function setting data last time and displays the virtual cube. The user can execute processing identical with the processing performed before or the processing set before by selecting the virtual cube reproduced. The processing procedure described above is an example of a processing procedure from the display processing for the virtual cube according to this embodiment until the processing for saving the virtual cube. The embodiment is not limited to such a processing procedure.

In this embodiment, the function setting data including information on functions corresponding to surfaces, selection of which is accepted, is saved. This is not a function that can be used only when a plurality of virtual cubes are displayed as in this embodiment. For example, it is possible to apply this when only one virtual cube is displayed as in the fourth embodiment. It is possible to use this not only in such an example but also in all embodiments.

In this embodiment, since a plurality of virtual cubes are displayed, it is possible to set processing obtained by combining an input function and an output function for each of the virtual cubes. Thus, convenience is improved. Selection of a surface having an input function shown thereon and a surface having an output function shown thereon corresponding to processing is accepted in advance. When the user selects a virtual cube, the user can execute processing that uses a function, selection of which has already been accepted in the virtual cube selected. Consequently, operability and convenience are improved. The MFP 4800 can hold selection of functions corresponding to processing different for each of the virtual cubes. In other words, it is possible to specify the processing, which is obtained by combining the functions, simply by selecting a virtual cube. Therefore, convenience and operability are improved.

It is possible to execute processing simply by selecting a virtual cube as in the conventional MFP. Moreover, it is possible to accept selection of surfaces having functions shown thereon on the respective virtual cubes and set conditions for functions corresponding to the surfaces. This makes it possible to give high flexibility to the setting of the functions while maintaining operability of the conventional MFP. It is also possible to execute the processing many times by holding this setting.

In the embodiments described above, the MFP implementing the display processing apparatus have been explained. However, the display processing apparatus is not limited to the MFP.

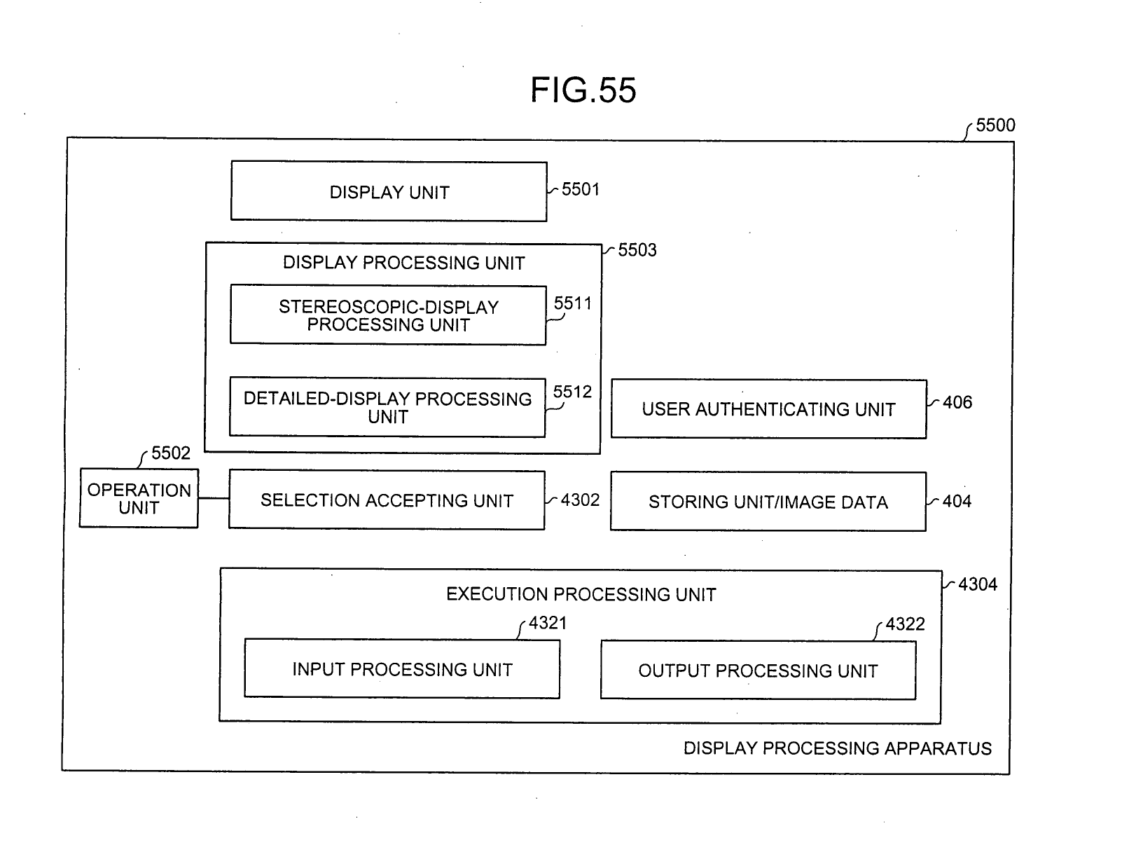

FIG. 55 is a functional block diagram of a display processing apparatus 5500 according to a sixth embodiment of the present invention.

As shown in the figure, the display processing apparatus 5500 has substantially the same structure as the application layer 4351 of the MFP 4300 according to the fourth embodiment. The display processing apparatus 5500 is different from the application layer 4351 in that the display processing unit 4301 is changed to a display processing unit 5503 and a display unit 5501 and an operation unit 5502 are added. The display processing apparatus 5500 includes the storing unit 4304 provided outside the application layer 4351.

The display processing unit 5503 includes a stereoscopic-display processing unit 5511 and a detailed-display processing unit 5512.

The stereoscopic-display processing unit 5511 is different from the stereoscopic-display processing unit 4311 of the embodiments described above in that the stereoscopic-display processing unit 5511 displays surfaces having different functions shown thereon on a virtual cube according to a difference of executable functions of the MFP 4300 and the display processing apparatus 5500. Otherwise, the stereoscopic-display processing unit 5511 is the same as the stereoscopic-display processing unit 4311. Thus, further explanations of the stereoscopic-display processing unit 5511 are omitted. As in the embodiments, the stereoscopic-display processing unit 5511 may show a plurality of input functions and a plurality of output functions on respective surfaces thereof or may show functions not related to input and output on the respective surfaces. As in the fifth embodiment, the stereoscopic-display processing unit 5511 may display a plurality of virtual cubes or may display one virtual cube.

When the selection accepting unit 4302 accepts a surface of a virtual cube displayed by the stereoscopic-display processing unit 5511, the detailed-display processing unit 5512 displays a setting screen for setting a corresponding function on the surface. Otherwise, the detailed-display processing unit 5512 is the same as the detailed-display processing unit 4312. Thus, further explanations of the detailed-display processing unit 5512 are omitted.

A virtual cube having a plurality of surfaces, on which functions are shown by the stereoscopic-display processing unit 5511, arranged thereon, a setting screen, or the like is displayed on the display unit 5501.

The display unit 5501 is, for example, a liquid crystal panel built in the portable display processing apparatus 5500. The liquid crystal panel does not have to be a liquid crystal touch panel in which a user can input data by touching the same as in the embodiments described above. The selection accepting unit 4302 may accept selection according to an input from the operation unit 5502 described later, which is provided separately from the liquid crystal panel. The display unit 5501 is provided in the display processing apparatus 5500 in advance and has a display area of a predetermined size.

Although different from this embodiment, the display unit may have functions of the display unit and the operation unit integrated therein as the liquid crystal touch panel as in the embodiments described above.

The predetermined size of the display area of the display unit 5501 is not limited. However, since the display unit 5501 is provided in the display processing apparatus 5500, a size smaller than the display processing apparatus 5500 is preferable. A size of the display area of the display unit 5501 is a size designed for the purpose of urging the user to recognize executable functions.

As a display processing apparatus including a display unit having a size designed for the purpose of urging the user to recognize executable functions, there are various apparatuses that include a necessary and sufficient display unit that can display the functions and are designated with higher priority given to portability, reduction in space, and other functions than a size of the display unit. Examples of the display processing apparatus include the image forming apparatuses explained in the embodiments described above, an audio visual apparatus, a portable terminal, and a cellular phone.

The display unit having the size designed for the purpose of urging the user to recognize executable functions excludes displays of a personal computer (PC) and the like having high universality that specifically have a plurality of different sizes despite the fact that the displays urge the user to recognize identical functions, or that are designed without assuming a state in which functions are displayed. This is because, in designing screen layouts for displaying functions in the PC and the like, the layouts are usually designed taking into account display areas of the displays. In other words, the displays are different from the device described above in that the displays are main factors of judgment.

The operation unit 5502 is an interface provided for the user to apply operation to the display processing apparatus 5500. The operation unit 5502 may be any mechanism as long as the mechanism is an interface with which the user can input selection of a surface having an input function shown thereon.

Examples of an apparatus including the display processing apparatus 5500 according to this embodiment include the various apparatuses explained in the third embodiment.

As an example of use of the cellular phone, a built-in program or the like is started, a virtual polyhedron including a plurality of surfaces having functions for performing some processing shown thereon is displayed, and selection of the surfaces is accepted. In this case, as in the embodiments described above, the virtual polyhedron including the surfaces having the functions shown on a display screen of the cellular phone is rotated to switch a displayed surface every predetermined time. Consequently, even if an area that can be used for displaying the functions is small, it is possible to display more surfaces having input functions shown thereon and surfaces having output functions shown thereon by switching the display. This makes it possible to appropriately accept selection of surfaces having functions shown thereon even when the cellular phone has a plurality of functions.

As an example of acceptance of selection of surfaces having functions shown thereon in the case of the cellular phone, the user can select these surfaces and accept the selection by depressing dial buttons allocated with UP, DOWN, LEFT, RIGHT and DETERMINE. In this way, the user can accept selection of a desired input function and output function even with a standard interface included in the cellular phone.

The selection of a surface is not limited to the rotation of the virtual polyhedron at every predetermined time. A three-dimensional shape model may be rotated if a predetermined condition is satisfied. Since the functions are shown on the surfaces of the virtual cube, the user can three-dimensionally grasp selectable functions.

The display processing apparatus 5500 is not limited to a display processing apparatus built in other apparatuses. For example, the functions of the display processing apparatus 5500 may be realized by starting a program in a cellular phone or the like. In such a cellular phone, the same effects as those of the embodiments described above are obtained by displaying a virtual cube and accepting selection of surfaces having functions shown thereon.

Although different from this embodiment, it is possible to apply the present invention to an apparatus including an input unit of a coordinate input system such as a liquid crystal touch panel, a tablet, or the like. For example, in an apparatus connected to a tablet and a monitor, a three-dimensional shape model including a function indicating an area having a function shown thereon is displayed on the monitor and the three-dimensional shape model is rotated when a predetermined condition is satisfied. When the user points the function indicating area of the three-dimensional shape model from the tablet using a stylus pen, the selection accepting unit accepts selection of the function indicating area. In this way, when an input interface is limited, an area having a function shown thereon is displayed on an outer surface of the three-dimensional shape model and the three-dimensional shape model is rotated and displayed according to the predetermined condition. This makes it easy to select a function. As a result, operability is improved.

A display processing program executed in the MFPs described in the embodiments and the modifications is stored in a read only memory (ROM) or the like in advance and provided.

The display processing program may be recorded in a computer-readable recording medium such as a compact disk-read only memory (CD-ROM), a flexible disk (FD), a compact disk-recordable (CD-R), or a digital versatile disk (DVD) as a file of an installable format or an executable format and provided.

The display processing program may be stored on a computer connected to a network such as the Internet and downloaded through the network to be provided. The display processing program may be provided or distributed through the network such as the Internet.

The display processing program is constituted as a module including the units described above (the display processing unit, the selection accepting unit, the execution processing unit, and the user authenticating unit). As actual hardware, when a central processing unit (CPU) (a processor) reads out the display processing program from the ROM and executes the display processing program, the respective units are loaded onto a main storage device. The display processing unit, the selection accepting unit, the execution processing unit, and the user authenticating unit are generated on the main storage device.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display processing apparatus comprising:
a display processing unit that displays a function indicating area having shown therein a function executed when selection thereof is accepted from a user; and
a selection accepting unit that accepts selection of the function indicating area displayed.

2. The display processing apparatus according to claim 1, wherein the display processing unit displays an input indicating area having an input function shown therein or an output indicating area having an output function shown therein as the function indicating area, and
the display processing apparatus further includes a switching unit that switches the input indicating area and the output indicating area displayed by the display processing unit.

3. The display processing apparatus according to claim 2, further comprising a display unit that has a displayable coordinate input surface and accepts an indication of the user when the user touches the coordinate input surface, wherein
the display processing unit displays the input indicating area and the output indicating area on the display unit, and
the selection accepting unit accepts selection of the input indicating area and the output indicating area from the indication on the coordinate input surface of the display unit.

4. The display processing apparatus according to claim 2, further comprising a display unit that has a display area of a predetermined size set for a purpose of urging the user to recognize an executable function, wherein
the display processing unit displays the input indicating area and the output indicating area on the display unit.

5. The display processing apparatus according to claim 2, wherein
the display processing unit displays a three-dimensional shape model having the input indicating area or the output indicating area shown on an outer surface thereof, and
the switching unit performs rotation control for the three-dimensional shape model to switch the input indicating area and the output indicating area displayed by the display processing unit.

6. The display processing apparatus according to claim 1, wherein
the display processing unit includes a stereoscopic-display processing unit that performs display for rotating a three-dimensional shape model having the function indicating area shown on an outer surface thereof around a predetermined rotation axis, and
the selection accepting unit accepts selection of the function indicating area shown on the outer surface of the three-dimensional shape model displayed by the stereoscopic-display processing unit.

7. The display processing apparatus according to claim 6, further comprising a display unit that has a displayable coordinate input surface and accepts an indication of the user when the user touches the coordinate input surface, wherein
the stereoscopic-display processing unit displays the three-dimensional shape model on the display unit, and
the selection accepting unit accepts selection of the function indicating area displayed by the stereoscopic-display processing unit from the indication on the coordinate input surface of the display unit.

8. The display processing apparatus according to claim 6, further comprising a display unit that has a display area of a predetermined size set for a purpose of urging the user to recognize an executable function, wherein
the stereoscopic-display processing unit displays the three-dimensional shape model on the display unit.

9. The display processing apparatus according to claim 6, wherein the stereoscopic display processing unit displays a plurality of three-dimensional shape models having the function indicating area shown on outer surfaces thereof.

10. The display processing apparatus according to claim 6, wherein the stereoscopic display processing unit displays, in the three-dimensional shape model having opposed two surfaces, an input indicating area that indicates a function indicating area for an input function and an output indicating area that indicates a function indicating area for an output function, which are in a predetermined relation, on the opposed two surfaces, respectively.

11. A display processing method comprising:
displaying a function indicating area having shown therein a function executed when selection from a user is accepted; and
accepting selection of the function indicating area displayed.

12. The display processing method according to claim 11, wherein
at the displaying, an input indicating area having an input function shown therein or an output indicating area having an output function shown therein is displayed as the function indicating area, and
the display processing method further includes switching the input indicating area and the output indicating area displayed at the displaying.

13. The display processing method according to claim 12, wherein
at the displaying, the input indicating area and the output indicating area are displayed on a display unit that has a displayable coordinate input surface and accepts an indication of the user when the user touches the coordinate input surface, and
at the accepting, selection of the input indicating area and the output indicating area is accepted according to the indication from the coordinate input surface of the display unit.

14. The display processing method according to claim 12, wherein, at the displaying, the input indicating area and the output indicating area are displayed on a display unit that has a display area of a predetermined size set for a purpose of urging the user to recognize an executable function.

15. The display processing method according to claim 12, wherein
the displaying includes displaying a three-dimensional shape model having the input indicating area or the output indicating area shown on an outer surface thereof, and
the switching includes rotating the three-dimensional shape model to switch the input indicating area and the output indicating area displayed at the displaying.

16. The display processing method according to claim 11, wherein
the displaying includes rotating a displayed three-dimensional shape model having shown thereon a function executed when selection from the user is accepted around a predetermined rotation axis, and
the accepting includes accepting selection of the function indicating area shown on an outer surface of the three-dimensional shape model at the rotating.

17. The display processing method according to claim 16, wherein
at the rotating, the three-dimensional shape model is displayed on a display unit that has a displayable coordinate input surface and accepts an indication of the user when the user touches the coordinate input surface, and
at the accepting, selection of the function indicating area displayed at the rotating is accepted from the indication on the coordinate input surface of the display unit.

18. The display processing method according to claim 16, wherein, at the rotating, the three-dimensional shape model is displayed on a display unit that has a display area of a predetermined size set for a purpose of urging the user to recognize an executable function.

19. The display processing method according to claim 16, wherein the rotating includes displaying a plurality of three-dimensional shape models having the function indicating area shown on outer surfaces thereof.

20. The display processing method according to claim 16,
wherein the rotating includes displaying, in the three-dimensional shape model having opposed two surfaces, an input indicating area that indicates a function indicating area for an input function and an output indicating area that indicates a function indicating area for an output function, which are in a predetermined relation, on the opposed two surfaces, respectively.

21. A computer program product comprising a computer usable medium having computer readable program codes embodied in the medium that when executed causes a computer to execute:
displaying a function indicating area having shown therein a function executed when selection from a user is accepted; and
accepting selection of the function indicating area displayed.

22. The computer program product according to claim 21, wherein
at the displaying, an input indicating area having an input function shown therein or an output indicating area having an output function shown therein is displayed as the function indicating area, and
the computer program product further causing the computer to execute switching the input indicating area and the output indicating area displayed at the displaying.

23. The computer program product according to claim 21, wherein
at the displaying, the computer program product causes the computer to execute rotating a displayed three-dimensional shape model having shown thereon a function executed when selection from the user is accepted around a predetermined rotation axis, and
the accepting includes accepting selection of the function indicating area shown on an outer surface of the three-dimensional shape model at the rotating.
